(19) United States
(12) Patent Application Publication
(10) Pub. No.: US 2025/0007117 A1
(43) Pub. Date: Jan. 2, 2025

(54) BUSBAR-OVER-ELECTRODE INTERCONNECT SYSTEMS FOR SECONDARY BATTERIES AND METHODS OF ASSEMBLING THE SAME

(71) Applicant: Enovix Corporation, Fremont, CA (US)

(72) Inventors: Daniel J. Noelle, Mountain View, CA (US); Michael J. Armstrong, New Braunfels, TX (US); Miles A.M. Kool, San Francisco, CA (US); Robert S. Busacca, San Francisco, CA (US); Benjamin L. Cardozo, Palo Alto, CA (US); Murali Ramasubramanian, Fremont, CA (US)

(21) Appl. No.: 18/741,672

(22) Filed: Jun. 12, 2024

Related U.S. Application Data
(60) Provisional application No. 63/510,811, filed on Jun. 28, 2023.

(51) Int. Cl. H01M 50/533; H01M 4/66; H01M 50/536

(52) U.S. Cl. CPC H01M 50/533; H01M 4/661; H01M 50/536

(57) ABSTRACT

An electrode assembly includes unit cells stacked in a longitudinal direction, each unit cell including an electrode structure, a separator, and a counter-electrode structure. The electrode structure includes an electrode current collector and an electrode active material layer. The counter-electrode structure includes a counter-electrode current collector and a counter-electrode active material layer. An end portion of the counter-electrode current collector extends past the counter-electrode active material and the separator. The end portion of the counter-electrode current collector is bent to define a bent end portion of the respective counter-electrode current collector. The bent end portions of at least some of the counter-electrode current collectors overlap the bent end portion of an adjacent counter-electrode current collector. The electrode assembly also includes a counter-electrode busbar extending across and attached to the bent end portions such that the counter-electrode current collectors are electrically connected to and are disposed inboard of the counter-electrode busbar.

### FIELD

The field of the disclosure relates generally to energy storage technology, such as battery technology. More specifically, the field of the disclosure relates to electrode assemblies that include busbar-over-electrode electrical interconnections, secondary batteries including such electrode assemblies, and methods of assembling such electrode assemblies.

### BACKGROUND

Secondary batteries, such as lithium based secondary batteries, have become desirable energy sources due to their comparatively high energy density, power and shelf life. Examples of lithium secondary batteries include non-aqueous batteries such as lithium-ion and lithium-polymer batteries. Secondary batteries typically have two-dimensional laminar architectures, such as planar or spirally wound (i.e., jellyroll) laminate structures, where a surface area of each laminate is approximately equal to its geometric footprint (ignoring porosity and surface roughness).

Three-dimensional secondary batteries may provide increased capacity and longevity compared to laminar secondary batteries. Three-dimensional battery architectures (e.g., interdigitated electrode arrays) have been proposed in the literature to provide higher electrode surface area, higher energy and power density, improved battery capacity, and improved active material utilization compared with two-dimensional architectures (e.g., flat and spiral laminates). For example, reference to Long et al., “Three-dimensional battery architectures,” Chemical Reviews, 2004, 104, 4463-4492, may help to illustrate the state of the art in proposed three-dimensional battery architectures, and is therefore incorporated by reference as non-essential subject matter herein.

Known three-dimensional secondary batteries include electrode assemblies having a multitude of electrode and counter-electrode substructures in alternating stacked arrangement to build capacity of the secondary battery. The electrode and the counter-electrode substructures include electrochemically active material into which a carrier ion, such as lithium, inserts and extracts. As the battery is discharged, carrier ions are extracted from the electrode substructures and inserted into the counter-electrode substructures. As the battery is charged, the carrier ions are extracted from the counter-electrode substructures and inserted into the electrode substructures. The electrode and counter-electrode substructures are typically connected to respective electrode and counter-electrode terminals of the secondary battery via interconnection tabs disposed along one or more outer edges of the electrode assembly to facilitate charging and discharging the secondary battery. The interconnection tabs include electrode tabs connected to the electrode terminal and counter-electrode tabs connected to the counter-electrode terminal. The tabs may be connected to the respective terminals by electrode and counter-electrode busbars that are respectively attached to the electrode tabs and the counter-electrode tabs.

The interconnection tabs may be formed as end portions of current collectors of the electrode and counter-electrode substructures that extend past the electrochemically active material along one or more edges of the electrode assembly. The current collectors and the tabs may be constructed of thin electrically conductive (e.g., metal) material, which may facilitate reducing the footprint and increasing the energy density of the secondary battery. The terminals and the busbars are typically thicker and heavier in weight than the tabs. The difference in thickness and weight between the tabs and the terminals and busbars presents manufacturing and cost challenges with respect to establishing and maintaining mutual electrical connection between the electrode and counter-electrode substructures and the respective terminal. For example, during production, the tabs may be connected to the terminal or busbar by gluing, welding, soldering, and the like, and the difference in thickness and weight makes it difficult to create a reliable connection. The connection between the tabs and the terminal or busbar are also susceptible to damage post-production due to impacts or material fatigue. The failure of such connection between one or more of the tabs and the terminal or busbar may cause deteriorated performance (e.g., lower energy and power density and/or lower battery capacity) or failure of the battery.

Thus, a need exists for three-dimensional secondary batteries that include an improved interconnect design of battery components to address the challenges presented in three-dimensional secondary batteries and to facilitate improving manufacturing yield, reliability, and/or performance of the batteries.

### BRIEF DESCRIPTION

One aspect is an electrode assembly for use with a secondary battery. The electrode assembly defines mutually perpendicular transverse, longitudinal, and vertical directions corresponding to an X axis, a Y axis, and a Z axis, respectively, of a three-dimensional Cartesian coordinate system. The electrode assembly includes a population of unit cells being stacked in the longitudinal direction, each member of the unit cell population including an electrode structure, a separator structure, and a counter-electrode structure, wherein: the electrode structure includes an electrode current collector and an electrode active material layer, the electrode structure extending in the transverse direction; the counter-electrode structure includes a counter-electrode current collector and a counter-electrode active material layer, the counter-electrode structure extending in the transverse direction, an end portion of the counter-electrode current collector extending past the counter-electrode active material and the separator structure in the transverse direction, and the end portion of the counter-electrode current collector being bent towards the longitudinal direction to define a bent end portion of the respective counter-electrode current collector; and the bent end portions of at least some of the counter-electrode current collectors overlap the bent end portion of an adjacent counter-electrode current collector in a Y-Z plane of the electrode assembly defined by the Y and Z axes. The electrode assembly also includes a counter-electrode busbar being attached to the bent end portions of the counter-electrode current collectors such that the counter-electrode current collectors are electrically connected to the counter-electrode busbar, the counter-electrode busbar extending across the bent end portions in the Y-Z plane such that the bent end portions of the counter-electrode current collectors are disposed inboard of the counter-electrode busbar.

Another aspect is a secondary battery that includes an electrode assembly disposed within a battery enclosure. The electrode assembly defines mutually perpendicular transverse, longitudinal, and vertical directions corresponding to an X axis, a Y axis, and a Z axis, respectively, of a three-dimensional Cartesian coordinate system. The electrode assembly includes a population of unit cells being stacked in the longitudinal direction, each member of the unit cell population including an electrode structure, a separator structure, and a counter-electrode structure, wherein: the electrode structure includes an electrode current collector and an electrode active material layer, the electrode structure extending in the transverse direction; the counter-electrode structure includes a counter-electrode current collector and a counter-electrode active material layer, the counter-electrode structure extending in the transverse direction, an end portion of the counter-electrode current collector extending past the counter-electrode active material and the separator structure in the transverse direction, and the end portion of the counter-electrode current collector being bent towards the longitudinal direction to define a bent end portion of the respective current collector; and the bent end portions of at least some of the counter-electrode current collectors overlap the bent end portion of an adjacent counter-electrode current collector in a Y-Z plane of the electrode assembly defined by the Y and Z axes. The electrode assembly also includes a counter-electrode busbar attached to the bent end portions of the counter-electrode current collectors such that the counter-electrode current collectors are electrically connected to the counter-electrode busbar, the counter-electrode busbar extending across the bent end portions in the Y-Z plane such that the bent end portions of the counter-electrode current collectors are disposed inboard of the counter-electrode busbar, and a conductive terminal attached to the counter-electrode busbar, the conductive terminal extending outward beyond the battery enclosure.

Yet another aspect is a method of assembling an electrode assembly. The method includes stacking a population of unit cells in a stacking direction, each member of the unit cell population including an electrode structure, a separator structure, and a counter-electrode structure, wherein the electrode structure comprises an electrode current collector and an electrode active material layer, the counter-electrode structure comprises a counter-electrode current collector and a counter-electrode active material layer, the electrode structure and the counter-electrode structure extend in a transverse direction perpendicular to the stacking direction, and an end portion of the counter-electrode current collector extends past the counter-electrode active material and the separator structure in the transverse direction; bending the end portion of each counter-electrode current collector towards the stacking direction to define a bent end portion, the bent end portions of at least some of the counter-electrode current collectors overlapping the bent end portion of an adjacent counter-electrode current collector; positioning a counter-electrode busbar across the bent end portions of the counter-electrode current collectors such that the bent end portions of the counter-electrode current collectors are disposed between the population of the unit cells and the busbar; and attaching the counter-electrode busbar to the bent end portions of the counter-electrode current collectors.

Yet another aspect is a method of assembling a secondary battery. The method includes assembling an electrode assembly, wherein assembling the electrode assembly comprises: stacking a population of unit cells in a stacking direction, each member of the unit cell population including an electrode structure, a separator structure, and a counter-electrode structure, wherein the electrode structure comprises an electrode current collector and an electrode active material layer, the counter-electrode structure comprises a counter-electrode current collector and a counter-electrode active material layer, the electrode structure and the counter-electrode structure extend in a transverse direction perpendicular to the stacking direction, and an end portion of the counter-electrode current collector extends past the counter-electrode active material and the separator structure in the transverse direction; bending the end portion of each counter-electrode current collector towards the stacking direction to define a bent end portion, the bent end portions of at least some of the counter-electrode current collectors overlapping the bent end portion of an adjacent counter-electrode current collector; positioning a counter-electrode busbar across the bent end portions of the counter-electrode current collectors such that the bent end portions of the counter-electrode current collectors are disposed between the population of the unit cells and the busbar; attaching the counter-electrode busbar to the bent end portions of the counter-electrode current collectors; and attaching a conductive terminal to the counter-electrode busbar. The method also includes enclosing the electrode assembly within a battery enclosure, wherein the conductive terminal extends outward beyond the battery enclosure.

Various refinements exist of the features noted in relation to the above-mentioned aspects. Further features may also be incorporated in the above-mentioned aspects. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of a partially assembled secondary battery of an exemplary embodiment.

FIG. 2 depicts a partial section of the secondary battery taken along lines 1-1 in FIG. 1.

FIG. 3 depicts an example cathode structure of the secondary battery of FIGS. 1 and 2.

FIG. 4 depicts an anode structure for the secondary battery of FIGS. 1 and 2.

FIG. 5 is a simplified diagram of an example electrode assembly for cycling between a charged state and a discharged state in a battery.

FIG. 6 is a simplified diagram of another example electrode assembly for cycling between a charged state and a discharged state in a battery.

FIG. 7 is a simplified diagram of another example electrode assembly for cycling between a charged state and a discharged state in a battery.

FIG. 8 is a simplified diagram of another example electrode assembly for cycling between a charged state and a discharged state in a battery.

FIG. 9 is a top view of a pair of electrode structures with their current collectors attached to a busbar through current limiters.

FIG. 10 is a side view one of the electrode structures of FIG. 9 with its current collector attached to the busbar through a current limiter in accordance with one embodiment.

FIG. 11 is a side view of an electrode structure with its current collector attached to a busbar through a current limiter in accordance with another embodiment.

FIG. 12 is a side view of an electrode structure with its current collector attached to a busbar through a current limiter in accordance with another embodiment.

FIGS. 13-15 are side views of electrode structures with a current collector attached to a busbar through a current limiter and one or more interface layers in accordance with various embodiments.

FIG. 16 is a simplified diagram of an end of a counter-electrode current collector in accordance with one embodiment.

FIG. 17 is a side view of the end of a counter-electrode current collector in FIG. 16 connected to a counter-electrode busbar.

FIG. 18 is a side view of a counter-electrode current collector connected to a counter-electrode busbar without the use of a slot in the current collector.

FIG. 19 is a side view of counter-electrode current collectors connected to a counter-electrode busbar with overlapping end portions disposed inboard from the busbar in accordance with an example embodiment.

FIG. 20 is a side view of counter-electrode current collectors connected to a counter-electrode busbar with overlapping end portions disposed inboard from the busbar in accordance with another example embodiment.

FIG. 21 is a side view of counter-electrode current collectors connected to a layered counter-electrode busbar with overlapping end portions disposed inboard from the busbar in accordance with another example embodiment.

FIG. 22 is a side view of counter-electrode current collectors connected to a layered counter-electrode busbar showing multiple groups of overlapping end portions.

FIGS. 23A-23E are side views of a partially assembled electrode assembly and depict various examples of laser weld patterns formed on overlapping end portions of counter-electrode current collectors.

FIG. 24 is a simplified diagram of an electrode assembly is accordance with an example embodiment showing counter-electrode structures connected in series by overlapping end portions disposed inboard of and attached to a counter-electrode busbar.

FIGS. 25 and 26 are enlarged partial detail perspective views of a partially assembled example secondary battery in accordance with an example embodiment.

FIGS. 27 and 28 are side views of another partially assembled example secondary battery in accordance with an example embodiment.

FIG. 29 is a schematic side view of the secondary battery shown in FIG. 28.

FIG. 30 is a cross section taken along the lines 29-29 in FIG. 29.

FIG. 31 is an example method of assembling a secondary battery assembly.

FIG. 32 illustrates a sequence of operations used to produce a secondary battery.

FIG. 33 is a simplified diagram of an example unit cell in accordance with the method of FIG. 31.

Corresponding reference numerals used throughout the drawings indicate corresponding parts.

### Definitions

“A,” “an,” and “the” (i.e., singular forms) as used herein refer to plural referents unless the context clearly dictates otherwise. For example, in one instance, reference to “an electrode” includes both a single electrode and a plurality of similar electrodes.

“About” and “approximately” as used herein refers to plus or minus 10%, 5%, or 1% of the value stated. For example, in one instance, about 250 micrometers (μm) would include 225 μm to 275 μm. By way of further example, in one instance, about 1,000 μm would include 900 μm to 1,100 μm. Unless otherwise indicated, all numbers expressing quantities (e.g., measurements, and the like) and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

“Anode” as used herein in the context of a secondary battery refers to the negative electrode in the secondary battery.

“Anode material” or “Anodically active material” as used herein means material suitable for use as the negative electrode of a secondary battery

“Cathode” as used herein in the context of a secondary battery refers to the positive electrode in the secondary battery

“Cathode material” or “Cathodically active material” as used herein means material suitable for use as the positive electrode of a secondary battery.

“Conversion chemistry active material” or “Conversion chemistry material” refers to a material that undergoes a chemical reaction during the charging and discharging cycles of a secondary battery.

“Counter-electrode” as used herein may refer to the negative or positive electrode (anode or cathode), opposite of the Electrode, of a secondary battery unless the context clearly indicates otherwise.

“Counter-electrode structure” as used herein may refer to an electrochemical structure adapted for use in a secondary battery, opposite of an Electrode structure, that includes a counter-electrode current collector and a counter-electrode material. A Counter-electrode structure may be an anode structure (e.g., a negative electrode structure) including an anode current collector and anode material or a cathode structure (e.g., a positive electrode structure) including a cathode current collector and cathode material, opposite of the Electrode structure, unless the context clearly indicates otherwise.

“Counter-electrode current collector” as used herein may refer to the negative or positive (anode or cathode) current collector, opposite of the Electrode current connector, of a secondary battery unless the context clearly indicates otherwise.

“Counter-electrode material” as used herein may refer to anode material or cathode material, opposite of the Electrode material, unless the context clearly indicates otherwise.

“Cycle” as used herein in the context of cycling of a secondary battery between charged and discharged states refers to charging and/or discharging a battery to move the battery in a cycle from a first state that is either a charged or discharged state, to a second state that is the opposite of the first state (i.e., a charged state if the first state was discharged, or a discharged state if the first state was charged), and then moving the battery back to the first state to complete the cycle. For example, a single cycle of the secondary battery between charged and discharged states can include, as in a charge cycle, charging the battery from a discharged state to a charged state, and then discharging back to the discharged state, to complete the cycle. The single cycle can also include, as in a discharge cycle, discharging the battery from the charged state to the discharged state, and then charging back to a charged state, to complete the cycle.

“Electrochemically active material” as used herein means anodically active material or cathodically active material.

“Electrode” as used herein may refer to the negative or positive electrode (anode or cathode) of a secondary battery unless the context clearly indicates otherwise.

“Electrode structure” as used herein may refer to an electrochemical structure adapted for use in a secondary battery and that includes an electrode current collector and an electrode material. An Electrode structure may be an anode structure (e.g., a negative electrode structure) including an anode current collector and anode material or a cathode structure (e.g., a positive electrode structure) including a cathode current collector and cathode material unless the context clearly indicates otherwise.

“Electrode current collector” as used herein may refer to the negative or positive (anode or cathode) current collector of a secondary battery unless the context clearly indicates otherwise.

“Electrode material” as used herein may refer to anode material or cathode material unless the context clearly indicates otherwise.

“Capacity” or “C” as used herein refers to an amount of electric charge that a battery (or a sub-portion of a battery comprising one or more pairs of electrode structures and counter-electrode structures that form a bilayer) can deliver at a pre-defined voltage unless the context clearly indicates otherwise.

“Electrolyte” as used herein refers to a non-metallic liquid, gel, or solid material in which current is carried by the movement of ions adapted for use in a battery unless the context clearly indicates otherwise.

“Charged state” as used herein in the context of the state of a secondary battery refers to a state where the secondary battery is charged to at least 75% of its rated capacity unless the context clearly indicates otherwise. For example, the battery may be charged to at least 80% of its rated capacity, at least 90% of its rated capacity, and even at least 95% of its rated capacity, such as 100% of its rated capacity.

“Discharge capacity” as used herein in connection with a negative electrode means the quantity of carrier ions available for extraction from the negative electrode and insertion into the positive electrode during a discharge operation of the battery between a predetermined set of cell end of charge and end of discharge voltage limits unless the context clearly indicates otherwise.

“Discharged state” as used herein in the context of the state of a secondary battery refers to a state where the secondary battery is discharged to less than 25% of its rated capacity unless the context clearly indicates otherwise. For example, the battery may be discharged to less than 20% of its rated capacity, such as less than 10% of its rated capacity, and even less than 5% of its rated capacity, such as 0% of its rated capacity.

“Reversible coulombic capacity” as used herein in connection with an electrode (i.e., a positive electrode, a negative electrode or an auxiliary electrode) means the total capacity of the electrode for carrier ions available for reversible exchange with a counter electrode.

“Longitudinal axis,” “transverse axis,” and “vertical axis,” as used herein refer to mutually perpendicular axes (i.e., each are orthogonal to one another). For example, the “longitudinal axis,” “transverse axis,” and the “vertical axis” as used herein are akin to an X axis, a Y axis, and a Z axis, respectively, of a Cartesian coordinate system used to define three-dimensional aspects or orientations. As such, the descriptions of elements of the disclosed subject matter herein are not limited to the particular axis or axes used to describe three-dimensional orientations of the elements. Alternatively stated, the axes may be interchangeable when referring to three-dimensional aspects of the disclosed subject matter.

“Composite material” or “Composite” as used herein refers to a material which comprises two or more constituent materials unless the context clearly indicates otherwise.

“Void fraction” or “Porosity” or “Void volume fraction” as used herein refers to a measurement of the voids (i.e., empty) spaces in a material, and is a fraction of the volume of voids over the total volume of the material, between 0 and 1, or as a percentage between 0% and 100%.

“Polymer” as used herein may refer to a substance or material consisting of repeating subunits of macromolecules unless the context clearly indicates otherwise.

“Microstructure” as used herein may refer to the structure of a surface of a material revealed by an optical microscope above about 25× magnification unless the context clearly indicates otherwise.

“Microporous” as used herein may refer to a material containing pores with diameters less than about 2 nanometers unless the context clearly indicates otherwise.

“Macroporous” as used herein may refer to a material containing pores with diameters greater than about 50 nanometers unless the context clearly indicates otherwise.

“Nanoscale” or “Nanoscopic scale” as used herein may refer to structures with a length scale in the range of about 1 nanometer to about 100 nanometers.

“Separator,” “Separator layer,” or “Separator structure” as used herein may refer to electrically insulating but ionically permeable separator material that is adapted to electrically isolate an electrode structure from an adjacent counter-electrode structure.

“Unit cell” as used herein may refer to a subassembly of a secondary battery that includes an electrode structure, a counter-electrode structure, and a separator between the electrode structure and the counter-electrode structure. A pair of adjacent unit cells of a secondary battery may be arranged with an electrode structure of a first unit cell of the pair adjacent to a counter-electrode structure of a second unit cell of the pair and may share a common separator between the electrode structure of the first unit cell and the counter-electrode structure of the second unit cell.

### DETAILED DESCRIPTION

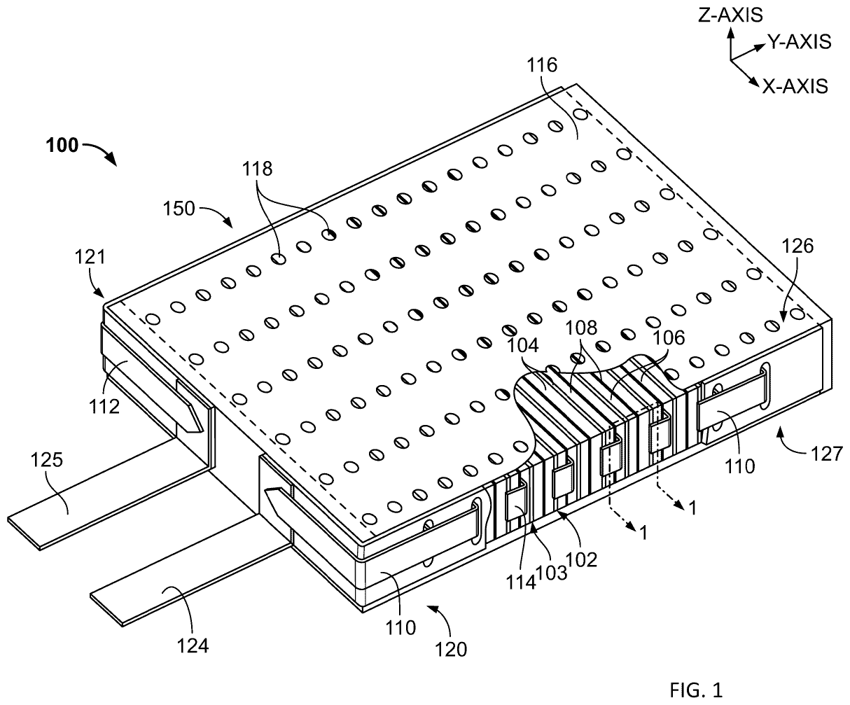

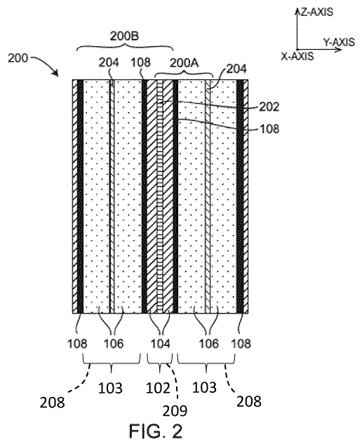

FIG. 1 is a perspective view of a partially assembled secondary battery 100 of an exemplary embodiment, and FIG. 2 depicts a partial section of the secondary battery 100 taken along lines 1-1 in FIG. 1. The secondary battery 100 in FIG. 1 has a portion exposed showing some of the internal structures of the secondary battery, as further described below. When fully assembled, the second battery 100 includes a battery enclosure made of an insulating packaging material, such as a multi-layer aluminum polymer material, plastic, or the like. The battery enclosure is omitted from FIG. 1 to show an electrode assembly 150 of the secondary battery 100. The electrode assembly 150 is disposed within the battery enclosure when the secondary battery is fully assembled.

The electrode assembly 150 of the secondary battery 100 includes a population of electrode structures 102 and a population of counter-electrode structures 103. The members of the population of electrode structures 102 (also referred to as the electrode structures 102) are stacked in alternating succession with the members of the population of counter-electrode structures 103 (also referred to as the counter-electrode structures 103). A separator structure 108, also referred to as a separator layer 108 or separator 108, is stacked between each pair of an electrode structure 102 and an adjacent counter-electrode structure 103. Each of the electrode structures 102, counter-electrode structures, and separator structures 108 has a dimension in the X-axis, Y-axis and Z-axis, respectively. The X-axis, Y-axis and Z-axis are each mutually perpendicular, akin to a Cartesian coordinate system. As used herein, dimensions of each of the electrode structures 102, counter-electrode structures, and separator structures 108 in the Z-axis may be referred to as a “height”, dimensions in the X-axis may be referred to as a “length” and dimensions in the Y-axis may be referred to as a “width.” The secondary battery 100 defines a transverse direction in the X-axis, a longitudinal direction in the Y-axis, and a vertical direction in the Z-axis. The X-axis may also be referred to herein as a transverse axis, the Y-axis may also be referred to herein as a longitudinal axis, and the Z-axis may also be referred to herein as a vertical axis. The electrode structures 102, counter-electrode structures 103, and separator structures 108 are stacked in the longitudinal or Y-axis direction and arranged as a multilayer stack 200 (see FIG. 2).

Each of the electrode structures 102 includes at least one electrode active material layer 104 and each of the counter-electrode structures 103 includes at least one counter-electrode active material layer 106. The electrode active material layer 104 may include anodically active material or cathodically active material and the counter-electrode active material layer 106 may include the opposite active material (cathodically active material or anodically active material) as the electrode active material layer 104. In the example secondary battery 100, the electrode active material layer 104 includes anodically active material and may be referred to as an anodically active material layer 104. Correspondingly, in the example secondary battery 100, the counter-electrode active material layer 104 includes cathodically active material and may be referred to as a cathodically active material layer 106. The anodically active material layer 104 and the cathodically active material layer 106 are electrically isolated from each other by a separator layer 108 positioned between the respective electrode structure 102 and counter-electrode structure 103. It should be appreciated that in suitable embodiments of the present disclosure, any number of the electrode structures 102, counter-electrode structures 103, and separator structures 108 may be used, such as from 1 to 200 or more of each of the electrode structures 102, counter-electrode structures 103, and separator structures 108 in the secondary battery 100.

Referring to FIG. 1, the secondary battery 100 includes a first busbar 110 that is in electrical contact with the anodically active material layer 104 of the electrode structures 102 and a second busbar 112 that is in electrical contact with the cathodically active material layer 106 of the counter-electrode structures 103 via electrode tabs 114. The electrode tabs 114 are only visible on a first side 120 of the secondary battery 100 in FIG. 1, although a different set of the electrode tabs 114 are present on a second side 121 of the secondary battery. The first busbar 110 is shown with a portion cut away in FIG. 1 to show the underlying electrode tabs 114. The electrode tabs 114 on the first side 120 of the secondary battery 100 are electrically coupled with the first busbar 110, which may be referred to as an anode busbar. The electrode tabs 114 on the second side 121 of the secondary battery 100 (not visible in FIG. 1) are electrically coupled to the second busbar 112, which may be referred to as a cathode busbar. The electrode tabs 114 on the first side 120 extend from the electrode structures 102 and the electrode tabs 114 on the second side 121 extend from the counter-electrode structures 103. The electrode tabs 114 on the second side 121 of the secondary battery may also be referred to as counter-electrode tabs 114.

In this embodiment, the first busbar 110 is electrically coupled with a first electrical terminal 124 of the secondary battery 100, which is electrically conductive. When the first busbar 110 comprises an anode busbar for the secondary battery 100, the first electrical terminal 124 comprises a negative terminal for the secondary battery 100. Further in this embodiment, the second busbar 112 is electrically coupled with a second electrical terminal 125 of the secondary battery 100, which is electrically conductive. When the second busbar 112 comprises a cathode busbar for the secondary battery 100, the second electrical terminal 125 comprises a positive terminal for the secondary battery 100.

In one embodiment, a casing 116, which may be referred to as a constraint, may be applied over one or both of the X-Y surfaces of the electrode assembly 150. In the embodiment shown in FIG. 1, the casing 116 includes a plurality of perforations 118 to facilitate distribution or flow of an electrolyte solution once the secondary battery 100 has been fully assembled. In one embodiment, the casing 116 comprises stainless steel, such as SS301, SS316, 440C or 440C hard. In other embodiments, the casing 116 comprises aluminum (e.g., aluminum 7075-T6, hard H18, etc.), titanium (e.g., 6Al-4V), beryllium, beryllium copper (hard), copper (O₂ free, hard), nickel, other metals or metal alloys, composite, polymer, ceramic (e.g., alumina (e.g., sintered or Coorstek AD96), zirconia (e.g., Coorstek YZTP), yttriastabilizedzirconia (e.g., ENrG E-Strate®)), glass, tempered glass, polyetheretherketone (PEEK) (e.g., Aptiv 1102), PEEK with carbon (e.g., Victrex 90HMF40 or Xycomp 1000-04), polyphenylene sulfide (PPS) with carbon (e.g., Tepex Dynalite 207), polyetheretherketone (PEEK) with 30% glass (e.g., Victrex 90HMF40 or Xycomp 1000-04), polyimide (e.g., Kapton®), E Glass Std Fabric/Epoxy, 0 deg, E Glass UD/Epoxy, 0 deg, Kevlar Std Fabric/Epoxy, 0 deg, Kevlar UD/Epoxy, 0 deg, Carbon Std Fabric/Epoxy, 0 deg, Carbon UD/Epoxy, 0 deg, Toyobo Zylon® HM Fiber/Epoxy, Kevlar 49 Aramid Fiber, S Glass Fibers, Carbon Fibers, Vectran UM LCP Fibers, Dyneema, Zylon, or other suitable material.

In some embodiments, the casing 116 comprises a sheet having a thickness in the range of about 10 to about 100 micrometers (μm). In one embodiment, the casing 116 comprises a stainless-steel sheet (e.g., SS316) having a thickness of about 30 μm. In another embodiment, the casing 116 comprises an aluminum sheet (e.g., 7075-T6) having a thickness of about 40 μm. In another embodiment, the casing 116 comprises a zirconia sheet (e.g., Coorstek YZTP) having a thickness of about 30 μm. In another embodiment, the casing 116 comprises an E Glass UD/Epoxy 0 deg sheet having a thickness of about 75 μm. In another embodiment, the casing 116 comprises 12 μm carbon fibers at >50% packing density.

In this embodiment, the casing 116 defines a first major surface 126 and a second major surface 127 that opposes the first major surface 126. The major surfaces 126, 127 of the casing 116 may be substantially planar is some embodiments.

With reference to FIG. 2, which depicts a partial section of the secondary battery 100 taken along lines 1-1 in FIG. 1, individual layers of a portion of the multilayer stack 200 included in the electrode assembly 150 are shown. The individual layers include the electrode structures 102, the counter-electrode structures 103, and the separator structures 108 between adjacent electrode structures 102 and counter-electrode structures 103. The separator layer 108 may be an ionically permeable microporous polymeric material suitable for use as a separator in a secondary battery. In an embodiment, the separator layer 108 is coated with ceramic particles on one or both sides.

The portion of the multilayer stack 200 is shown in FIG. 2 with an electrode structure 102 in the center and counter-electrode structures 103 on each side of the electrode structure 103. The electrode structure 102 is an anode structure in the example embodiment and includes an anode current collector 202. The anode current collector 102 may comprise or be electrically coupled with, one of the electrode tabs 114 on one of the sides 120, 121 of the secondary battery 100 (see FIG. 1). The electrode structure 102 further includes the anodically active material layer 104 on each side of the anode current collector 202. The counter-electrode structures 103 are each cathode structures in the example embodiment. Each counter-electrode structure 103 includes a cathode current collector 204 and the cathodically active material layer 106 on each side of the cathode current collector 204. The cathode current collector 204 may comprise or be electrically coupled with, one of the electrode tabs 114 on one of the sides 120, 121 of the secondary battery 100 that is different than the anode current collector 202. The anodically active material layers 104 of the electrode structure 102 are each adjacent to the cathodically active material layer 106 of one of the counter-electrode structures 103. Each separator layer 108 is positioned between and electrically isolates an adjacent pair of an anodically active material layer 104 and a cathodically active material layer 106.

The relative placement of the electrode structures 102 and the counter-electrode structures 103 in the portion of the multilayer stack 200 shown in FIG. 2 is by way of example only and varies along sections of the secondary battery 100 taken along lines other than lines 1-1 in FIG. 1. In another example portion of the multilayer stack 200, the placement of the electrode structure 102 and the counter-electrode structure 103 may be swapped from the placement shown in FIG. 2, such that a counter-electrode structure 103 is toward the center and electrode structures 102 are distal to (i.e., on each side of) the counter-electrode structure 103.

The multilayer stack 200 of the electrode assembly 150 includes stacked groups of a counter-electrode structure 103 including the cathode current collector 204 and the cathodically active material layer 106 on at least one side of the cathode current collector 204, one or more separator layers 108, and an electrode structure 102 including the anode current collector 202 and the anodically active material layer 104 on at least one side of the anode current collector 202, with at least of the one or more separator layers 108 between the at least one anodically active material layer 104 that faces the at least one cathodically active material layer 106. The stacked groups of the multilayer stack 200 may also be referred to as “unit cells.” A unit cell may be considered to include, from left to right in stacked succession as shown in FIG. 2, the anode current collector 202, the anodically active material layer 104, the separator layer 108, the cathodically active material layer 106, and the cathode current collector 204. This arrangement is depicted as a unit cell 200A in FIG. 2. Additionally and/or alternatively, a unit cell may be considered to include, from left to right in stacked succession as shown in FIG. 2, the separator layer 108, a first layer of the cathodically active material layer 106, the cathode current collector 204, a second layer of the cathodically active material layer 106, the separator layer 108, a first layer of the anodically active material layer 104, the anode current collector 202, a second layer of the anodically active material layer 104, and the separator layer 108. This arrangement is depicted as a unit cell 200B in FIG. 2.

The counter-electrode structure 103 including the cathodically active material layer 106 and the cathode current collector 204 may be referred to as a cathode structure 103. The electrode structure 102 including the anodically active material layer 104 and the anode current collector 202 may be referred to as an anode structure 102. Collectively, the population of the cathode structures 103 for the secondary battery 100 may be referred to as a positive electrode 208 of the secondary battery 100, and the population of the anode structures 102 for the secondary battery 100 (only one of the anode structures 102 are shown in FIG. 2) may be referred to as the negative electrode 209 of the secondary battery 100.

A voltage difference V exists between adjacent cathode structures 103 and anode structures 102, with the adjacent structures considered a bilayer in some embodiments. Each bilayer has a capacity C determined by the makeup and configuration of the cathode structures 103 and the anode structures 102. In this embodiment, each bilayer produces a voltage difference of about 4.35 volts. In other embodiments, each bilayer has a voltage difference of about 0.5 volts, about 1.0 volts, about 1.5 volts, about 2.0 volts, about 2.5 volts, about 3.0 volts, about 3.5 volts, about 4.0 volts, 4.5 volts, about 5.0 volts, between 4 and 5 volts, or any other suitable voltage. During cycling between a charged state and a discharged state, the voltage may vary, for example, between about 2.5 volts and about 4.35 volts. The capacity C of a bilayer in this embodiment is about 3.5 milliampere-hour (mAh). In other embodiments, the capacity C of a bilayer is about 2 mAh, less than 5 mAh, or any other suitable capacity. In some embodiments, the capacity C of a bilayer may be up to about 10 mAh.

The cathode current collector 204 may comprise aluminum, nickel, cobalt, titanium, and tungsten, or alloys thereof, or any other material suitable for use as a cathode current collector layer. In general, the cathode current collector 204 will have an electrical conductivity of at least about 10³ Siemens/cm. For example, in one such embodiment, the cathode current collector 204 will have a conductivity of at least about 10⁴ Siemens/cm. By way of further example, in one such embodiment, the cathode current collector 204 will have a conductivity of at least about 10⁵ Siemens/cm. In general, the cathode current collector 204, may comprise a metal such as aluminum, carbon, chromium, gold, nickel, NiP, palladium, platinum, rhodium, ruthenium, an alloy of silicon and nickel, titanium, or a combination thereof (see “Current collectors for positive electrodes of lithium-based batteries” by A. H. Whitehead and M. Schreiber, Journal of the Electrochemical Society, 152(11) A2105-A2113 (2005)). By way of further example, in one embodiment, the cathode current collector 204 comprises gold or an alloy thereof such as gold silicide. By way of further example, in one embodiment, the cathode current collector 204 comprise nickel or an alloy thereof such as nickel silicide.

The cathodically active material layer 106 may be an intercalation-type chemistry active material, a conversion chemistry active material, or a combination thereof.

Exemplary conversion chemistry materials useful in the present disclosure include, but are not limited to, S (or Li₂S in the lithiated state), LiF, Fe, Cu, Ni, FeF₂, FeO_{d}F_{3.2d}, FeF₃, CoF₃, CoF₂, CuF₂, NiF₂, where 0≤d≤0.5, and the like.

Exemplary cathodically active material layers 106 also include any of a wide range of intercalation-type cathodically active materials. For example, for a lithium-ion battery, the cathodically active material may comprise a cathodically active material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathodically active materials include lithium cobalt oxide (LiCoO₂), LiNi_{0.5}Mn_{1.5}O₄, Li(NiₓCo_{y}Al_{z})O₂, lithium metal phosphate (e.g., lithium iron phosphate, LiFePO₄), Li₂MnO₄, V₂O₅, molybdenum oxysulfides, phosphates, silicates, vanadates, sulfur, sulfur compounds, oxygen (air), lithium nickel manganese cobalt oxide (Li(NiₓMn_{y}Co_{z})O₂), and combinations thereof.

In general, the cathodically active material layers 106 will have a thickness of at least about 20 μm. For example, in one embodiment, the cathodically active material layers 106 will have a thickness of at least about 40 μm. By way of further example, in one such embodiment, the cathodically active material layers 106 will have a thickness of at least about 60 μm. By way of further example, in one such embodiment, the cathodically active material layers 106 will have a thickness of at least about 100 μm. Typically, the cathodically active material layers 106 will have a thickness of less than about 90 μm or less than about 70 μm.

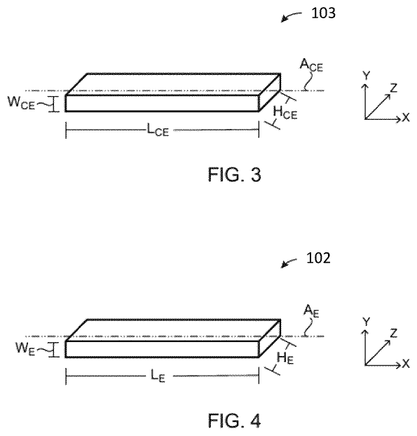

FIG. 3 depicts one of the cathode structures 103 of FIGS. 1 and 2. Each cathode structure 103 has a length (L_{CE}) measured along the transverse axis (A_{CE}), a width (W_{CE}) measured along the longitudinal direction or Y-axis, and a height (H_{CE}) measured in a vertical direction that is perpendicular to each of the directions of measurement of the length L_{CE} and the width W_{CE}.

The length L_{CE} of the cathode structures 103 will vary depending upon the secondary battery 100 and its intended use. In general, however, each cathode structure 103 will typically have a length L_{CE} in the range of about 5 millimeters (mm) to about 500 mm. For example, in one such embodiment, each cathode structure 103 has a length L_{CE} of about 10 mm to about 250 mm. By way of further example, in one such embodiment each cathode structure 103 has a length L_{CE} of about 25 mm to about 100 mm. According to one embodiment, the cathode structures 103 include one or more first electrode members having a first length, and one or more second electrode members having a second length that is different than the first length. In yet another embodiment, the different lengths for the one or more first electrode members and one or more second electrode members may be selected to accommodate a predetermined shape for an electrode assembly, such as an electrode assembly shape having different dimensions along one or more of the longitudinal and/or transverse axis, and/or to provide predetermined performance characteristics for the secondary battery 100.

The width W_{CE} of the cathode structures 103 will also vary depending upon the secondary battery 100 and its intended use. In general, however, the cathode structures 103 will typically have a width W_{CE} within the range of about 0.01 mm to 2.5 mm. For example, in one embodiment, the width W_{CE} of each cathode structure 103 will be in the range of about 0.025 mm to about 2 mm. By way of further example, in one embodiment, the width W_{CE} of each cathode structure 103 will be in the range of about 0.05 mm to about 1 mm. According to one embodiment, the cathode structures 103 include one or more first electrode members having a first width, and one or more second electrode members having a second width that is different than the first width. In yet another embodiment, the different widths for the one or more first electrode members and one or more second electrode members may be selected to accommodate a predetermined shape for the secondary battery 100, such as an assembly having different dimensions along one or more of the longitudinal and/or transverse axis, and/or to provide predetermined performance characteristics for the secondary battery 100.

The height H_{CE} of the cathode structures 103 will also vary depending upon the secondary battery 100 and its intended use. In general, however, the cathode structures 103 will typically have a height H_{CE} within the range of about 0.05 mm to about 25 mm. For example, in one embodiment, the height H_{CE} of each cathode structure 103 will be in the range of about 0.05 mm to about 5 mm. By way of further example, in one embodiment, the height H_{CE} of each cathode structure 103 will be in the range of about 0.1 mm to about 1 mm. According to one embodiment, the cathode structures 103 include one or more first cathode members having a first height, and one or more second cathode members having a second height that is different than the first height. In yet another embodiment, the different heights for the one or more first cathode members and one or more second cathode members may be selected to accommodate a predetermined shape for the secondary battery 100, such as a shape having different dimensions along one or more of the longitudinal and/or transverse axis, and/or to provide predetermined performance characteristics for the secondary battery 100.

In general, each cathode structure 103 has a length L_{CE} that is substantially greater than its width W_{CE} and substantially greater than its height H_{CE}. For example, in one embodiment, the ratio of L_{CE} to each of W_{CE} and H_{CE} is at least 5:1, respectively (that is, the ratio of L_{CE} to W_{CE} is at least 5:1, respectively and the ratio of L_{CE} to H_{CE} is at least 5:1, respectively), for each cathode structure 103. By way of further example, in one embodiment the ratio of L_{CE} to each of W_{CE} and H_{CE} is at least 10:1 for each cathode structure 103. By way of further example, in one embodiment, the ratio of L_{CE} to each of W_{CE} and H_{CE} is at least 15:1 for each cathode structure 103. By way of further example, in one embodiment, the ratio of L_{CE} to each of W_{CE} and H_{CE} is at least 20:1 for each cathode structure 103.

In one embodiment, the ratio of the height H_{CE} to the width W_{CE} of the cathode structures 103 is at least 0.4:1, respectively. For example, in one embodiment, the ratio of H_{CE} to W_{CE} will be at least 2:1, respectively, for each cathode structure 103. By way of further example, in one embodiment, the ratio of H_{CE} to W_{CE} will be at least 10:1, respectively, for each cathode structure 103. By way of further example, in one embodiment, the ratio of H_{CE} to W_{CE} will be at least 20:1, respectively, for each cathode structure 103. Typically, however, the ratio of H_{CE} to W_{CE} will generally be less than 1,000:1, respectively, for each cathode structure 103. For example, in one embodiment, the ratio of H_{CE} to W_{CE} will be less than 500:1, respectively, for each cathode structure 103. By way of further example, in one embodiment, the ratio of H_{CE} to W_{CE} will be less than 100:1, respectively. By way of further example, in one embodiment, the ratio of H_{CE} to W_{CE} will be less than 10:1, respectively. By way of further example, in one embodiment, the ratio of H_{CE} to W_{CE} will be in the range of about 2:1 to about 100:1, respectively, for each cathode structure 103.

### Anodic Type Structures and Materials

Referring again to FIG. 2, the anode current collector 202 in the multilayer stack 200 may comprise a conductive material such as copper, carbon, nickel, stainless-steel, cobalt, titanium, and tungsten, and alloys thereof, or any other material suitable as an anode current collector layer. In general, the anode current collector 202 will have an electrical conductivity of at least about 10³ Siemens/cm. For example, in one such embodiment, the anode current collector 202 will have a conductivity of at least about 10⁴ Siemens/cm. By way of further example, in one such embodiment, the anode current collector 202 will have a conductivity of at least about 10⁵ Siemens/cm.

In general, the anodically active material layers 104 in the multilayer stack 200 may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo2O4; (f) particles of graphite and carbon; (g) lithium metal; and (h) combinations thereof.

Exemplary anodically active material layers 104 include carbon materials such as graphite and soft or hard carbons, or graphene (e.g., single-walled or multi-walled carbon nanotubes), or any of a range of metals, semi-metals, alloys, oxides, nitrides and compounds capable of intercalating lithium or forming an alloy with lithium. Specific examples of the metals or semi-metals capable of constituting the anode material include graphite, tin, lead, magnesium, aluminum, boron, gallium, silicon, Si/C composites, Si/graphite blends, silicon oxide (SiOx), porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In one exemplary embodiment, the anodically active material comprises aluminum, tin, or silicon, or an oxide thereof, a nitride thereof, a fluoride thereof, or other alloy thereof. In another exemplary embodiment, the anodically active material layers 104 comprise silicon or an alloy or oxide thereof.

In one embodiment, the anodically active material layers 104 are microstructured to provide a significant void volume fraction to accommodate volume expansion and contraction as lithium ions (or other carrier ions) are incorporated into or leave the anodically active material layers 104 during charging and discharging processes for the secondary battery 100. In general, the void volume fraction of (each of) the anodically active material layer 104 is at least 0.1. Typically, however, the void volume fraction of (each of) the anodically active material layer 104 is not greater than 0.8. For example, in one embodiment, the void volume fraction of (each of) the anodically active material layer 104 is about 0.15 to about 0.75. By way of the further example, in one embodiment, the void volume fraction of (each of) the anodically active material layer 104 is about 0.2 to about 0.7. By way of the further example, in one embodiment, the void volume fraction of (each of) the anodically active material layer 104 is about 0.25 to about 0.6.

Depending upon the composition of the microstructured anodically active material layers 104 and the method of their formation, the microstructured anodically active material layers 104 may comprise macroporous, microporous, or mesoporous material layers or a combination thereof, such as a combination of microporous and mesoporous, or a combination of mesoporous and macroporous. Microporous material is typically characterized by a pore dimension of less than 10 nanometer (nm), a wall dimension of less than 10 nm, a pore depth of 1 μm to 50 μm, and a pore morphology that is generally characterized by a “spongy” and irregular appearance, walls that are not smooth, and branched pores. Mesoporous material is typically characterized by a pore dimension of 10 nm to 50 nm, a wall dimension of 10 nm to 50 nm, a pore depth of 1 μm to 100 μm, and a pore morphology that is generally characterized by branched pores that are somewhat well defined or dendritic pores. Macroporous material is typically characterized by a pore dimension of greater than 50 nm, a wall dimension of greater than 50 nm, a pore depth of 1 μm to 500 μm, and a pore morphology that may be varied, straight, branched, or dendritic, and smooth or rough-walled. Additionally, the void volume may comprise open or closed voids, or a combination thereof. In one embodiment, the void volume comprises open voids, that is, the anodically active material layers 104 contain voids having openings at the lateral surface of the anodically active material layers through which lithium ions (or other carrier ions) can enter or leave. For example, lithium ions may enter the anodically active material layers 104 through the void openings after leaving the cathodically active material layers 106. In another embodiment, the void volume comprises closed voids, that is, the anodically active material layers 104 contain voids that are enclosed. In general, open voids can provide greater interfacial surface area for the carrier ions whereas closed voids tend to be less susceptible to SEI formation, while each provides room for the expansion of anodically active material layers 104 upon the entry of carrier ions. In certain embodiments, therefore, it is preferred that the anodically active material layers 104 comprise a combination of open and closed voids.

In one embodiment, the anodically active material layers 104 comprise porous aluminum, tin or silicon or an alloy, an oxide, or a nitride thereof. Porous silicon layers may be formed, for example, by anodization, by etching (e.g., by depositing precious metals such as gold, platinum, silver or gold/palladium on the surface of single crystal silicon and etching the surface with a mixture of hydrofluoric acid and hydrogen peroxide), or by other methods known in the art such as patterned chemical etching. Additionally, the porous anodically active material layers 104 will generally have a porosity fraction of at least about 0.1, but less than 0.8 and have a thickness of about 1 μm to about 100 μm. For example, in one embodiment, the anodically active material layers 104 comprise porous silicon, have a thickness of about 5 μm to about 100 μm, and have a porosity fraction of about 0.15 to about 0.75. By way of further example, in one embodiment, the anodically active material layers 104 comprise porous silicon, have a thickness of about 10 μm to about 80 μm, and have a porosity fraction of about 0.15 to about 0.7. By way of further example, in one such embodiment, the anodically active material layers 104 comprise porous silicon, have a thickness of about 20 μm to about 50 μm, and have a porosity fraction of about 0.25 to about 0.6. By way of further example, in one embodiment, the anodically active material layers 104 comprise a porous silicon alloy (such as nickel silicide), have a thickness of about 5 μm to about 100 μm, and have a porosity fraction of about 0.15 to about 0.75.

In another embodiment, the anodically active material layers 104 comprise fibers of aluminum, tin, or silicon, or an alloy thereof. Individual fibers may have a diameter (thickness dimension) of about 5 nm to about 10,000 nm and a length generally corresponding to the thickness of the anodically active material layers 104. Fibers (nanowires) of silicon may be formed, for example, by chemical vapor deposition or other techniques known in the art such as vapor liquid solid (VLS) growth and solid liquid solid (SLS) growth. Additionally, the anodically active material layers 104 will generally have a porosity fraction of at least about 0.1, but less than 0.8 and have a thickness of about 1 μm to about 200 μm. For example, in one embodiment, the anodically active material layers 104 comprise silicon nanowires, have a thickness of about 5 μm to about 100 μm, and a porosity fraction of about 0.15 to about 0.75. By way of further example, in one embodiment, the anodically active material layers 104 comprise silicon nanowires, have a thickness of about 10 μm to about 80 μm, and a porosity fraction of about 0.15 to about 0.7. By way of further example, in one such embodiment, the anodically active material layers 104 comprise silicon nanowires, have a thickness of about 20 μm to about 50 μm, and a porosity fraction of about 0.25 to about 0.6. By way of further example, in one embodiment, the anodically active material layers 104 comprise nanowires of a silicon alloy (such as nickel silicide), have a thickness of about 5 μm to about 100 μm, and a porosity fraction of about 0.15 to about 0.75.

In yet other embodiments, the anodically active material layers 104 are coated with a particulate lithium material selected from the group consisting of stabilized lithium metal particles, e.g., lithium carbonate-stabilized lithium metal powder, lithium silicate stabilized lithium metal powder, or other source of stabilized lithium metal powder or ink. The particulate lithium material may be applied on the anodically active material layers 104 by spraying, loading, or otherwise disposing the lithium particulate material onto the anodically active material layers 104 at a loading amount of about 0.05 mg/cm² to 5 mg/cm², e.g., about 0.1 mg/cm² to 4 mg/cm², or even about 0.5 mg/cm² to 3 mg/cm². The average particle size (D₅₀) of the lithium particulate material may be 5 μm to 200 μm, e.g., about 10 μm to 100 μm, 20 μm to 80 μm, or even about 30 μm to 50 μm. The average particle size (D₅₀) may be defined as a particle size corresponding to 50% in a cumulative volume-based particle size distribution curve. The average particle size (D₅₀) may be measured, for example, using a laser diffraction method.

In one embodiment, the anode current collector 202, has an electrical conductance that is substantially greater than the electrical conductance of its associated anodically active material layers 104. For example, in one embodiment, the ratio of the electrical conductance of the anode current collector 202 to the electrical conductance of the anodically active material layers 104 is at least 100:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 500:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 1000:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 5000:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 10,000:1 when there is an applied current to store energy in the secondary battery 100 or an applied load to discharge the secondary battery 100.

FIG. 4 depicts one of the anode structures 102 of FIGS. 1 and 2 of an exemplary embodiment. Each anode structure 102 has a length (L_{E}) measured along a transverse axis (A_{E}), a width (W_{E}) measured along the longitudinal direction or Y-axis, and a height (H_{E}) measured in a vertical direction that is orthogonal to each of the directions of measurement of the length L_{E} and the width W_{E}.

The length L_{E} of the anode structures 102 will vary depending upon the secondary battery 100 and its intended use. In general, however, the anode structures 102 will typically have a length L_{E} in the range of about 5 millimeter (mm) to about 500 mm. For example, in one such embodiment, the anode structures 102 have a length L_{E} of about 10 mm to about 250 mm. By way of further example, in one such embodiment, the anode structures 102 have a length L_{E} of about 25 mm to about 100 mm. According to one embodiment, the anode structure 102 include one or more first electrode members having a first length, and one or more second electrode members having a second length that is different than the first length. In yet another embodiment, the different lengths for the one or more first electrode members and the one or more second electrode members may be selected to accommodate a predetermined shape for the secondary battery 100, such as a shape having different dimensions along one or more of the longitudinal and/or transverse axis, and/or to provide predetermined performance characteristics for the secondary battery 100.

The width W_{E} of the anode structures 102 will also vary depending upon the secondary battery 100 and its intended use. In general, however, each anode structure 102 will typically have a width W_{E} within the range of about 0.01 mm to 2.5 mm. For example, in one embodiment, the width W_{E} of each anode structure 102 will be in the range of about 0.025 mm to about 2 mm. By way of further example, in one embodiment, the width W_{E} of each anode structure 102 will be in the range of about 0.05 mm to about 1 mm. According to one embodiment, the anode structures 102 include one or more first electrode members having a first width, and one or more second electrode members having a second width that is different than the first width. In yet another embodiment, the different widths for the one or more first electrode members and one or more second electrode members may be selected to accommodate a predetermined shape for the secondary battery 100, such as a shape having different dimensions along one or more of the longitudinal and/or transverse axis, and/or to provide predetermined performance characteristics for the secondary battery 100.

The height H_{E} of the anode structures 102 will also vary depending upon the secondary battery 100 and its intended use. In general, however, the anode structures 102 will typically have a height H_{E} within the range of about 0.05 mm to about 25 mm. For example, in one embodiment, the height H_{E} of each anode structure 102 will be in the range of about 0.05 mm to about 5 mm. By way of further example, in one embodiment, the height H_{E} of each anode structure 102 will be in the range of about 0.1 mm to about 1 mm. According to one embodiment, the anode structures 102 include one or more first electrode members having a first height, and one or more second electrode members having a second height that is different than the first height. In yet another embodiment, the different heights for the one or more first electrode members and one or more second electrode members may be selected to accommodate a predetermined shape for the secondary battery 100, such as a shape having different dimensions along one or more of the longitudinal and/or transverse axis, and/or to provide predetermined performance characteristics for the secondary battery 100.

In general, the anode structures 102 each have a length L_{E} that is substantially greater than each of its width W_{E} and its height H_{E}. For example, in one embodiment, the ratio of L_{E} to each of W_{E} and H_{E} is at least 5:1, respectively (that is, the ratio of L_{E} to W_{E} is at least 5:1, respectively and the ratio of L_{E} to H_{E} is at least 5:1, respectively), for each anode structure 102. By way of further example, in one embodiment, the ratio of L_{E} to each of W_{E} and H_{E} is at least 10:1. By way of further example, in one embodiment, the ratio of L_{E} to each of W_{E} and H_{E} is at least 15:1. By way of further example, in one embodiment, the ratio of L_{E} to each of W_{E} and H_{E} is at least 20:1, for each anode structure 102.

In one embodiment, the ratio of the height H_{E} to the width W_{E} of the anode structures 102 is at least 0.4:1, respectively. For example, in one embodiment, the ratio of H_{E} to W_{E} will be at least 2:1, respectively, for each anode structure 102. By way of further example, in one embodiment, the ratio of H_{E} to W_{E} will be at least 10:1, respectively. By way of further example, in one embodiment, the ratio of H_{E} to W_{E} will be at least 20:1, respectively. Typically, however, the ratio of H_{E} to W_{E} will generally be less than 1,000:1, respectively. For example, in one embodiment, the ratio of H_{E} to W_{E} will be less than 500:1, respectively. By way of further example, in one embodiment, the ratio of H_{E} to W_{E} will be less than 100:1, respectively. By way of further example, in one embodiment, the ratio of H_{E} to W_{E} will be less than 10:1, respectively. By way of further example, in one embodiment, the ratio of H_{E} to W_{E} will be in the range of about 2:1 to about 100:1, respectively, for each anode structure 102.

### Separator Structures, Separator Materials, and Electrolytes

Referring again to FIGS. 1 and 2, the separator layer(s) 108 separate the cathode structures 103 from the anode structures 102. The separator layers 108 are made of electrically insulating but ionically permeable separator material. The separator layers 108 are adapted to electrically isolate each member of the plurality of the cathode structures 103 from each member of the plurality of the anode structures 102. Each separator layer 108 will typically include a microporous separator material that can be permeated with a non-aqueous electrolyte; for example, in one embodiment, the microporous separator material includes pores having a diameter of at least 50 Angstroms (Å), more typically in the range of about 2,500 Å, and a porosity in the range of about 25% to about 75%, more typically in the range of about 35% to 55%

In general, the separator layers 108 will each have a thickness of at least about 4 μm. For example, in one embodiment, the separator layers 108 will have a thickness of at least about 8 μm. By way of further example, in one such embodiment, the separator layers 108 will have a thickness of at least about 12 μm. By way of further example, in one such embodiment, the separator layers 108 will have a thickness of at least about 15 μm. In some embodiments, the separator layers 108 will have a thickness of up to 25 μm, up to 50 μm, or any other suitable thickness. Typically, however, the separator layers 108 will have a thickness of less than about 12 μm or less than about 10 μm.

In general, the material of the separator layers 108 may be selected from a wide range of material having the capacity to conduct carrier ions between the anodically active material layers 104 and the cathodically active material layers 106 of the multilayer stack 200. For example, the separator layers 108 may comprise a microporous separator material that may be permeated with a liquid, non-aqueous electrolyte. Alternatively, the separator layers 108 may comprise a gel or solid electrolyte capable of conducting carrier ions between the anodically active material layers 104 and the cathodically active material layers 106 of the multilayer stack 200.

In one embodiment, the separator layers 108 may comprise a polymer-based electrolyte. Exemplary polymer electrolytes include PEO-based polymer electrolytes and polymer-ceramic composite electrolytes.

In another embodiment, the separator layers 108 may comprise an oxide-based electrolyte. Exemplary oxide-based electrolytes include lithium lanthanum titanate (Li_{0.34}La_{0.56}TiO₃), Al-doped lithium lanthanum zirconate (Li_{6.24}La₃Zr₂Al_{0.24}O_{11.98}), Ta-doped lithium lanthanum zirconate (Li_{6.4}La₃Zr_{1.4}Ta_{0.6}O₁₂), and lithium aluminum titanium phosphate (Li_{1.4}Al_{0.4}Ti_{1.6}(PO₄)₃).

In another embodiment, the separator layers 108 may comprise a solid electrolyte. Exemplary solid electrolytes include sulfide-based electrolytes such as lithium tin phosphorus sulfide (Li₁₀SnP₂S₁₂), lithium phosphorus sulfide (β-Li₃PS₄), and lithium phosphorus sulfur chloride iodide (Li₆PS₅Cl_{0.9}I_{0.1}).

In some embodiments, the separator layers 108 may comprise a solid-state lithium ion conducting ceramic, such as a lithium-stuffed garnet.

In one embodiment, the separator layers 108 comprise a microporous separator material comprising a particulate material and a binder, with the microporous separator material having a porosity (void fraction) of at least about 20 vol. %. The pores of the microporous separator material will have a diameter of at least 50 Å and will typically fall within the range of about 250 Å to about 2,500 Å. The microporous separator material will typically have a porosity of less than about 75%. In one embodiment, the microporous separator material has a porosity (void fraction) of at least about 25 vol %. In one embodiment, the microporous separator material will have a porosity of about 35-55%.

The binder for the microporous separator material may be selected from a wide range of inorganic or polymeric materials. For example, in one embodiment, the binder is an organic material selected from the group consisting of silicates, phosphates, aluminates, aluminosilicates, and hydroxides such as magnesium hydroxide, calcium hydroxide, etc. For example, in one embodiment, the binder is a fluoropolymer derived from monomers containing vinylidene fluoride, hexafluoropropylene, tetrafluoropropene, and the like. In another embodiment, the binder is a polyolefin such as polyethylene, polypropylene, or polybutene, having any of a range of varying molecular weights and densities. In another embodiment, the binder is selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In another embodiment, the binder is selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, and polyethylene oxide. In another embodiment, the binder is selected from the group consisting of acrylates, styrenes, epoxies, and silicones. In another embodiment, the binder is a copolymer or blend of two or more of the aforementioned polymers.

The particulate material comprised by the microporous separator material may also be selected from a wide range of materials. In general, such materials have a relatively low electronic and ionic conductivity at operating temperatures and do not corrode under the operating voltages of the battery electrode or current collector contacting the microporous separator material. For example, in one embodiment, the particulate material has a conductivity for carrier ions (e.g., lithium) of less than 1×10⁻⁴ Siemens/cm (S/cm). By way of further example, in one embodiment, the particulate material has a conductivity for carrier ions of less than 1×10⁻⁵ S/cm. By way of further example, in one embodiment, the particulate material has a conductivity for carrier ions of less than 1×10⁻⁶ S/cm. Exemplary particulate materials include particulate polyethylene, polypropylene, a TiO₂-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in one embodiment, the particulate material comprises a particulate oxide or nitride such as TiO₂, SiO₂, Al₂O₃, GeO₂, B₂O₃, Bi₂O₃, BaO, ZnO, ZrO₂, BN, Si₃N₄, and Ge3N4. See, for example, P. Arora and J. Zhang, “Battery Separators” Chemical Reviews 2004, 104, 4419-4462). In one embodiment, the particulate material will have an average particle size of about 20 nm to 2 μm, more typically 200 nm to 1.5 μm. In one embodiment, the particulate material will have an average particle size of about 500 nm to 1 μm.

In an alternative embodiment, the particulate material comprised by the microporous separator material may be bound by techniques such as sintering, binding, curing, etc. while maintaining the void fraction desired for electrolyte ingress to provide the ionic conductivity for the functioning of the battery.

In the secondary battery 100 (see FIG. 1), the microporous separator material of the separator layers 108 are permeated with a non-aqueous electrolyte suitable for use as a secondary battery electrolyte. Typically, the non-aqueous electrolyte comprises a lithium salt and/or mixture of salts dissolved in an organic solvent and/or solvent mixture. Exemplary lithium salts include inorganic lithium salts such as LiClO₄, LiBF₄, LiPF₆, LiAsF₆, LiCl, and LiBr; and organic lithium salts such as LiB(C₆H₅)₄, LiN(SO₂CF₃)₂, LiN(SO₂CF₃)₃, LiNSO₂CF₃, LiNSO₂CF₅, LiNSO₂C₄F₉, LiNSO₂C₅F₁₁, LiNSO₂C₆F₁₃, and LiNSO₂C₇F₁₅. Exemplary organic solvents to dissolve the lithium salt include cyclic esters, chain esters, cyclic ethers, and chain ethers. Specific examples of the cyclic esters include propylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

In one embodiment, the microporous separator material of the separator layers 108 may be permeated with a non-aqueous, organic electrolyte including a mixture of a lithium salt and a high-purity organic solvent. In addition, the electrolyte may be a polymer using a polymer electrolyte or a solid electrolyte.

### Additional Embodiments of the Present Disclosure

Embodiments of the present disclosure relate to interconnection techniques and designs that facilitate durable and reliable electrical connections between components of batteries (e.g., three-dimensional secondary batteries). A busbar-over-electrode interconnection may be used to establish and maintain mutual electrical connections between electrode substructures (e.g., a population of cathode structures 103 and/or a population of an anode structures 102 shown in FIGS. 1-4) and a respective electrical terminal (e.g., a first terminal 124 and/or a second terminal shown in FIG. 1) of a secondary battery (e.g., a secondary battery 100 shown in FIG. 1). In particular, the busbar-over-electrode interconnection facilitates establishing and maintaining electrical contact between a busbar (e.g., a first busbar 110 and/or a second busbar 112 shown in FIG. 1) of the secondary battery and an electrochemically active material layer of the respective electrode substructure (e.g., the anodically active material layer 104 and/or the cathodically active material layer 106 shown in FIG. 1) and, more specifically, between the busbar and electrode tabs (e.g., the electrode tabs 114 shown in FIG. 1) disposed along one or more sides (e.g., one or both of the sides 120, 121 shown in FIG. 1) of the secondary battery.

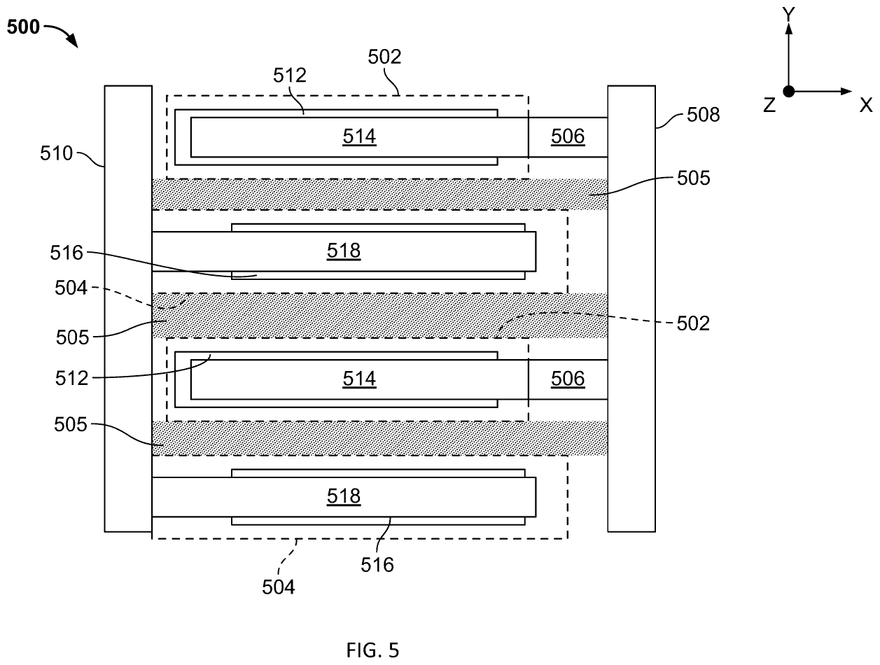

FIG. 5 is a simplified diagram of an example electrode assembly 500 for cycling between a charged state and a discharged state in a battery. The electrode assembly 500 includes a population of electrode structures 502, a population of counter-electrode structures 504, a population of separator structures 505, a population of current limiters 506, an electrode busbar 508, and a counter-electrode busbar 510. The example electrode assembly 500 is suitable for use in a three-dimensional secondary battery (e.g., the secondary battery 100), or another suitable energy storage device, in which the electrode structures 502 and counter-electrode structures 504 each extend a length along an X-axis direction and height along a Z-axis direction of the assembly 500 and are separated from each other along a Y-axis (or longitudinal) direction. In other embodiments, the electrode assembly 500 may be for use in a laminar secondary battery. Each electrode structure 502 may be similar to the cathode structure 103 or the anode structure 102 described above, and each counter-electrode structure 504 may be similar to the other of the cathode structure 103 or anode structure 102. The electrode busbar 508 may be similar to the first busbar 110 or the second busbar 112 described above, and the counter-electrode busbar 510 may be similar to the other of the first busbar 110 or second busbar 112. The electrode assembly 500 may also include conductive terminals (e.g., similar to the electrical terminals 124 and 125 shown in FIG. 1) each connected to one of the electrode busbar 508 and the counter-electrode busbar 510. Conductive terminals are omitted from the simplified diagram of FIG. 5.

In the example embodiment, the electrode structures 502 and counter-electrode structures 504 are generally rectangular and arranged in an interdigitated structure. That is, the electrode structures 502 and counter-electrode structures 504 extend from opposite electrode and counter-electrode busbars 508, 510 and alternate along the Y-axis direction. In other embodiments, other shapes and arrangements of the electrode structures 502 and counter-electrode structures 504 may be used. For example, the electrode assembly 500 (and the battery within which it is included) may have any of the shapes and/or arrangements described or shown in U.S. Pat. No. 9,166,230, which is hereby incorporated by reference in its entirety.

Each member of the population of electrode structures 502 includes an electrode active material 512 and an electrode current collector 514. In the example embodiment, the electrode structures 502 are electrically connected in parallel to the electrode busbar 508 through a current limiter 506. In other embodiments, some or all the electrode structures 508 may be electrically connected to the electrode busbar 508 without a current limiter. The electrode structures 502 may be anodic or cathodic, but all of the electrode structures 502 in the population are of the same type (anodic or cathodic) in the example embodiment. In some other embodiments, the electrode structures 502 may include anodic and cathodic structures.

Each member of the population of counter-electrode structures 504 includes a counter-electrode active material 516 and a counter-electrode current collector 518. The counter-electrode structures 504 are electrically connected in parallel to the counter-electrode busbar 510. In the illustrated embodiment, the counter-electrode structures are electrically connected to the counter-electrode busbar 510 without a current limiter. In other embodiments, some or all the counter-electrode structures 504 may be electrically connected to the counter-electrode busbar 510 through a current limiter (e.g., the current limiter 506). The counter-electrode structures 504 are all of the same type (anodic or cathodic) in the example embodiment, and are of the opposite type to the electrode structures 502. In some other embodiments, the counter-electrode structures 504 may include anodic and cathodic structures.

Although only two electrode structures 502 and two counter-electrode structures 504 are shown in FIG. 5, the electrode assembly 500 may have any number of electrode structures 502 and counter-electrode structures 504. The populations of electrode structures 502 and counter-electrode structures 504 will generally include the same number of members, but may include different numbers of electrode structures 502 and counter-electrode structures 504 in some embodiments. For example, some embodiments may begin and end with the same electrode structure 502 or counter-electrode structure 504, resulting in one more electrode structure 502 or counter-electrode structure 504. In some embodiments, the populations of electrode structures 502 and counter-electrode structures 504 include at least twenty members each. Some embodiments include populations of electrode structures 502 and counter-electrode structures 504 having about 10 members each, between 10 and 25 members each, between 25 and 250 members each, between 25 and 150 members each, between 50 and 150 members each, or up to 500 members each. In some embodiments, the electrode structures 502 or the counter-electrode structures 504 do not include an active material when discharged, and only the other of the counter-electrode structures 504 or the electrode structures 502 includes an active material when discharged.

The cathodic type of the electrode structure 502 or the counter-electrode structure 504 includes a current collector 514 or 518 that is a cathode current collector. The cathode current collector may comprise aluminum, nickel, cobalt, titanium, and tungsten, or alloys thereof, or any other material suitable for use as a cathode current collector layer. In general, the cathode current collector will have an electrical conductivity of at least about 10³ Siemens/cm. For example, in one such embodiment, the cathode current collector will have a conductivity of at least about 10⁴ Siemens/cm. By way of further example, in one such embodiment, the cathode current collector will have a conductivity of at least about 10⁵ Siemens/cm. In some embodiments, the cathode current collector is similar to the cathode current collector 204 described above.

The anodic type of the electrode structure 502 or the counter-electrode structure 504 includes a current collector 514 or 518 that is an anode current collector. The anode current collector may comprise a conductive material such as copper, carbon, nickel, stainless steel, cobalt, titanium, and tungsten, and alloys thereof, or any other material suitable as an anode current collector layer. In some embodiments, the anode current collector is similar to the anode current collector 202 described above.

The cathodic type of the electrode structure 502 or the counter-electrode structure 504 includes an active material 512 or 516 that is a cathodically active material. In some embodiments, the cathodically active material is similar to the cathodically active material layer 106 described above. The anodic type of the electrode structure 502 or the counter-electrode structure 504 includes an active material 512 or 516 that is an anodically active material. In some embodiments, the anodically active material is similar to the anodically active material layer 104 described above.

The separator structures 505 separate the electrode structures 502 from the counter-electrode structures 504. The separator structures 505 are made of electrically insulating but ionically permeable separator material. The separator structures 505 are adapted to electrically isolate each member of the population of electrode structures 502 from each member of the population of counter-electrode structures 504. Each separator structure 505 may be similar to the separator layer 108 described above.

The conductive terminals (not shown) that are included in the electrode assembly 500 (e.g., similar to the electrical terminals 124 and 125 shown in FIG. 1) that are connected to one of the electrode busbar 508 and the counter-electrode busbar 510 may be made of any suitable conductive metal material. In various embodiments, the conductive terminal that is connected to the cathodic type busbar 508 or 510 is made of an aluminum material and the conductive terminal that is connected to the anodic type busbar 508 or 510 is made of a nickel material.

The electrode busbar 508 is a cathodic electrode busbar when the electrode structure 502 is a cathodic type, and is an anodic electrode busbar when the electrode structure 502 is an anodic type. Similarly, the counter-electrode busbar 510 is a cathodic electrode busbar when the counter-electrode structure 504 is a cathodic type, and is an anodic electrode busbar when the counter-electrode structure 504 is an anodic type. In the example embodiment, the anodic type busbar is a copper busbar and the cathodic type busbar is an aluminum busbar. In other embodiments, the electrode busbar 508 and the counter-electrode busbar 510 may be any suitable conductive material to enable the electrode assembly 500 to function as described herein.

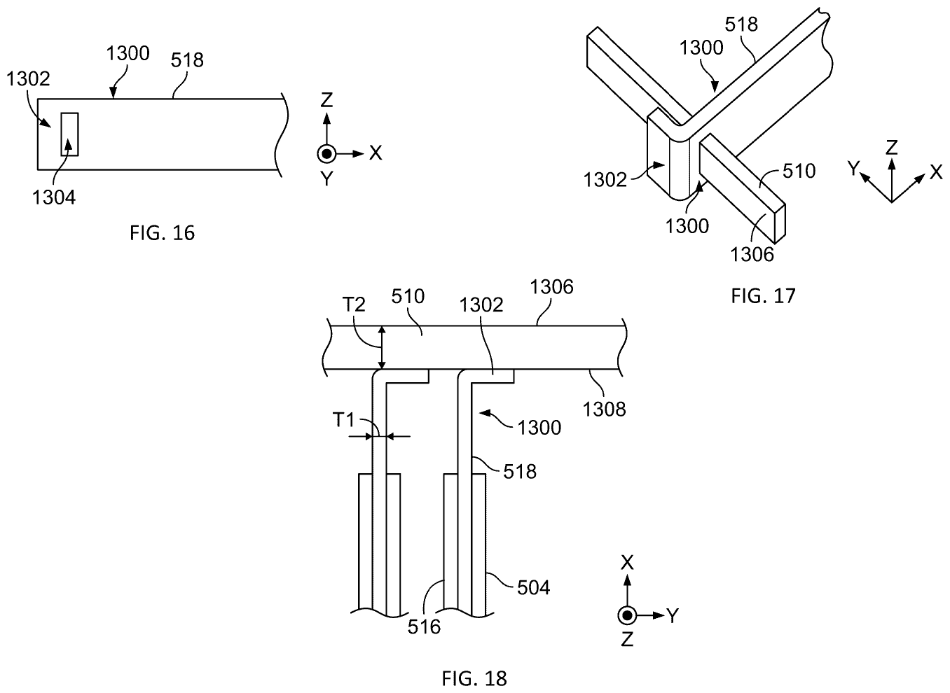

In the example embodiment, the counter-electrode structures 504 are a cathodic type. The cathodic counter-electrode structures 504, and more specifically, the cathodic counter-electrode current collectors 518, are directly connected or attached to the cathodic counter-electrode busbar 510. That is, the counter-electrode current collectors 518 are welded, soldered, or glued to the counter-electrode busbar 510 without any components (e.g., current limiters) electrically or physically positioned between them. In embodiments where the counter-electrode current collectors 518 are welded to the counter-electrode busbar 510, the welds may be made using a laser welder, friction welding, ultrasonic welding or any suitable welding method for welding the counter-electrode busbar 510 to the counter-electrode current collectors 518. Example techniques for connection between the counter-electrode current collectors 518 and the counter-electrode busbar 510 will be described in further detail below with reference to FIGS. 16-23.

In the example embodiment, the electrode structures 502 are an anodic type. Each member of the population of current limiters 506 is electrically connected between a different anodic electrode current collector 514 and the anodic electrode busbar 508. The current limiters 506 are configured to limit the current that may flow through the electrode current collector 514, and correspondingly through the electrode structure 502, to which it is connected. Thus, for example, if a short circuit is formed between one of the electrode current collectors 514 and one of the counter-electrode current collectors 518, the current limiter 506 limits the amount of current that can flow from the other electrodes and counter electrodes of the electrode assembly and thereby limits the temperature experienced by the electrode assembly 500 and a thermal runaway is prevented. Specifically, the current limiters 506 limit an amount of current that may be conducted through a unit cell during a discharge of the electrode assembly in which there is an electrical short between the electrode and counter-electrode of the unit cell to a value I, which is less than a current (sometimes referenced herein as Iₜᵣ or I_{L}) through a member of the unit cell population that would induce thermal runaway of the member of the unit cell population. The current limiters provide a soft landing for the battery in the event of a short circuit. The current limiters continuously allow a non-zero level of current to flow in the event of a short circuit, but limit that current to below a level that would trigger a thermal runaway. This current will continue to flow until the battery is discharged and the risk of thermal runaway is ended.

The current limiters 506 are resistive current limiters. The current limiters 506 have a nonzero resistance within the range of normal operating temperatures of the electrode assembly 500. In one example, the normal operating temperatures are between negative twenty ° C. and eighty ° C. In other embodiments, the normal operating temperatures are between negative forty ° C. and eighty-five ° C., between negative forty ° C. and one hundred and fifty ° C., or any other suitable range of normal operating temperatures. The resistance is such that the current limiters 506 limit the current that may pass through any unit cell and prevent the current from reaching a level that may cause catastrophic failure or any other maximum current level that is determined for other performance or abuse tolerance reasons as determined during battery design. The current limiters 506 do not rely on a fuse or any PTC characteristic of the resistive material. That is, although the current limiters 506 may exhibit PTC, a PTC is not required for the current limiters 506 to function as described herein. Rather, the resistance of the current limiters 506 in the range of normal operating temperatures of the electrode assembly 500 is sufficient to limit the current. In some embodiments, the resistance may increase or decrease (i.e., the current limiters may have a negative temperature coefficient) within the normal range of operating temperatures. The current limiters 506 are each electrically in series with the electrode current collector 514 to which it is attached. Thus, the resistance of each current limiter 506 and its associated electrode structure 502 is increased by adding the resistance of the associated electrode structure 502 and the resistance of the current limiter 506 attached thereto.

Adding resistance to a battery is conventionally discouraged, because the added resistance will increase the losses experienced by the battery when current is flowing into the electrode structures 502 (during charging) and out of the electrode structures (during discharge). However, because the electrode current collectors 514 are all connected to the electrode busbar 508 in parallel (electrically parallel), the increase in total resistance seen at the electrode busbar 508 is much smaller than the resistance of each individual current limiter 506. Moreover, the resistance of the current limiters 506 in this disclosure is selected to be small enough to have a limited voltage drop across the current limiters 506 and thereby have a limited loss of power. In the example embodiment, the resistance of the current limiters is selected to have no more than a 20 mV drop across each of the current limiters 506 during charging or discharging at a 1 C rate to limit losses during normal operation while still protecting the battery during a short circuit.

In the example embodiment, each individual unit cell, that includes a pair of one anodic electrode structure 502 and one cathodic counter-electrode structure 504, without a current limiter 506 has a relatively small size (compared to a laminar battery), a relatively low capacity, and an internal resistance high enough that current through an isolated unit cell cannot reach levels sufficient to cause thermal runaway and catastrophic failure, even when there is a short circuit between the electrode structure 502 and the counter-electrode structure 504 of the unit cell. However, when multiple unit cells are connected in parallel to a busbar, such as the busbar 508, in an electrode assembly, such as electrode assembly 500, all of the unit cells contribute current to the unit cell that has a short circuit within it. Under such circumstances, without a current limiter 506, sufficient current may pass through the shorted unit cell to cause thermal runaway and catastrophic failure of the electrode assembly 500 and the battery containing it. By adding the current limiters 506, the resistance of a unit cell is effectively increased. With the fixed voltage V of the unit cells, increasing the resistance will result in a corresponding reduction in the maximum current according to Ohm's law.

More specifically, the capacity of the electrode assembly 500 is subdivided into a number (n) of electrode unit cells, each of which includes one electrode structure 502 and one counter-electrode structure 504. Each unit cell forms a voltage (V). Each individual electrode unit cell has its own characteristic resistance (R_{bl}) which is a function of conductivity and geometry of the unit cell assembly. Each individual unit cell is capable of discharging a power (\dot{q}_{bl}) across a short circuit, such as forced internal short circuit (FISC) resistance (Rₛ). For an individual unit cell, the FISC power is given by:

$${\dot{q}}_{bl} = \frac{{V}^{2}}{{R}_{s} + {R}_{bl}} \qquad ( 1 )$$

When electrode structure 502 and counter-electrode structure 504 of each unit cell are connected in parallel to their respective busbars 508, 510, all unit cells contribute power discharging across the FISC (\dot{q}_{cell}) of the individual affected (i.e., shorted) unit cell. The FISC power of all unit cells of the cell connected in parallel is given by:

$${\dot{q}}_{cell} = \frac{{V}^{2}}{{R}_{s} + {R}_{bl} / n} \qquad ( 2 )$$

Adding in the current limiters 506, each of which has a nonzero resistance (R_{cld}) results in a FISC power for a shorted unit cell given by:

$${\dot{q}}_{FISC} = \frac{{V}^{2}}{{R}_{s} + {[ {R}_{bl}^{- 1} + {( {R}_{cld} + \frac{{R}_{bl} + {R}_{cld}}{n - 1} )}^{- 1} ]}^{- 1}} \qquad ( 3 )$$

The resistance R_{cld} of each current limiter 506 is selected such that the FISC power \dot{q}_{FISC} of for a shorted unit cell is less than the power minimum for occurrence of thermal runaway (\dot{q}ₜᵣ) or other maximum power considerations chosen due to battery design constraints.

The required resistance of the current limiters 506 may also be viewed from the perspective of the resistance needed to limit the current through a shorted unit cell below a threshold current that is sufficient to cause thermal runaway. Thus, by knowing the voltage produced by each unit cell, the capacity of each unit cell, the internal resistance of each unit cell, the resistance of the electrode busbar 508, and the resistance of the counter-electrode busbar 510, a resistance for the current limiters 506 can be calculated that will limit a current through the shorted unit cell to less than the threshold current needed to cause thermal runaway. The threshold current needed to cause thermal runaway may vary somewhat depending on the construction of the electrode assembly and the capacity of the individual unit cells, but for similarly constructed electrode assemblies, the threshold current will remain relatively constant. In the example embodiment, the threshold current is about 8 amps. In other embodiments, the threshold current may be about 4 amps, about 8 amps, about 10 amps, about 12 amps, or between 8 amps and 12 amps. The resistance needed for the current limiters 506 will vary depending on the specific configuration of the battery and its components. For similar electrode assemblies, the resistance needed to limit the current below the threshold current will generally increase as the capacity of the individual unit cells increases.

More specifically, the capacity of traditional stack battery cells is subdivided into a number of electrode unit cells (N) where each positive and negative electrode forms a voltage (V). The number of unit cells in a complete stack is represented by the capital letter N, while the number of unit cells as a variable, for example when performing an iterative assay with different numbers of unit cells, is represented by the lowercase letter n. Each individual electrode unit cell has its own characteristic resistance (R_{bl}) which is a function of conductivity and geometry of the unit cell assembly. Each individual unit cell is capable of discharging a current (I_{bl}) across a forced internal short circuit (FISC) resistance (Rₛ). The FISC current of an individual unit cell is given by

$${I}_{bl} = \frac{V}{{R}_{s} + {R}_{bl}} \qquad ( 4 )$$

When positive and negative electrodes of each unit cell are connected in parallel through their respective current collecting terminals with their own characteristic resistance (Rₜ), all unit cells of the cell contribute current (I_{cell}) discharging across the FISC of an individual affected unit cell. The FISC current of all unit cells of the cell connected in parallel is given by:

$${I}_{cell} = \frac{V}{{R}_{s} + {[ {R}_{bl}^{- 1} + {( {R}_{t} + \frac{{R}_{bl}}{N - 1} )}^{- 1} ]}^{- 1}} \qquad ( 5 )$$

In at least some cases, the characteristic resistance of an individual unit cell is low enough that the current it is capable of discharging across a FISC is sufficient to exceed a thermal runaway current (Iₜᵣ), which is a current that may be sufficient to cause self-accelerating exothermic decomposition and thermal runaway. When multiple electrode unit cells are mutually connected through shared terminals, discharge current across the FISC of an individual affected unit cell is increasingly likely to exceed the thermal runaway current (Iₜᵣ) and result in catastrophic failure of the cell.

The resistance of each current limiter 506 is selected to be sufficient to limit the current that may pass through any individual unit cell below the thermal runaway current (Iₜᵣ). The resistance of each current limiter (R_{cld}) is determined as a resistance that will satisfy:

$$\frac{{V}_{TOC}}{{R}_{s , WCFISC} + {[ {R}_{bl}^{- 1} + {( {R}_{cld} + {R}_{t} + \frac{{R}_{bl} + {R}_{cld}}{N - 1} )}^{- 1} ]}^{- 1}} < {I}_{tr} \qquad ( 6 )$$

where V_{TOC} is the voltage of a unit cell at top of charge, and R_{S,WCFISC} is equivalent to the impedance of the unit cells in an assembly without a current limiting device in a worst case forced internal short circuit at the top of charge in an assembly of N unit cells. In the example, the worst case is considered to occur when the resistance of the forced internal short circuit is approximately equal to the resistance of the shorted unit cell. The impedance is used because the current changes very rapidly upon occurrence of a short circuit. In one embodiment, R_{S,WCFISC} is the impedance at 20 kHz. Thus, the resistance R_{S,WCFISC} may be described by:

$${R}_{s , WCFISC} = {R}_{20 kHz} ( {V}_{TOC} , N ) \qquad ( 7 )$$

Other embodiments may use impedance at any other frequency or a direct current resistance. In some embodiments, the actual short circuit resistance of a shorted unit cell is calculated and used in equation (6) instead of the worst case internal short circuit resistance R_{s,WCFISC}. As used herein, the short circuit resistance Rₛ can refer to either the actual, measured short circuit resistance of a unit cell or the worst case internal short circuit resistance R_{s,WCFISC}, unless otherwise specified. An example method for determining the actual short circuit resistance is provided below.

The resistance of an individual unit cell is determined by the impedance at top of charge further considering the number of unit cell subdivisions and the resistance of the terminals calculated based on their material composition and geometry. For the example using the 20 kHz impedance, the resistance of a unit cell is given by:

$${R}_{bl} = \frac{{R}_{20 kHz} ( {V}_{TOC} , N )}{N} - {R}_{t} \qquad ( 8 )$$

In the example embodiment, the thermal runaway current (Iₜᵣ) to be used in equation (6) above is determined by performing a worst case forced internal short circuit assay that is described below. In other embodiments, the thermal runaway current (Iₜᵣ) may be estimated, derived from simulations, determined using a different assay, or arrived at through any other suitable methods. However determined, the thermal runaway current (Iₜᵣ) is then used in equation (6) to determine the resistance needed in the current limiter (R_{cld}) to satisfy the inequality. By selecting providing current limiters 506 with the resistance R_{cld}, the current limiters 506 will effectively limit the current through any unit cell to less than the thermal runaway current (Iₜᵣ), even in the event of an internal short circuit in a unit cell.

For the example embodiment, the resistance of each current limiter 506 at 25 degrees Celsius (° C.) is about 0.25 ohms (Ω) and limits the short circuit current to less than about 8 amps. This results in a 20 mV or less voltage drop across each current limiter 506 when the electrode assembly 500 is charging or discharging at a 1 C rate. In other embodiments, the resistance of each current limiter 506 is between 0.25Ω and 2.5Ω. In some embodiments, the resistance of each current limiter 506 is between 0.1Ω and 1.5Ω. These ranges provide a range of resistances that balance the need to limit the current during a short circuit while also limiting losses during normal operation of the battery. The exact value within the ranges, as well as which range is to choose, may be selected based on the voltage, capacity, or other characteristics of the particular battery. More generally, in some embodiments, the resistance of each current limiter 506 is determined by selecting a resistance that produces a voltage drop of less than 0.5 volts when the electrode assembly 500 (or an individual unit cell) is charging or discharging at a 1 C rate when discharged from a top of charge (TOC) condition. That is, the current at the 1 C rate time the resistance of the current limiter 103 is less than 0.5 volts to minimize losses during normal operation while still sufficiently limiting current during a short circuit.

The current limiters 506 are positioned on the electrode busbar 508 in the example embodiment. The current limiters are physically positioned between the electrode current collectors 514 and the electrode busbar 508. In other embodiments, the current limiters 506 may be electrically between the electrode current collectors 514 and the electrode busbar 508, but physically outside of the connection between the electrode current collectors 514 and the electrode busbar 508.

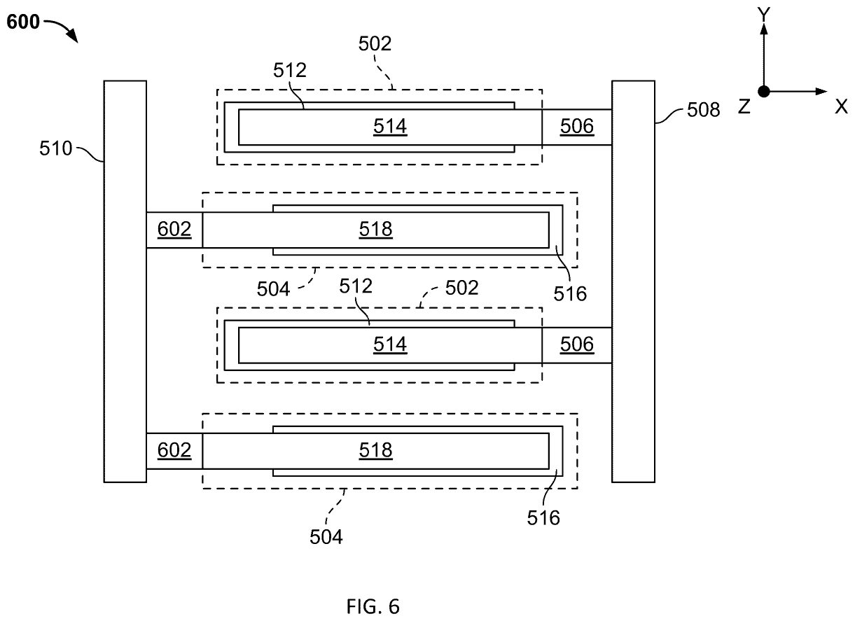

FIG. 6 is a simplified diagram of another example electrode assembly 600 for cycling between a charged state and a discharged state in a battery. The electrode assembly 600 is similar to the electrode assembly 500 (FIG. 5), and the same reference numbers are used to identify common components. For clarity of illustration, the separator structures 505 are not shown in FIG. 6, but are included in this example electrode assembly 600.

Unlike the electrode assembly 500, the electrode assembly 600 includes a population of additional current limiters 602. The additional current limiters 602 are each electrically connected between a different one of the counter-electrode current collectors 518 and the counter-electrode busbar 510. In some embodiments, the additional current limiters 602 are the same as the current limiters 506 discussed above, and the connections are made in the same ways as the current limiters 506. However, in some embodiments, the additional current limiters 602 have a different composition and/or are different from the current limiters 506. For example, a conductive film may be used as the resistance for the additional current limiters 602, while a conductive adhesive may be used in the current limiters 506. Alternatively, one type of conductive adhesive may be used in the current limiters 506, and a different type of conductive adhesive may be used in the additional current limiters 602. This may be especially useful when the counter-electrode busbar 510 and the electrode busbar 508 are made of different materials that may adhere to different conductive adhesives differently. As another example, the additional current limiters 602 may use different conductive materials suspended in the conductive adhesive than the current limiters 506. Further, in some embodiments, the additional current limiters 602 have a different resistance than the current limiters 506. In particular embodiments, the additional current limiters 602 have a resistance that is less than the resistance of the current limiters 506, including having a resistance of less than 0.25Ω, when the resistance of the current limiter 506 is sufficient to limit current below a threshold which would lead to a catastrophic failure.

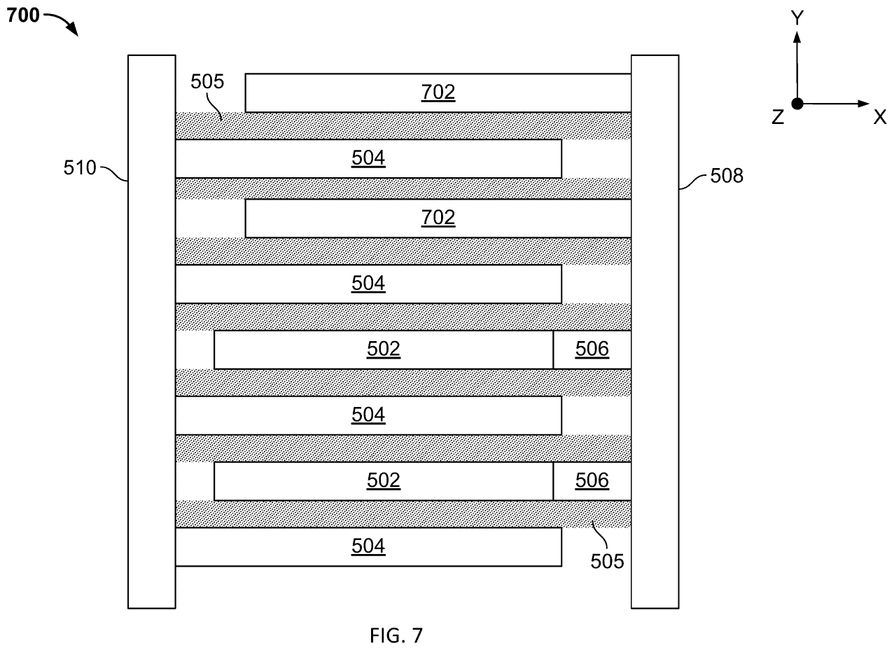

FIG. 7 is a simplified diagram of another example electrode assembly 700 for cycling between a charged state and a discharged state in a battery. The electrode assembly 700 is similar to the electrode assembly 500, and the same reference numbers are used to identify common components. Some details of the electrode structures 502 and the counter-electrode structures 504 are removed for clarity of illustration, but all aspects of the electrode structures 502 and the counter-electrode structures 504 discussed above are the same in the electrode assembly 500. Unlike the electrode assembly 600, the electrode assembly 800 includes a population of additional electrode structures 802 that are connected directly to the electrode busbar 508. That is, the additional electrode structures 802 are connected to the electrode busbar 508 without a current limiter 506.

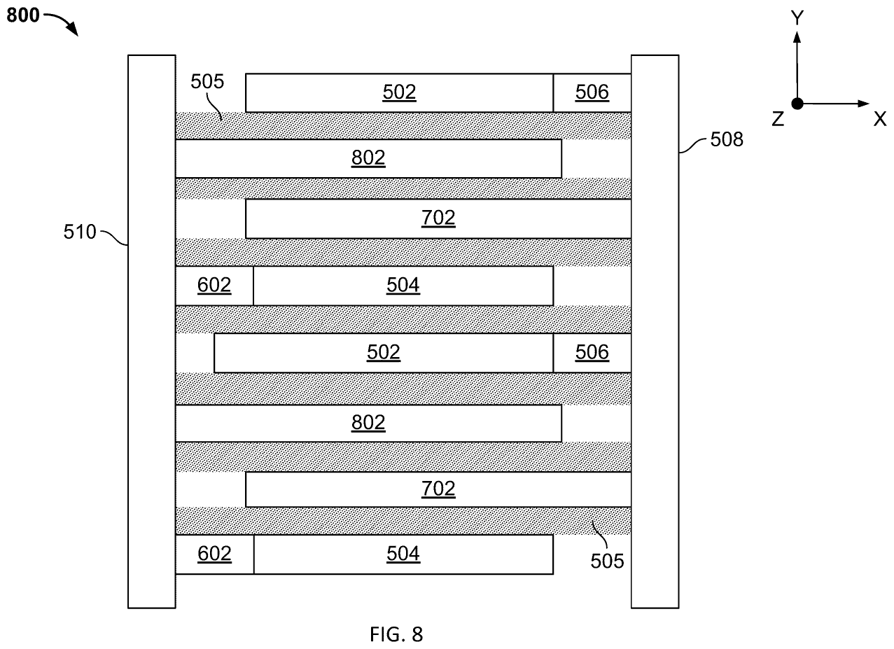

FIG. 8 is a simplified diagram of another example electrode assembly 800 for cycling between a charged state and a discharged state in a battery. The electrode assembly 800 is similar to the electrode assembly 600, and the same reference numbers are used to identify common components. Some details of the electrode structures 502 and the counter electrode structures 504 are removed for clarity of illustration, but all aspects of the electrode structures 502 and the counter electrode structures 504 discussed above are the same in the electrode assembly 800. Unlike the electrode assembly 700, the electrode assembly 800 includes the population of additional electrode structures 702 and a population of additional counter-electrode structures 802 that are all connected directly to the counter-electrode busbar 510. That is, the additional electrode structures 702 are connected to the electrode busbar 208 without a current limiter 506 and the additional counter-electrode structures 802 are connected to the counter-electrode busbar 510 without an additional current limiter 602.

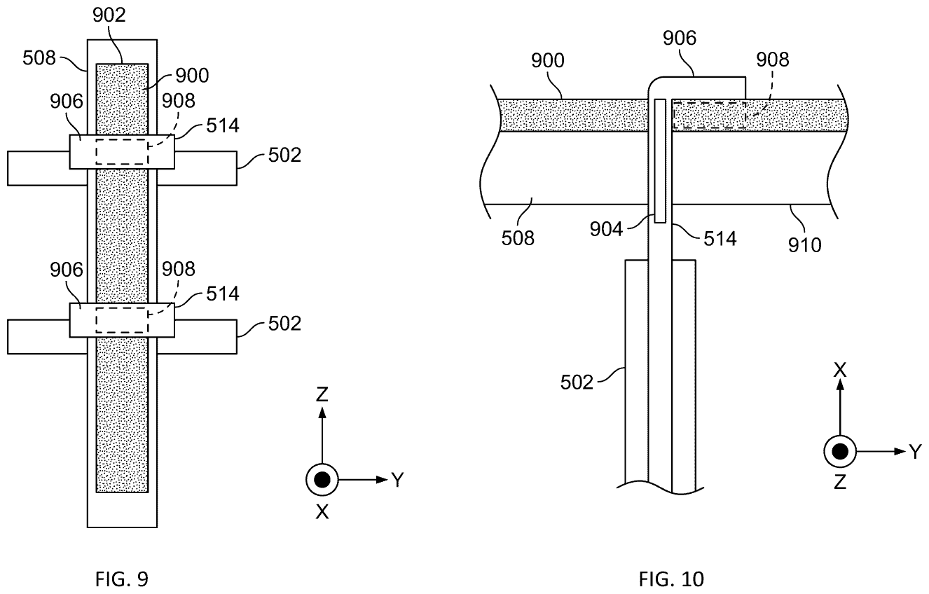

Referring now to FIGS. 9 and 10, the example current limiters 506 are comprised of a unitary layer 900 of a conductive adhesive disposed on a surface 902 of the electrode busbar 508 to which the electrode current collectors 514 will be attached (e.g., welded). The surface 902 of the electrode busbar 508 is an exterior surface and faces opposite the electrode assembly with which the electrode busbar 508 is used. The electrode current collectors 514 each include a slot 904 (FIG. 10) that is sized and shaped to receive the electrode busbar 508. An end portion 906 of each of the electrode current collectors 514 extends past the slot 904. The electrode busbar 508 is inserted through the slot 904 of each electrode current collector 514, and the end portion 906 of each electrode current collector 514 is folded or bent towards and/or into contact the current limiters 506. In particular, in the example shown in FIG. 10, the end portions 906 are folded or bent towards the electrode busbar 508 and/or the unitary layer 900 of the current limiters 506, generally in the Y-axis direction, and the bent end portions 906 may come into contact with the surface 902 of the busbar 508 and/or the unitary layer 900. The bent end portions 906 of the electrode current collector 514 are then attached (e.g., by welding) to the electrode busbar 508 and/or the current limiters 506.

In the example shown in FIGS. 9 and 10, each individual current limiter 506 is a portion 908 of the unitary layer 900 located between the bent end portion 906 of one of the electrode current collectors 514 and the exterior surface 902 of the electrode busbar 208. In other embodiments, the conductive adhesive may be applied on the surface 902 of the electrode busbar 508 in individual portions rather than as a unitary layer 900, one for each electrode current collector 514 that will be connected to the electrode busbar 508. For example, the conductive adhesive may be applied to the electrode busbar 508 around the locations to which the bent end portions 906 will be attached (e.g., the locations on the surface 902 of the electrode busbar 508 over and/or on which the electrode current collector 514 will be positioned when the end portion 906 is bent over the electrode busbar 508).

Each application of the conductive adhesive, and thus each current limiter 506, may be physically separate from each other application of the conductive adhesive. In other embodiments, the conductive adhesive of the current limiters 506 may be applied to each electrode current collector 514 (e.g., to the end portion 906 of each electrode current collector 514), such that the conductive adhesive will be positioned around the locations on the electrode busbar 508 to which the bent end portions 906 will be attached, and each current limiter 506 will be physically separated from the other current limiters 506. In other embodiments, the electrode busbar 508 may be connected to the electrode current collectors 514 by any other suitable connective arrangement (e.g., without using a slot, with the busbar 508 extending across the end portions 906 of the current collectors 514 such that the end portions 906 are attached to an interior surface 910 opposite the exterior surface 902 of the busbar 508, etc.), with the conductive adhesive positioned between the electrode current collectors 514 and the exterior surface 902 and/or interior surface 910 of the busbar 508.

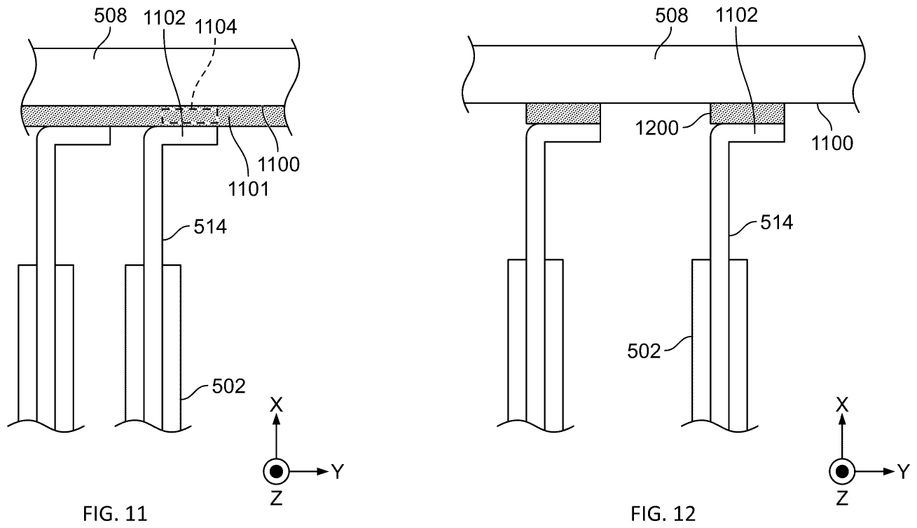

FIGS. 11 and 12 illustrate example embodiments in which the example the electrode current collectors 514 do not include the slot 904. In these embodiments, the current limiters 506 are comprised of a conductive adhesive disposed between end portions 1102 of the current collectors 514 and an interior surface 1100 of the electrode busbar 508 to which the electrode current collectors 514 will be attached. The end portion 1102 of each electrode current collector 514 may be bent (e.g., to approximately a ninety degree angle as shown in FIGS. 11 and 12) and the electrode busbar 508 is positioned over the bend end portions 1102. The end portions 1102 need not be bent to exactly ninety degrees and may be generally perpendicular to the rest of the respective current collector 514. In some embodiments, the end portions 1102 may be bent at an oblique angle (e.g., less than a ninety degree angle, less than a 75 degree angle, less than a sixty degree angle, less than a 45 degree angle, less than a 30 degree angle, or less than a 15 degree angle). In some embodiments, the end portions 1102 may not be bent and extend generally perpendicular to the interior surface 1100 of the busbar 508 to which the end portions 1102 will be attached.

As shown in FIG. 11, in some embodiments, the current limiters 506 are comprised of a unitary layer 1101 of a conductive adhesive disposed on the interior surface 1100 of the electrode busbar 508 to which the electrode current collectors 514 will be attached. The electrode busbar 508 may then be attached to the end portions 1102 of the electrode current collector 514, such as by gluing, welding, soldering, or using any other suitable technique for joining the electrode current collectors 514 to the electrode busbar 508. In an example embodiment, the electrode busbar 508 may be attached to the end portions 1102 by hot pressing the electrode busbar 508 to soften the conductive adhesive of the unitary layer 1101 and applying pressure to the busbar 508 to adhere the electrode busbar 508 to the end portions 1102 using the conductive adhesive. Although illustrated butted against the conductive adhesive, it should be understood that the end portions 1102 of the current collectors may extend into the conductive adhesive. In the illustrated embodiment, each individual current limiter 506 is a portion 1104 of the unitary layer 1101 located between the end portion 1102 of the current collector 514 and the interior surface 1100 of the electrode busbar 508.

As shown FIG. 12, in some embodiments, the current limiters 506 are comprised of conductive adhesive that is applied in individual portions 1200 between the interior surface 1100 of the electrode busbar 508 and the end portions 1102 of the electrode current collectors 514. More specifically, one portion 1200 of the conductive adhesive is provided for each electrode current collector 514 that will be connected to the electrode busbar 508. Each application or portion 1200 of the conductive adhesive, and thus each current limiter 506, is physically separate from each other application or portion 1200 of the conductive adhesive. In some embodiments, each portion 1200 of the conductive adhesive may be applied to the interior surface 1100 of the electrode busbar 508 around the location to which the end portion 1802 of one of the electrode current collectors 514 will be attached. In other embodiments, each portion 1200 of the conductive adhesive of the current limiters 506 may be applied to the end portion 1102 of each electrode current collector 514, such that the portions 1200 of the conductive adhesive will be positioned around the locations of the interior surface 1100 of the electrode busbar 508 to which the end portions 1102 are attached, and each current limiter 506 will be physically separated from the other current limiters 506.

Although the current limiters 506 have been described as being comprised of a conductive adhesive, in other embodiments, a resistor other than a conductive adhesive is used for the current limiters 506. For example, a conductive film having the desired resistance may be applied in a unitary strip to the electrode busbar 508, applied in individual portions to the electrode busbar, or applied in individual portions to each electrode current collector 514 in manners similar to the conductive adhesive. Alternatively, a non-adhesive conductive polymer may be applied in place of the conductive adhesive. Further, in some embodiments, discrete resistors may be electrically connected between the electrode current collectors 514 and the electrode busbar 508. The discrete resistors may be physically located between the electrode current collectors 514 and the electrode busbar 508, or may be physically outside of the interface between the electrode current collectors 514 and the electrode busbar 508, but electrically between the electrode current collectors 514 and the electrode busbar 508. The discrete resistors may be any suitable resistor, including wire wound resistors, thick film resistors, thin film resistors, carbon film resistors, carbon pile resistors, metal film resistors, foil resistors, or the like.

In some embodiments, one or more interface layers are included between the current limiters 506 and the electrode busbar 508 or between the current limiters 506 and the electrode current collectors 514. In general, the resistance between the electrode busbar 508 and each electrode current collector 514 is defined by the resistance of the current limiter 506, plus the resistance of the interface between the current limiter 506 and the electrode current collector 514, plus the resistance of the interface between the current limiter 506 and the electrode busbar 508. Generally, the interface resistances may be produced by imperfect (e.g., “real” connections rather than “ideal”) electrical connection between the current limiter 506 and the electrode busbar 508 and the electrode current collector 514. Without being limited to any particular theory, the imperfect electrical connection may be caused by, for example, microscope structural variations of the surface of the electrode busbar 508 and/or electrode current collector 514, the distribution and structure of conductive particles in the current limiter 506, and the like. The interface layer is provided to improve the electrical connection between these components to reduce the series resistance of the electrical connection between the current limiter 506, the electrode busbar 508, and the electrode current collector 514.

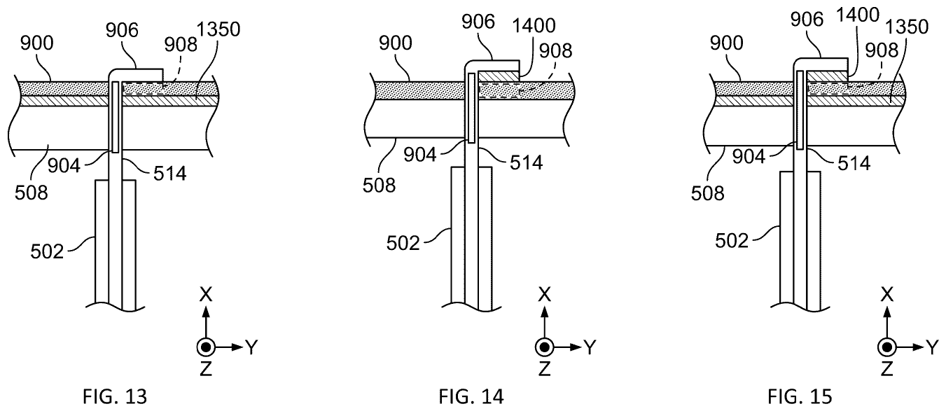

Referring now to FIGS. 13-15, various embodiments similar to the embodiment shown in FIG. 10 and described above are shown. Similar reference numbers in FIGS. 13-15 refer to similar components in FIG. 10 and described above. In FIG. 13, an interface layer 1350 is applied to the electrode busbar 508. In FIG. 15, an interface layer 1400 is applied to electrode current collector 514. The interface layer 1400 may be applied to each current collector 514, or less than all current collectors 514. In FIG. 15, the interface layer 1350 is applied to the electrode busbar 508 and the interface layer 1400 is applied to the electrode current collector 514.

In some embodiments, the interface layers 1350 and 1400 are carbon based coatings. For example, the interface layers 1350 and/or 1400 may be coatings produced by slurry coating carbon nanotubes onto the electrode busbar 508 and/or the electrode current collector 514. In other embodiments, the interface layers 1350 and/or 1400 are graphite coatings or any other suitable electrically conductive coating. In some embodiments, the interface layers 1350 and/or 1400 are applied using a hot anvil approach in which heat is applied to the electrode busbar 508 and/or the electrode current collector 514 to coat the electrode busbar 508 and/or the electrode current collector 514 with the selected materials to form the interface layers 1350 and/or 1400.

The conductive adhesive used in the current limiters 506 in the example embodiments may be an adhesive polymer, copolymer, or blend with a conductive material suspended therein. In the example embodiments, the conductive adhesive is a thermoplastic material. In other embodiments, the conducive adhesive is a thermoset material. The adhesive polymer is substantially nonconducting (e.g., insulating) prior to suspension of the conductive material therein. Generally, desirable polymers are any that are (a) stable in the environment of a Li-ion battery cell (i.e. do not dissolve in the electrolytes, react with electrolyte components or any other battery components, or undergo redox chemistry or reactions that degrade the material during cell operation) and (b) have melting points above the typical working temperature of a Li-ion battery. Because adhesion is an important property of the conductive adhesive, polymers that exhibit adhesive qualities are desirable as at least one component of the conductive adhesive.

Flexibility in the polymer is another desirable trait. Therefore, materials or blends of materials with some elasticity and particularly with a glass transition temperature (Tg) above 0° C. are preferred, but not required. In some embodiments, the conductive adhesive is a polymer blend with at least one component with a high elasticity (measured by standard methods such as modulus and/or elongation to break. In some embodiments, the adhesive polymer is a flowable adhesive polymer. In such embodiments, the conductive adhesive should have flow properties that allow for melt processing, including compounding of conductive aids and other additives if desired, film/sheet preparation by standard methods such as cast film, blown film, and calendering. For example, the melt flow index (I2, 190° C., ASTM D1238) of the polymer blend used for the conductive adhesive should be in the range of 0.1 to 1000 grams (g)/10 minutes (min), preferably 0.1 to 100 g/10 min, most preferably 0.5 to 20 g/10 min. Melting points of the polymers used in the conductive adhesive should allow for melt processing and bonding to the cell via a melt press or related technique, and should be above the typical working temperature range of the cell. Polymers that melt from 40° C. to 300° C. may be used for the conductive adhesive. Polymers with a melting point in the range of 60° C. to 200° C. are preferred, polymers with a melting point in the range of 70° C. to 165° C. are most preferred.

Example suitable adhesive polymers or copolymers for use in the conductive adhesive include EAA (ethylene-co-acrylic acid) and EMAA (ethylene-co-methacrylic acid), ionomers of the EAA or EMAA, polyethylene and copolymers thereof (such as, ethylene/1-octene, ethylene/1-hexene, ethylene/1-butene, and ethylene/propylene copolymers), polypropylene and copolymers thereof, a functionalized or derivatized polyethylene or polypropylene (such as, maleic anhydride grafted materials), or the like.

The conductive material suspended in the polymer to form the conductive adhesive may be any powder, fiber, particle, or the like that confers the desired conductivity to the conductive adhesive after compounding with the polymer blend. Most desirable are materials that confer the desired conductivity at lower loadings, because high loading of additives may change the properties of the polymer blend in undesirable ways. For example, high loadings may lead to a significant decrease in melt processability, impacting the ability to manufacture films or sheets of conductive polymer using conventional equipment. In addition, conductive additives are often expensive materials, and lower loadings are desirable to maintain a lower cost for manufacturing.

The conductive material may be metal powder or fiber, conductive carbon black, metal coated carbon fiber, and carbon nanotubes, or blends thereof. In various embodiments, the conductive material may be carbon black, nickel particles, copper particles, gold particles, silver particles, tin particles, titanium particles, graphite particles, molybdenum particles, platinum particles, chromium particles, aluminum particles, or any other metallic particles, including alloys. Preferable conductive materials for use in the conductive adhesive are metal coated carbon fibers and conductive carbon blacks, or blends thereof. The metal coated carbon fibers may be coated in nickel, copper, gold, silver, tin, titanium, molybdenum, platinum chromium, aluminum, or any other metallic coating, including alloys. In a most preferred example, the conductive materials include nickel coated carbon fibers and “superconductive” carbon blacks (examples include but are not limited to Nouryon Ketjenblack EC 300-J and EC 600-JD materials, Orion Printex XE2B, Cabot Vulcan XCmax™ 22).

For embodiments in which the conductive material is a fiber (such as a nickel coated carbon fiber), the conductive material will generally have an elongated shape. It is preferable in such embodiments for the fibers to have a relatively large aspect ratio (length to diameter). In one example embodiment, nickel coated carbon fibers used as the conductive material in the conductive adhesive have an aspect ratio of about 850:1. Other useful aspect ratios for conductive materials are from 10:1 to 10,000:1, preferably 50:1 to 5000:1, and most preferably 100:1 to 2000:1.

Loading of conductive material into the polymer to form the conductive adhesive may be in the range of 1% to 50% conductive material (as weight percent of the total mixture). Preferably the loading of conductive material is from 2% to 40%, and most preferably the loading is from 3% to 30%.

The resistivity of the conductive adhesive should be in the range of 5.0×10⁻⁷ and 5.0×10³ Ω-cm, preferably from 5.0×10⁻⁵ and 5.0×10¹ Ω-cm, and most preferably from 5.0×10⁻³ and 5.0×10⁻¹ Ω-cm. The polymer resistivity is measured by making a sheet or film of the polymer blend with conductive additive(s), then laminating that sheet or film to a copper test structure consisting of four rectangular bars adhered adjacent to one another in an array with defined interspacing. Lamination may be accomplished using methods such as a hot press or heated calender. Once lamination is complete, the resistivity measurement is accomplished using a typical four-point probe method, where the source probes apply a current through the sheet of film by contacting the two outermost bars and the sense probe measures the potential between the innermost bars allowing for determination of the bulk resistivity when the geometry of the four-point test structure array and thickness of the sheet or film is defined.

In an example embodiment, the conductive material is carbon black. The conductive adhesive is formed by mixing carbon black in the adhesive polymer until the adhesive polymer has a volume resistivity of between about 0.01 and 1.0 Ω-cm. The resistivity can be adjusted by adjusting the amount of carbon black added to the adhesive polymer. Adding more carbon black will decrease the resistivity (i.e., make it more conductive), and adding less carbon black will increase the resistivity (i.e., make it less conductive). In the example embodiment, carbon black is added to the adhesive polymer in an amount between 5% to 30% by weight to achieve the desired resistivity. The conductive adhesive so prepared is applied to the electrode busbar 508 at a thickness of between 20 microns and 200 microns thick. By adjusting the resistivity of the adhesive polymer and the thickness of application, the desired resistance for the current limiters 506 may be achieved.

While the above-described example embodiments with reference to FIGS. 9-15 are described for the current limiters 506 applied between the electrode busbar 508 and the electrode current collectors 514, it will be appreciated that the feature and elements described above for the current limiters 506 apply similarly to the current limiters 602 described above that may be electrically connected between at least some of the counter-electrode current collectors 518 and the counter-electrode busbar 510. Moreover, in embodiments where at least some of the counter-electrode current collectors 518 are connected to the counter-electrode busbar 510 through the current limiters 602, the counter-electrode current collectors 518 may be connected to the counter-electrode busbar 510 using any suitable technique including those described above with reference to FIGS. 9-15.

FIGS. 16-23 illustrate example techniques for connecting the counter-electrode current collectors 518 to the counter-electrode busbar 510 without a current limiter. As described above, in the example embodiment, the counter-electrode structures 504 are a cathodic type. The cathodic counter-electrode structures 504, and more specifically, the cathodic counter-electrode current collectors 518, are directly connected or attached to the cathodic counter-electrode busbar 510 without any components (e.g., current limiters) electrically or physically positioned between them. In some embodiments, some or all the anodic electrode structures 502, and more specifically the anodic electrode current collectors 514, may be directly connected to the electrode busbar 508 without a current limiter therebetween using the techniques described below. Moreover, the counter-electrode structures 504 are not limited to being cathodic type and the electrode structures 502 are not limited to be anodic type. In some embodiments, some or all the counter-electrode structures 504 may be anodic type and/or some or all the electrode structures 502 may be cathodic type. Alternatively stated, the techniques described below with reference to FIGS. 16-23 may suitably be applied for directly connecting any type of electrode structure or counter-electrode structure to a corresponding busbar.

FIGS. 16 and 17 illustrate one technique for connecting the counter-electrode current collectors 518 to the counter-electrode busbar 510. FIGS. 16 and 17 each depict a portion 1300 of the counter-electrode current collector 518 that extends outward beyond the active material 516 (shown in FIG. 18) and defines an X-axis terminus of the counter-electrode structure 504. The portion 1300 includes a slot 1304 and an end portion 1302 that extends past the slot 1304 in the X-axis direction. Together, the slot 1304 and the end portion 1302 facilitate connecting the portion 1300 of the counter-electrode current collector 518 to the counter-electrode busbar 510.

FIG. 16 is a view of the end portion 1302 of one of the counter-electrode current collectors 518 that extends past the slot 1304. The slot 1304 is sized and shaped to receive the counter-electrode busbar 510. The slot 1304 is formed in the counter-electrode current collector 518 as a through-hole extending in the Y-axis direction near the end portion 1302.

As shown in FIG. 17, the counter-electrode busbar 510 is inserted through the slot 1304. Moreover, at least some or all the counter-electrode busbars 510 include a slot 1304 and an outward-extending end portion 1302, and the slots 1304 substantially align along the Y-axis direction such that the counter-electrode busbar 510 is inserted through the portions 1300 of the counter-electrode busbar 510 in the Y-axis direction to establish mutual connection between the counter-electrode busbar 510 and the counter-electrode structures 502 of the electrode assembly 500 (shown in FIG. 5). The end portions 1302 of the counter-electrode current collectors 518 are folded or bent generally in the Y-axis direction towards and, optionally, into contact with an exterior surface 1306 of the counter-electrode busbar 510. The bent end portions 1302 of the counter-electrode current collectors 518 may then be attached (e.g., glued, welded, soldered, and the like) to the counter-electrode busbar 510.

FIG. 18 illustrates another technique for connecting the counter-electrode current collectors 518 to the counter-electrode busbar 510. In this example, the portion 1300 of the counter-electrode current collector 518 that extends past the active material 516 does not include the slot 1304. Instead, the portion 1300, and more specifically the end portion 1302, is attached to an interior surface 1308 of the counter-electrode busbar 510, such that a busbar-over-electrode interconnection between the counter-electrode busbar 510 and the counter-electrode structures 504 is established. Alternatively stated, the connection between the counter-electrode busbar 510 and the end portions 1302 of the counter-electrode current collectors 518 is such that the counter-electrode busbar 510 extends across the end portions 1302 in a Y-Z plane defined by the Y and Z-axes and the end portions 1302 are disposed inboard of the counter-electrode busbar 510 between the interior surface 1308 and the rest of the electrode assembly 500. This interconnection design may facilitate preventing mechanical damage to the end portion 1302 of the counter-electrode current collector 518, which is otherwise externally exposed beyond the busbar 510 (see FIG. 17) and improving energy density of the electrode assembly.

As shown in FIG. 18, the end portions 1302 of the counter-electrode current collectors 518 may be bent to approximately a ninety degree angle and the counter-electrode busbar 510 is positioned over the bent end portion 1302. The end portions 1302 need not be bent to exactly ninety degrees and may be generally perpendicular to the rest of the respective current collector 518. In some embodiments, the end portions 1302 may be bent at an oblique angle (e.g., less than a ninety degree angle, less than a 75 degree angle, less than a sixty degree angle, less than a 45 degree angle, less than a 30 degree angle, or less than a 15 degree angle). In some embodiments, the end portions 1302 may not be bent and extend generally perpendicular to the interior surface 1308 of the busbar 510 to which the end portions 1302 will be attached. The counter-electrode busbar 510 may then be attached directly to the counter-electrode current collectors 518, and more specifically to the end portions 1302, such as by gluing, welding, soldering, or using any other suitable technique for joining the counter-electrode current collectors 518 to the counter-electrode busbar 510.

The techniques described with reference to FIGS. 16-18 for connecting the counter-electrode current collectors 518 to the counter-electrode busbar 510 present challenges in creating and/or maintaining the connections during manufacturing and operation. The counter-electrode current collectors 518 are formed from a thin layer of suitable material (e.g., aluminum, nickel, cobalt, titanium, and tungsten, or alloys thereof) that has the propensity to tear at or near the end portions 1302 that are attached to the counter-electrode busbar 510. The width, or thickness T₁ (FIG. 18) measured in the Y-axis direction, of the counter-electrode current collectors 518 and the thickness T₂ (FIG. 18) of the counter-electrode busbar 510, measured in the X-axis direction, will vary depending upon the energy storage device and its intended use. In general, however, the thickness T₂ of the counter-electrode busbar 510 is greater than the thickness T₁ of each of the counter-electrode current collectors 518. Additionally, the counter-electrode current collectors 518 and the counter-electrode busbar 510 are each made of similar electrically conductive (e.g., metal) material. In certain embodiments, for example, the counter-electrode current collectors 518 and the counter-electrode busbar 510, which may each be the cathodic type, are each made of aluminum. The difference between the thickness T₂ and the thickness T₁ translates to a difference in weight between each of the counter-electrode current collectors 518 and the counter-electrode busbar 510. More specifically, the difference between the thickness T₂ and the thickness T₁ translates to a relatively heavier counter-electrode busbar 510 that is attached to relatively thin counter-electrode current collectors 518 that may tear, wear, or otherwise result in a failed connection (e.g., a failed weld) with the busbar 510.

In various embodiments, the thickness T₁ of the counter-electrode current collectors 518 is between about 1 μm to about 100 μm, between about 1 μm to about 50 μm, between about 1 μm to about 40 μm, between about 1 μm to about 30 μm, between about 1 μm to about 20 μm, between about 1 μm to about 15 μm, between about 1 μm to about 10 μm, between about 10 μm to about 50 μm, between about 20 μm to about 50 μm, between about 30 μm to about 50 μm, between about 40 μm to about 50 μm, between about 10 μm to about 40 μm, between about 10 μm to about 30 μm, between about 10 μm to about 20 μm, or between about 10 μm to about 15 μm. For example, the thickness T₁ of the counter-electrode current collectors 518 may be about 1 μm, about 5 μm, about 10 μm, about 15 μm, about 20 μm, about 25 μm, about 30 μm, about 35 μm, about 40 μm, about 45 μm, about 50 μm, or about 100 μm. The counter-electrode current collectors 518 may individually have the same thickness T₁ or the individual thickness T₁ of the counter-electrode current collectors 518 may differ.

The thickness T₂ of the counter-electrode busbar 510 may, for example, be between about 20 μm to about 500 μm, between about 50 μm to about 500 μm, between about 100 μm to about 500 μm, between about 200 μm to about 500 μm, between about 300 μm to about 500 μm, between about 400 μm to about 500 μm, between about 20 μm to about 400 μm, between about 20 μm to about 300 μm, between about 20 μm to about 200 μm, between about 20 μm to about 100 μm, between about 20 μm to about 50 μm, between about 50 μm to about 100 μm, between about 100 μm to about 400 μm, between about 100 μm to about 300 μm, between about 100 μm to about 200 μm, between about 100 μm to about 150 μm, or between about 50 μm to about 150 μm. For example, the thickness T₂ of the counter-electrode busbar 510 may be about 20 μm, about 50 μm, about 100 μm, about 150 μm, about 200 μm, about 250 μm, about 300 μm, about 350 μm, about 400 μm, about 450 μm, or about 500 μm.

The difference between the thickness T₂ of the counter-electrode busbar 510 and the individual thickness T₁ of the counter-electrode current collectors 518 will vary depending upon the energy storage device and its intended use. In various embodiments, the thickness T₂ may be at least two times greater than the thickness T₁, at least three times greater than the thickness T₁, at least four times greater than the thickness T₁, at least five times greater than the thickness T₁, at least ten times greater than the thickness T₁, at least fifteen times greater than the thickness T₁, at least twenty times greater than the thickness T₁, at least thirty times greater than the thickness T₁, or at least forty times greater than the thickness T₁. The thickness T₂ may, in some examples, be up to fifty times greater than the thickness T₁.

The thicknesses T₁ and T₂ described above are applicable for any suitable material comprising the counter-electrode current collectors 518 and the counter-electrode busbar 510. Moreover, the thicknesses T₁ and T₂ described above are not limited to the counter-electrode structures, and may be applicable for the electrode current collectors 514 and the electrode busbar 508, respectively.

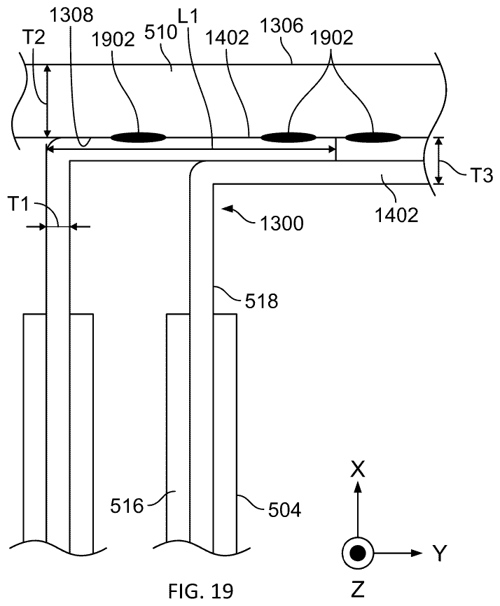

FIG. 19 illustrates an example technique for connecting the counter-electrode current collectors 518 to the counter-electrode busbar 510 in which the counter-electrode current collectors 518 include elongate bent end portions 1402 that extend over or overlap a bent end portion 1402 of an adjacent counter-electrode current collector 518. Each bent end portion 1402 extends a suitable length L₁, measured in the Y-axis direction, to enable the bent end portion 1402 to overlap the adjacent bent end portion 1402. The length L₁ will vary based on the sizing of the electrode and counter-electrode structures and the spacing between adjacent counter-electrode current collectors 518, which will vary based on the energy storage device and intended use. In some embodiments, the length L₁ may be at least 0.1 mm, at least 0.5 mm, at least 1 mm, at least 1.5 mm, or at least 2 mm, such as between about 0.1 mm to about 5 mm, between about 0.5 mm to about 5 mm, between about 1 mm to about 5 mm, between about 0.5 mm to about 4 mm, between about 0.5 mm to about 3 mm, between about 0.5 mm to about 2 mm, between about 1 mm to about 4 mm, between about 1 mm to about 3 mm, or between about 1 mm to about 2 mm. The length L₁ may vary based on a desired overlap between the bent end portions 1402 to obtain a cumulative thickness T₃, measured in the transverse direction, of the overlapping bent end portions 1402. In some embodiments, the bent end portion 1402 of each counter-electrode current collector 518 overlaps at least one adjacent bent end portion 1402. Some or all the bent end portions 1402 may overlap more than one bent end portion 1402 (i.e., the adjacent bent end portion 1402 and at least one further bent end portion 1402). In some embodiments, some or all the bent end portions 1402 may overlap at least two bent end portions 1402, such as two bent end portions, three bent end portions, four bent end portions, or five bent end portions.

The number of bent end portions 1402 that are overlapped by at least one other bent end portion 1402 determines the cumulative thickness T₃ of the bent end portions 1402. In various embodiments, the cumulative thickness T₃ is between about 20 μm to about 250 μm, between about 20 μm to about 200 μm, between about 20 μm to about 150 μm, between about 20 μm to about 100 μm, between about 20 μm to about 50 μm, between about 50 μm to about 250 μm, between about 50 μm to about 200 μm, between about 50 μm to about 150 μm, between about 50 μm to about 100 μm, between about 100 μm to about 250 μm, between about 100 μm to about 200 μm, between about 100 μm to about 150 μm, between about 150 μm to about 250 μm, between about 150 μm to about 200 μm, or between about 200 μm to about 250 μm. For example, the cumulative thickness T₃ of the overlapping bent end portions 1402 may be about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, or about 250 μm.

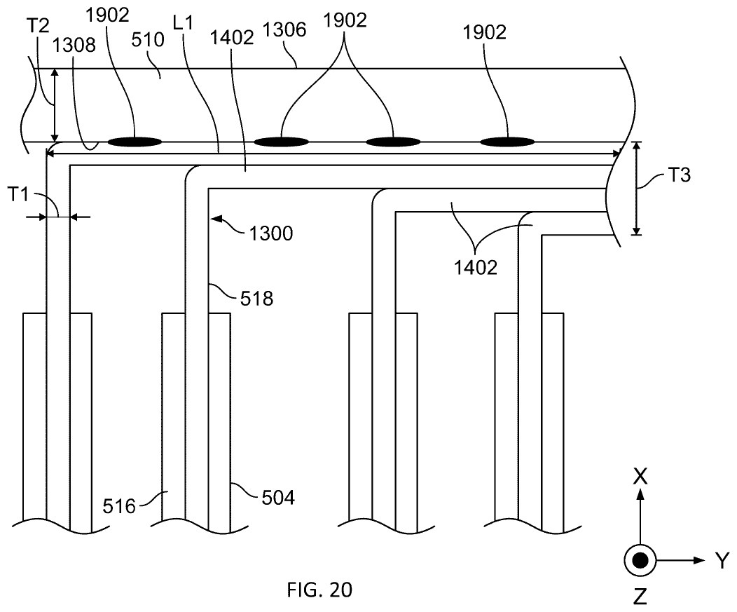

In some embodiments, the cumulative thickness T₃ is at least two times greater than the individual thickness T₁ of the counter-electrode current collectors 518. For example, the cumulative thickness T₃ may be approximately two times the individual thickness T₁, approximately three times the individual thickness T₁, approximately four times the individual thickness T₁, approximately five times the individual thickness T₁, approximately six times the individual thickness T₁, approximately seven times the individual thickness T₁, approximately eight times the individual thickness T₁, approximately nine times the individual thickness T₁, or approximately ten times the individual thickness T₁. FIG. 20 shows an example in which a bent end portion 1402 of one of the counter-electrode current collectors 518 overlaps three successive bent end portions 1402. The cumulative thickness T₃ is approximately four times the individual thickness T₁ in the example of FIG. 20.

The bent end portions 1402 of the counter-electrode current collectors 518 are attached to the interior surface 1308 of the counter-electrode busbar 510, such that a busbar-over-electrode interconnection between the counter-electrode busbar 510 and the counter-electrode structures 504 is established. Alternatively stated, the connection between the counter-electrode busbar 510 and the end portions 1402 of the counter-electrode current collectors 518 is such that the counter-electrode busbar 510 extends across the end portions 1402 in the Y-Z and the bent end portions 1402 are disposed inboard of the counter-electrode busbar 510 between the interior surface 1308 and the rest of the electrode assembly 500. The bent end portions 1402 may be attached to the interior surface 1308 of the counter-electrode busbar 510 by gluing, welding, soldering, or using any other suitable technique.

In certain embodiments, the bent end portions 1402 are directly attached to the interior surface 1308 by laser welding. FIG. 19 schematically depicts laser weld seams 1902 between the bent end portions 1402 and the interior surface 1308 of the counter-electrode busbar 510. The laser weld seams 1902 are shown as discrete, individual seams along the bent end portions 1402 in FIG. 19 but a unitary laser weld seam 1902 may also suitably be formed that extends across a single bent end portion 1402 or across multiple bent end portions 1402 in the longitudinal or Y-axis direction. Moreover, in the illustrated example, the laser weld seams 1902 are formed between the outermost bent end portion 1402 of the overlapping bent end portions 1402, that is, the bent end portion 1402 of the overlapping bent end portions 1402 that is directly attached to the interior surface 1308 of the counter-electrode busbar 510. As shown in FIG. 19, once one of the bent end portions 1402 terminates in its length L₁ or Y-axis extent, the subsequent bent end portion 1402 becomes the outermost bent end portion 1402 and a weld seam 1902 is formed between the subsequent bent end portion 1402 and the interior surface 1308.

In various embodiments, an infrared (IR) laser may be used to laser weld the bent end portions 1402 to the counter-electrode busbar 510. Suitable operating conditions for the IR laser include, for example, a 1064 nm wavelength, 1 watt (W) to 1 kilowatt (kW) power, 5 to 500 mm/s mark speed, and 1-100 kilohertz (kHz) pulse frequency. The operating conditions (e.g., intensity and/or duration) of the laser welding may be controlled such that the weld seams 1902 are formed between the outermost bent end portion 1402 and the interior surface 1308 only, and do not extend through the outermost bent end portion 1402 to underlying bent end portions 1402. In other examples, the weld seams 1902 may extend in the transverse or X-axis direction through multiple of the bent end portions 1402. Suitably, in examples where the weld seams 1902 extend through to underlying bent end portions 1402, the weld seams 1902 do not extend through to the undermost bent end portion 1402 of an overlapping group of bent end portions 1402. The operating conditions of the laser welding may be controlled such that the weld seams 1902 do not extend through to the undermost bent end portion 1402, to reduce or eliminate the likelihood of damaging other components of the electrode assembly 500 that are inboard of the end portions 1402.

As shown in FIG. 19, the end portions 1402 of the counter-electrode current collectors 518 may be bent to approximately a ninety degree angle and the counter-electrode busbar 510 is positioned over the bent end portion 1402. The end portions 1402 need not be bent to exactly ninety degrees and may be generally perpendicular to the rest of the respective current collector 518. The end portions 1402 may be bent to any suitable angle that enables the bent end portions 1402 to overlap at least the adjacent bent end portion 1402. In some embodiments, the end portions 1402 may be bent at an oblique angle (e.g., less than a ninety degree angle) that enables overlap between adjacent bent end portions 1402.

The cumulative thickness T₃ of the overlapping bent end portions 1402 may facilitate increasing the reliability of the connection between the counter-electrode current collectors 518 and the counter-electrode busbar 510. In particular, the cumulative thickness T₃ is closer to the thickness T₂ of the counter-electrode busbar 510 than the individual thickness T₁ of the counter-electrode current collectors 518, which may facilitate reducing the propensity of the bent end portions 1402 to tear when attached to relatively thicker counter-electrode busbar 510. The cumulative thickness T₃ may be greater than or less than the thickness T₂. In some embodiments, the cumulative thickness T₃ is within 50 μm of the thickness T₂, within 25 μm of the thickness T₂, within 20 μm of the thickness T₂, within 15 μm of the thickness T₂, within 10 μm of the thickness T₂, within 5 μm of the thickness T₂, or within 1 μm of the thickness T₂, “within” meaning above or below the thickness T₂. The cumulative thickness T₃ may be within a suitable percentage range above or below the thickness T₂. For example, the cumulative thickness T₃ may be within +/−25% of the thickness T₂, within +/−20% of the thickness T₂, within +/−15% of the thickness T₂, within +/−10% of the thickness T₂, or within +/−5% of the thickness T₂. In some embodiments, the cumulative thickness T₃ may be within +/−1% of the thickness T₂. In some embodiments, the cumulative thickness T₃ is approximately equal to the thickness T₂.

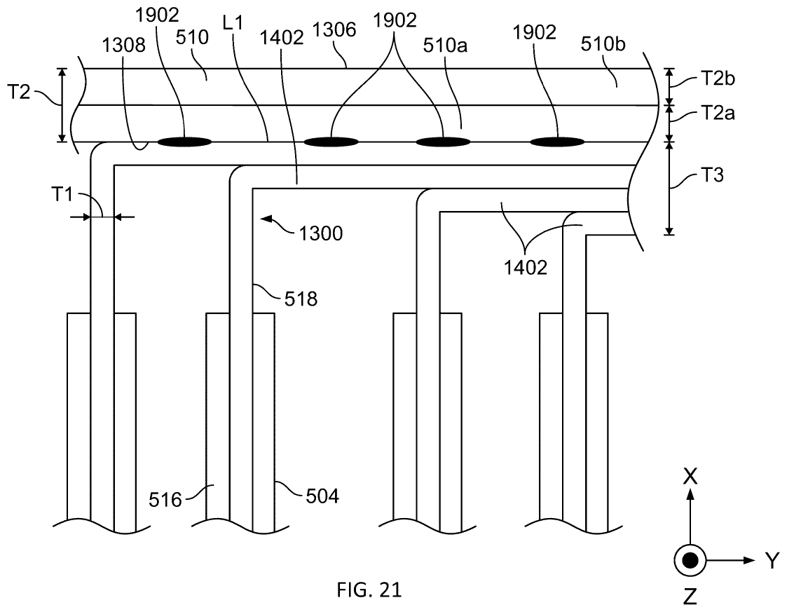

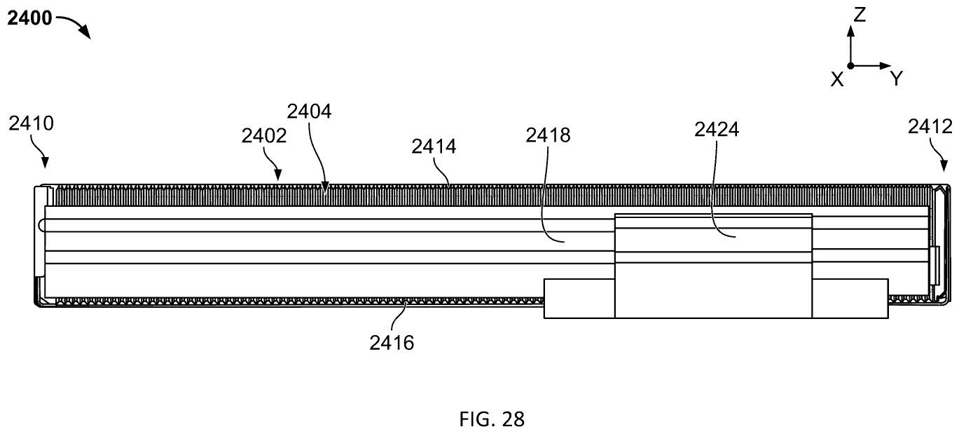

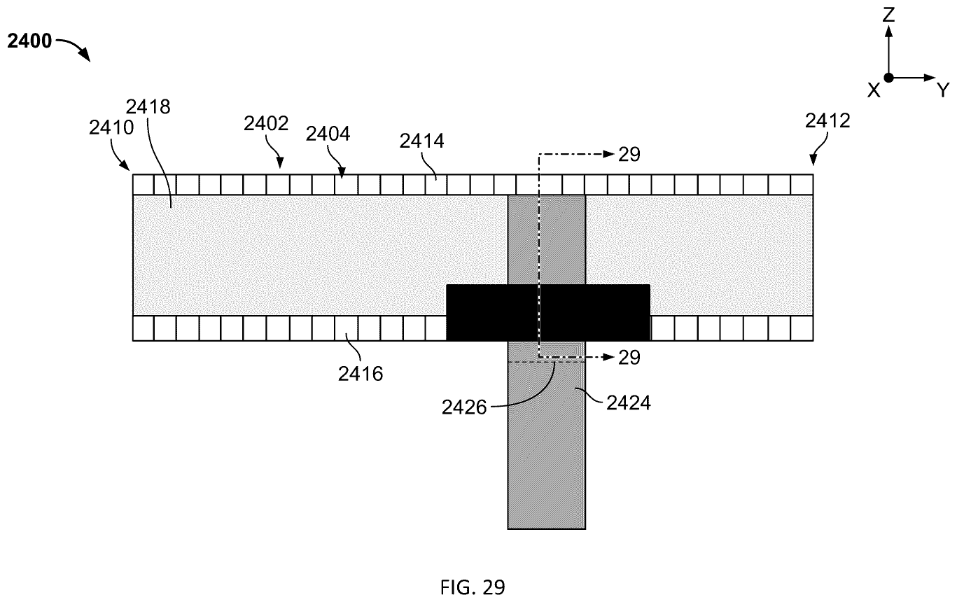

In some embodiments, the counter-electrode busbar 510 may include multiple busbar layers (e.g., two or more layers) successively stacked in the transverse direction to build the thickness T₂ of the busbar 510. FIG. 21 shows an example where the counter-electrode busbar 510 includes a first busbar layer 510a attached to the bent end portions 1402 of the counter-electrode current collectors 518 and a second busbar layer 510b stacked on and attached to the first busbar layer 510a. The first busbar layer 510a has a thickness T₂ₐ and the second busbar layer has a thickness T_{2b}. Together, the thicknesses T₂ₐ and T_{2b} build the thickness T₂ of the counter-electrode busbar 510. The multiple busbar layers (e.g., the first and second layers 510a and 510b) of the counter-electrode busbar 510 may enable a greater overall thickness T₂ without sacrificing the reliability of the connection between the busbar 510 and the bent end portions 1402 disposed inboard therefrom. In some embodiments, the multiple busbar layers (e.g., the first and second layers 510a and 510b) and the bent end portions 1402 of the counter-electrode current collectors 518 make up a busbar layer/current collector stack. In some embodiments, the busbar layer/current collector stack have a combined thickness (T₂ plus T₃) similar to or greater than a thickness of a terminal (e.g., terminal 2424 in FIGS. 28 and 29) promoting reliability and strength of a weld between the terminal and the busbar layer/current collector stack. In some embodiments, the busbar layer/current collector stack have a combined thickness (T₂ plus T₃). The combined thickness may reduce electrical resistance of current in the Y-direction, which reduces overpotential energy loss, joule heating, and/or charge non-uniformity.

The thickness T₂ₐ of the first busbar layer 510a may be approximately equal to, or slightly greater than or less than, the cumulative thickness T₃ of the overlapping bent end portions 1402 to facilitate greater reliability of the attachment therebetween. The thickness T_{2b} of the second busbar layer 510b may be approximately equal to, greater than, or less than the thickness T₂ₐ of the first busbar layer 510a. Suitably, the overall thickness T₂ of the counter-electrode busbar 510 is greater than the cumulative thickness T₃ of the overlapping bent end portions 1402 in these examples. However, in some embodiments where the counter-electrode busbar 510 includes multiple busbar layers (e.g., a first busbar layer 510a and a second busbar layer 510b), the overall thickness T₂ of the counter-electrode busbar 510 may be approximately equal to or less than the cumulative thickness T₃ of the overlapping bent end portions 1402, and the thicknesses T₂ₐ and T_{2b} are each less than the cumulative thickness T₃.

The first busbar layer 510a may be attached to the bent end portions 1402 by gluing, welding, soldering, or using any other suitable technique. The second busbar layer 510b may be attached to the first busbar layer 510a by gluing, welding, soldering, or using any other suitable technique. In some embodiments, the second busbar layer 510b is attached to the first busbar layer 510a using the same technique to attach the first busbar layer 510a to the bent end portions 1402. In certain embodiments, laser welding is used to attach the first busbar layer 510a to the bent end portions 1402 and to attach the second busbar layer 510b to the first busbar layer 510.

The first and second busbar layers 510a and 510b may be made of similar or dissimilar conductive materials to enable the counter-electrode busbar 510 to function as described herein. For example, the first and second busbar layers 510a and 510b may be made of aluminum. While the multiple layered counter-electrode busbar 510 is described with reference to two layers 510a and 510b, any suitable number of layers may be included as described for the layers 510a and 510b to build the thickness T₃ of the counter-electrode busbar 510 and to otherwise enable the busbar 510 to function as described herein.

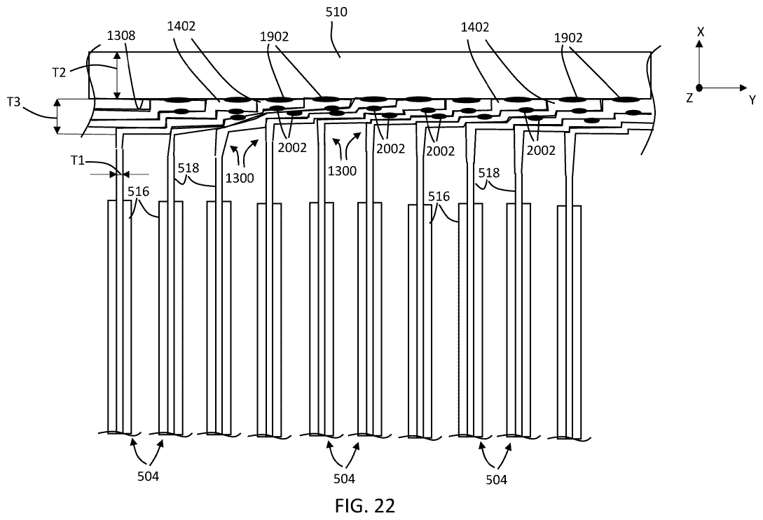

The overlapping bent end portions 1402 may also be attached to each other (e.g., by gluing, welding, soldering, or using any other suitable technique) prior to and/or during the attaching the counter-electrode busbar 510 to the bent end portions 1402. In one example, the overlapping bent end portions 1402 are directly welded (e.g., laser welded) to each other prior to and/or during a welding operation performed to attach the counter-electrode busbar 510 to the bent end portions 1402 (see FIG. 22).

FIG. 22 depicts multiple bent end portions 1402 of the counter-electrode current collectors 518 that overlap successive bent end portions 1402 to build to the cumulative thickness T₃. Each bent end portion 1402 is overlapped by three preceding bent end portions 1402 and overlaps three successive bent end portions 1402. The cumulative thickness T₃ is approximately four times the individual thickness T₁ in the example of FIG. 22. However, this is merely for example only and any suitable number of bent end portions 1402 may overlap to build to a desired thickness T₃.

Each instance of overlapping bent end portions 1402 that build the thickness T₃ may be considered a group of overlapping bent end portions 1402. In the example of FIG. 22, each group includes four overlapping bent end portions 1402. The overlapping bent end portions 1402 transition between groups as an outermost bent end portion 1402 of a group terminates in length in the longitudinal or Y-axis direction and a previously underlying bent end portion 1402 that is immediately overlapped by the terminating bent end portion 1402 becomes the outermost bent end portions 1402 of the subsequent group. Each bent end portion 1402 begins its longitudinal extent as an undermost bent end portion 1402 of a group and progressively advances into closer proximity to the interior surface 1308 until terminating in length as an outermost bent end portion 1402. In the example shown in FIG. 22, each bent end portion 1402 progresses through four different groups of overlapping bent end portions 1402. In other examples, the number of groups through which each bent end portions 1402 progresses is determined by the number of overlapping bent end portions 1402 to build a desired thickness T₃.

The laser weld seams 1902 between the outermost bent end portions 1402 and the interior surface 1308 of the counter-electrode busbar 510 are also shown in FIG. 22. As described above, while the laser weld seams 1902 are shown as discrete, individual weld seams, a unitary laser weld seam 1902 may also suitably be formed that extends across a single bent end portion 1402 or across multiple bent end portions 1402 in the longitudinal or Y-axis direction.

In the example of FIG. 22, laser weld seams 2002 are also formed between overlapping bent end portions 1402. The laser weld seams 2002 attach the overlapping bent end portions 1402 together and facilitate increasing the reliability of the connection between the overlapping bent end portions 1402 and the counter-electrode busbar 510. Although the laser weld seams 2002 are shown as discrete, individual weld seams in FIG. 22, the laser weld seams 2002 may extend either in the transverse or X-axis direction through a group of bent end portions 1402, in the longitudinal or Y-axis direction between groups of bent end portions 1402, or both. In various embodiments, an infrared (IR) laser may be used to laser weld the bent end portions 1402 together and form the laser weld seams 2002. Suitable operating conditions include those described above for laser welding the bent end portions 1402 to the counter-electrode busbar 510.

The laser weld seams 2002 may be formed prior to forming the laser weld seams 1902 or during the laser welding to form the laser weld seams 1902. In the latter case, the laser weld seams 2002 may be extensions of the laser weld seams 1902 in the transverse or X-axis direction. In the former case, the end portions 1402 of the counter-electrode current collectors 518 may be bent to define the overlapping bent end portions 1402, which is followed by laser welding the overlapping bent end portions 1402 to form the laser weld seams 2002 and attach the overlapping bent end portions 1402 together, and then finally the counter-electrode busbar 510 is positioned across the overlapping bent end portions 1402 and the laser weld seams 1902 are formed to attach the busbar 510 to the bent end portions 1402.

In some examples, where the overlapping bent end portions 1402 are laser welded together prior to laser welding the counter-electrode busbar 510 thereto or where the laser weld seams 2002 are formed during the laser welding that forms the laser weld seams 1902, the operating conditions of the laser welding may be controlled such that the laser weld seams 2002 extend through a group in the transverse direction between the outermost bent end portion 1402 and underlying bent end portions 2002 without reaching the undermost bent end portion 1402. This may suitably reduce or eliminate the likelihood of damaging other components of the electrode assembly 500 that are inboard of the end portions 1402. To illustrate, for each group overlapping bent end portions 1402 shown in FIG. 22, a laser weld seam 2002 is formed between the outermost bent end portion 1402 and the immediately underlying or “second” bent end portion 1402, and a laser weld seam 2002 is formed between the second bent end portion 1402 and the next underlying or “third” bent end portion 1402. A laser weld seam 2002 is not formed between the third bent end portion 1402 and the undermost bent end portion 1402. In some examples, a laser weld seam 2002 may be formed between the third bent end portion 1402 and the undermost bent end portion 1402, without extending through the undermost bent end portion 1402 in the transverse or X-axis direction.

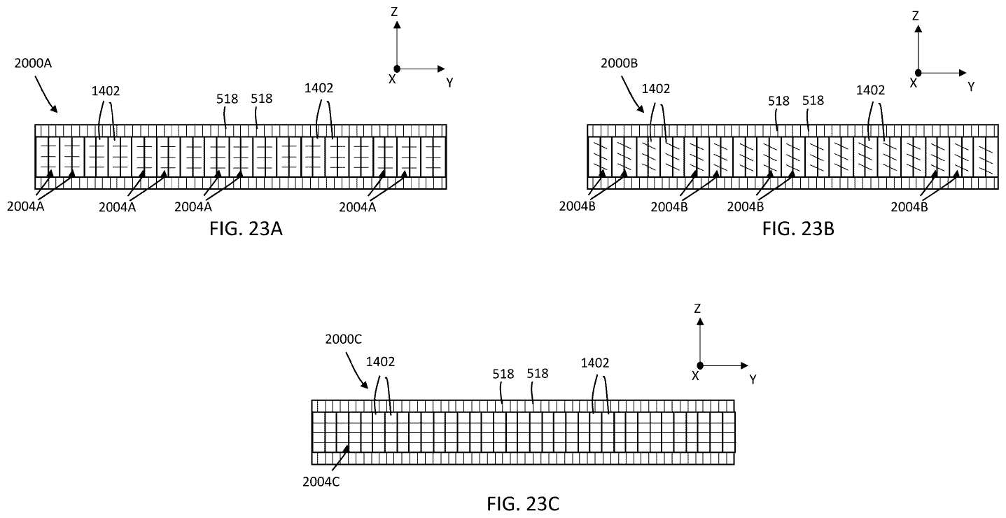

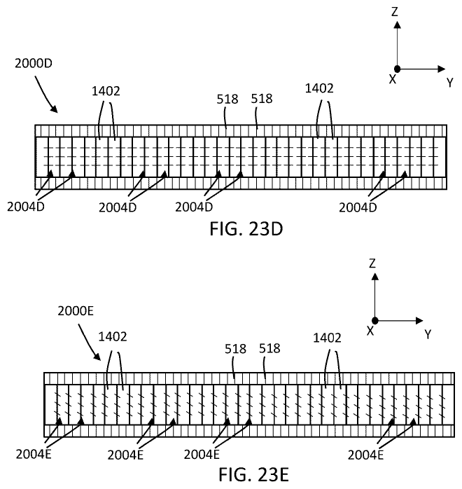

FIGS. 23A-23E depict various examples of laser weld patterns 2004A-2004C, respectively, for forming the laser weld seams 2002 shown in FIG. 22. Each of FIGS. 23A-23E depicts a side view of a partially assembled electrode assembly 2000A-2000E, respectively, viewed along the transverse or X-axis direction, and shows the outermost bent end portion 1402 of each of a population of groups of overlapping bent end portions 1402.

In FIG. 23A, laser weld patterns 2004A are formed on each outermost bent end portion 1402 and extend between adjacent outermost bent end portions 1402 in the longitudinal or Y-axis direction. A single set of laser weld patterns 2004A are formed on each outermost bent end portion 1402, such that each outermost bent end portions 1402 shares a set of laser weld patterns 2004A with only one adjacent outermost bent portion 1402. More than one set of laser weld patterns 2004A may be formed on each outermost bent end portion 1402. For example, FIG. 23D shows an electrode assembly 2000D in which a set of laser weld patterns 2004D are formed extending between each adjacent outermost bent end portion 1402. In other examples, a single set of laser weld patterns 2004A may be formed on each outmost bent end portion 1402 without extending between adjacent outermost bent end portions 1402. The laser weld patterns 2004A of each set extend substantially parallel to one another and substantially parallel to the Y-axis.

The laser weld patterns 2004B in FIG. 23B are similar to the laser weld patterns 2004A shown in FIG. 23A, except that the laser weld patterns 2004B of each set are formed at an oblique angle (e.g., between 10° and 80°, between 15° to 75°, between 20° to 60°, or between 25° to 55°) to the Y-axis. In FIG. 23C, a set of unitary laser weld patterns 2004C extend across each of the outermost bent end portions 1402 in the longitudinal or Y-axis direction. Each unitary laser weld pattern 2004C may be formed by a single (or uninterrupted) welding operation, or may be formed by a series of individual welds that overlap to form a unitary weld pattern 2004C. In FIG. 23E, the laser weld patterns 2004E are similar to the laser weld patterns 2004B shown in FIG. 23D in that the laser weld patterns 2004E are formed at an oblique angle, and a set of laser weld patterns 2004E are formed extending between each adjacent outermost bent end portion 1402 similar to the laser weld patterns 2004D shown in FIG. 23D.

The examples shown in FIGS. 23A-23E show sets of laser patterns 2004A-2004E that include three laser patterns formed on each outermost bent end portion 1402 and spaced in the vertical or Z-axis direction. However, a set of laser patterns formed on each outermost bent end portion 1402 may include any suitable number of laser patterns 2004A-2004E (e.g., one, two, four, five, six, or more than six laser patterns). The number of laser patterns 2004A-2004E formed on an outermost bent end portion 1402 may also vary between outermost bent end portions 1402. The laser weld patterns 2004A-2004E are shown as lines in FIGS. 23A-23E for example only, and may have any other suitable shape. For example, the laser weld patterns 2004A-2004E may be in the form of dots, circles, ovals, or any suitable shape.

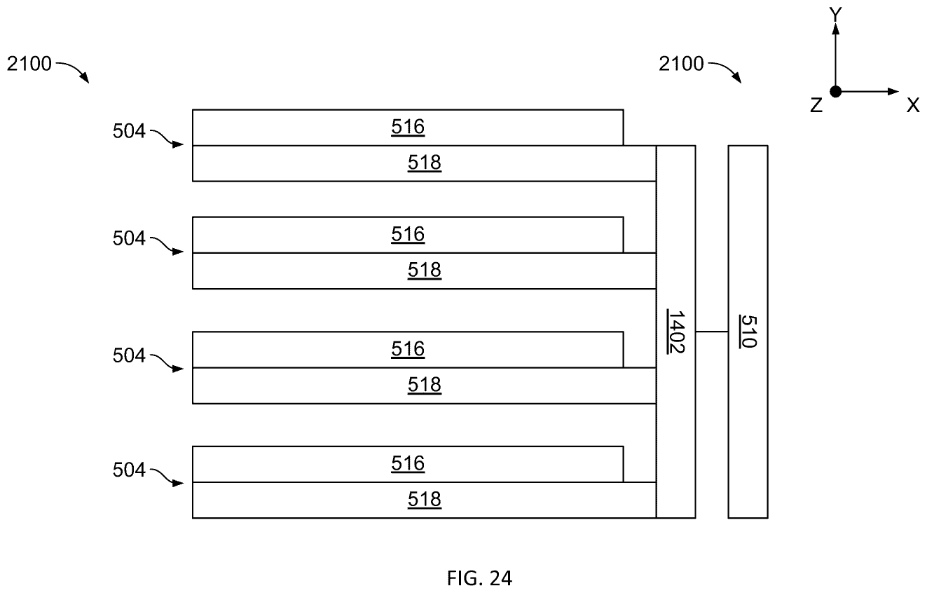

Attaching the overlapping bent end portions 1402 provides a daisy-chain between the counter-electrode structures 504, that is, provides a series connection between the counter-electrode structures 504 from one Y-axis end of an electrode assembly that includes the counter-electrode structures 504 to an opposite Y-axis end. To illustrate, reference is made to FIG. 24 which is a simplified diagram of a portion of an electrode assembly 2100 which may include similar components to the electrode assemblies described above (e.g., the electrode assembly 500 shown in FIG. 5), including the counter-electrode structures 504 each having the counter-electrode active material 516 and the counter-electrode current collector 518. The counter-electrode current collectors 518 are attached (e.g., welded, soldered, or glued) in series, or “daisy-chained,” by the overlapping bent end portions 1402 between a first Y-axis end 2102 of the electrode assembly 2100 to an opposite Y-axis end 2104. The overlapping bent end portions 1402 may be attached to daisy-chain the counter-electrode current collectors 518 using any technique described herein, including the welding techniques described above with reference to FIGS. 22 and 23A-23E. The overlapping bent end portions 1402 are also attached (e.g., welded, soldered, or glued) to the counter-electrode busbar 510. The overlapping bent end portions 1402 may be welded to the counter-electrode busbar 510 using the techniques described above with reference to FIGS. 19-22. The counter-electrode current collectors 504 are connected in parallel when the bent end portions 1402 are attached to the counter-electrode busbar 510.

The overlapping bent end portions 1402 being daisy-chained or connected in series provides a unitary electrical connection with the counter-electrode busbar 510 that compensates for and reduces the opportunity for a single failed attachment location (e.g., a single weld) between the counter-electrode busbar 510 and the bent end portions 1402 to result in lower energy and power density and/or lower battery capacity. In examples where the counter-electrode busbar 510 is connected to each counter-electrode current collector 518 at discrete locations (e.g., as shown in FIGS. 17 and 18), a failed connection between the counter-electrode busbar 510 and one of the counter-electrode current collectors 518 is not compensated for by the other connections as the counter-electrode current collectors 518 are electrically connected only by their respective connections with the busbar 510. Furthermore, attaching the overlapping bent end portions 1402 provides a metrology benefit in that, prior to attached the counter-electrode busbar 510 to the counter-electrode current collectors 518, verification tests (e.g., resistance probing) may be performed to determine whether the counter-electrode structures 504 are electrically connected together by the overlapping bent end portions 1402 which indicates reliable connections therebetween.

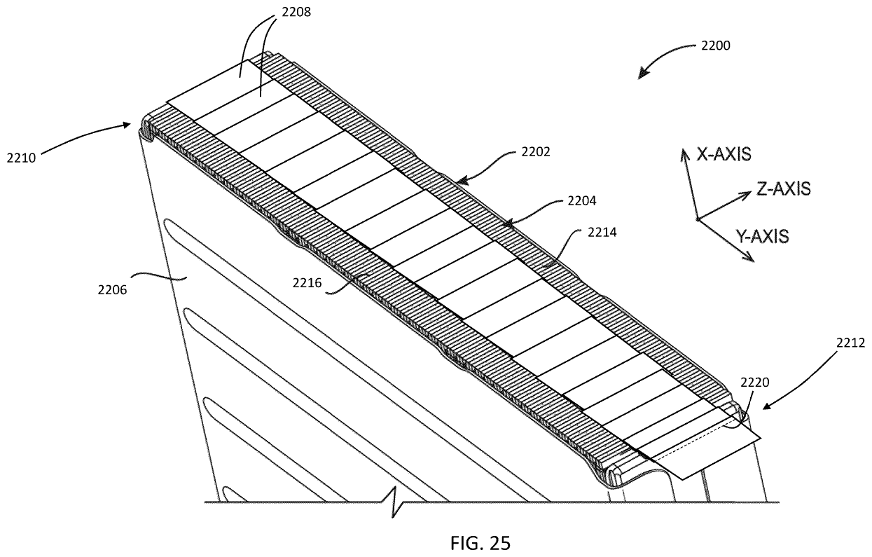

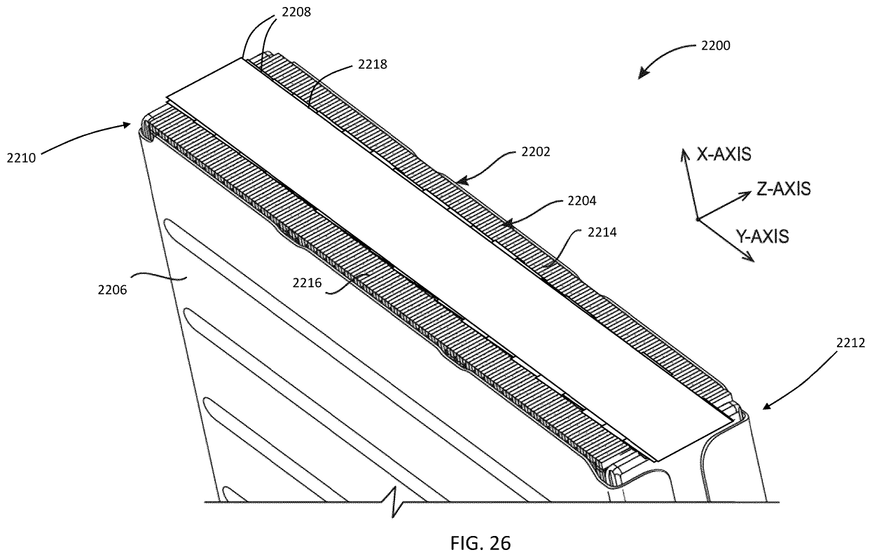

Reference is now made to FIGS. 25 and 26, which are enlarged partial detail perspective views of a partially assembled example secondary battery 2200, which may include similar components to secondary batteries described above (e.g., the secondary battery 100 in FIG. 1). In this embodiment, the secondary battery 2200 includes an electrode assembly 2202, which may be the same as or similar to the electrode assemblies described above, such as the electrode assembly 150 (FIG. 1) and/or electrode assembly 500 (FIG. 5). The electrode assembly 2202 includes a population of unit cells 2204 (e.g., the unit cell 200A and/or the unit cell 200B, FIG. 2) organized in a stacked arrangement in the Y-axis direction. Each of the unit cells 2204 includes at least an electrode structure that includes an electrode current conductor (e.g., an anode type current collector) and an electrode active material (e.g., anodically active material layer), a separator layer, and a counter-electrode structure including a counter-electrode current collector (e.g., a cathode type current collector) and a counter-electrode active material.

The stacked unit cells 2204 of the electrode assembly 2202 are held within a casing or constraint 2206 (which, in some embodiments, may be the same as or similar to the casing 116 shown in FIG. 1). When the secondary battery 2200 is completely assembled, the electrode assembly 2202 is disposed within a battery enclosure made of an insulating packaging material, such as a multi-layer aluminum polymer material, plastic, or the like.

As shown in FIG. 25, a current collector tab 2208 extends from a counter-electrode (e.g., a cathode) structure or an electrode (e.g., anode) structure of each of the unit cells 2204. In particular, similar to the bent end portions 1402 (FIGS. 19-23), each current collector tab 2208 is formed as an end portion of a current collector of the counter-electrode structure or electrode structure that extends outward beyond the active material of the structure to an X-axis terminus of the structure and is bent generally in the Y-axis direction back towards the electrode assembly 2202. Each current collector tab 2208 is bent in the same direction. In the illustrated example, each current collector tab 2208 is bent clockwise about the Z-axis, that is, from the X-axis, away from a first Y-axis end 2210 of the electrode assembly 2202 and towards a second Y-axis end 2212 of the electrode assembly 2202. Each current collector tab 2208 has a suitable length (which may be similar to the length L₁ described above with reference to FIGS. 19 and 20) in the Y-axis direction when bent to overlap one or more other current collector tabs 2208 and thereby build a thickness (e.g., the thickness T₃ described above with reference to FIGS. 19-23), measured in the X-axis direction, of the overlapping current collector tabs 2208 in a Y-Z plane of the electrode assembly 2202 defined by the Y and Z axes.

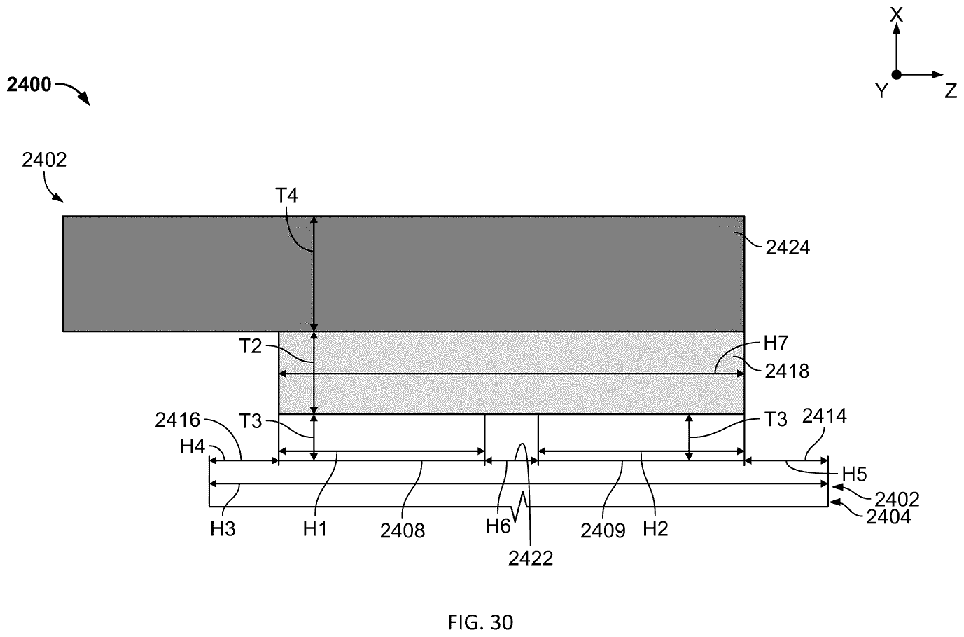

As shown in FIG. 25, in some embodiments, the current collector tabs 2208 have a height in the Z-axis direction that is less than a height of the unit cells 2204. The height of the current collector tabs 2208 may be similar to a sum total of the heights H₁, H₂, and H₆ described below and shown in FIG. 30. Accordingly, a first margin 2214 and a second margin 2216 of the unit cells 2204 are defined as extending from an outer edge of the electrode assembly 2202 to an outside edge of the collector tabs 2208, and the height of the unit cells 2204 is approximately equal to the height of the current collector tabs 2208 plus a margin height of each of the first margin 2214 and the second margin 2216 measured in the Z-axis direction. The margin height of the first margin 2214 and the second margin 2216 may be similar to the margin heights H₄ and H₅, respectively, described below and shown in FIG. 30.

The overlapping current collector tabs 2208 may be attached or secured together using any suitable technique, such as an adhesive, laser welding, and/or soldering, for example. For example, the overlapping current collector tabs 2208 may be laser welded together as described above for the bent end portions 1402 with reference to FIGS. 22 and 23A-23E. When attached, the overlapping current collector tabs 2208 may be daisy-chained or connected together in series from the first end 2210 of the electrode assembly 2202 in the Y-axis to the second end 2212 of the electrode assembly 2202 in the Y-axis. The overlapping current collector tabs 2208 may be attached before being attached to a busbar 2218 (shown in FIG. 26) or at the same time as the busbar 2218 is attached thereto.

Due to the Y-axis extent of the current collector tabs 2208 when bent towards the second end 2212 of the electrode assembly 2202, the current collector tabs 2208 of the current collectors located proximate the second Y-axis end 2212 extend outward beyond the second end 2212. The current collector tabs 2208 extending outward beyond the second Y-axis end 2212 may be cut along a cut line 2220 such that the collective length of the current collector tabs 2208 in the Y-axis direction is approximately equal to the length of the electrode assembly 2202 between the first end 2210 and the second end 2212 in the Y-axis direction. These current collector tabs 2208 may be cut, for example, by laser cutting when the overlapping current collector tabs 2208 are laser welded. Any other suitable cutting technique (e.g., a mechanical cutting technique) may be used to cut the current collector tabs 2208 extending outward beyond the second Y-axis end 2212.

Alternatively, the current collector tabs 2208 that extend outward beyond the second Y-axis end 2212 of the electrode assembly 2202 may not be cut. In these examples, the tabs 2208 proximate the second Y-axis ends 2212 may be folded towards the X-axis direction or may remain extending in the Y-axis direction beyond the second end 2212. The secondary battery 2200 may include an insulation layer (not shown) disposed over opposing Y-axis sides of the electrode assembly that each lie in an X-Z plane defined by the X and Z axes, and the insulation layer on the side adjacent the second end 2212 may extend in the X-axis direction to electrically insulate the tabs 2208 extending beyond the second end 2212, and/or to limit or prevent the tabs from contacting the casing or constraint 2206 within which the electrode assembly 2202 is contained when the secondary battery 2200 is assembled. Additionally and/or alternatively, the tabs 2208 may be folded toward the X-Z plane adjacent the second end 2212 and attached to a side of the casing or constraint 2206 using electrically insulating material (e.g., electrically insulating adhesive material).

As shown in FIG. 26, a busbar 2218 (which may be the same as or similar to the busbar 510 described above) extends along the Y-axis direction across each of the unit cells 2204. More specifically, the busbar 2218 is positioned along an end of the electrode assembly 2202 in the Y-Z plane and extends across the bent current collector tabs 2208. As such, the bent current collector tabs 2208 are disposed inboard of the busbar 2218, that is, between the busbar 2218 and the rest of the electrode assembly 2202.

The busbar 2218 may extend an entire length of the electrode assembly 2202 in the Y-axis direction, between the first end 2210 and the second end 2212 of the electrode assembly 2202, as shown in FIG. 26. In other embodiments, the busbar 2218 may extend less than the entire length of the electrode assembly 2202 in the Y-axis direction.

The height of the busbar 2218, measured in the Z-axis direction, may be approximately equal to the height of the current collector tabs 2208 in the Z-axis direction such that the busbar 2218 substantially covers the tabs 2208 without extending into the margins 2214 or 2216. The height of the busbar 2218 may be similar to the height H₇ described below and shown in FIG. 30. In other embodiments, the busbar 2218 may have a height in the Z-axis direction that is greater than or less than the height of the current collector tabs 2208.

To secure the current collector tabs 2208 to the busbar 2218, the busbar 2218 may be welded at one or more weld locations to the current collector tabs 2208. For example, the busbar 2218 may be laser welded to the current collector tabs 2208 as described above for the bent end portions 1402 with reference to FIGS. 19-22 and 23A-23E. In other embodiments, another suitable attachment technique may be used to secure the busbar 2218 to the current collector tabs 2208, such as using an adhesive, for example. The busbar 2218 may have a thickness, measured in the X-axis direction, that is similar to the thickness T₂ described above with reference to FIGS. 19 and 20, and may in some examples be formed of multiple busbar layers (e.g., as described above for the first busbar layer 510a and the second busbar layer 510b with reference to FIG. 21).

In examples where the current collector tabs 2208 that extend outward beyond the second Y-axis end 2212 of the electrode assembly 2202 are not cut, these tabs may not be directly attached to the busbar 2218 but are electrically connected to the busbar 2218 via the serial connection between the overlapping tabs 2208 attached together and the parallel connection provided by attaching the overlapping tabs 2208 to the busbar 2218. Furthermore, the busbar 2218 may not extend across the tabs 2208 extending outward beyond the second Y-axis end 2212 of the electrode assembly 2202. Reference made herein to the overlapping current collector tabs, such as the current collector tabs 2208, being disposed inboard of the busbar, such as the busbar 2218, encompasses examples where there are current collector tabs that extend outward beyond Y-axis end(s) of the electrode assembly of which they are a part, even though the outward-extending tabs may not be directly attached to the busbar and/or not directly covered by the busbar.

A conductive terminal (not shown in FIG. 26) may be attached to the busbar 2218. For example, the conductive terminal may be directly welded to the busbar 2218 when the busbar 2218 is attached to the current collector tabs 2208. Suitably, the busbar 2218 is a substantially planar strip of one or more layers of material (e.g., aluminum in a cathode type or copper in an anode type) such that a thickness of the busbar 2218, measured in the X-axis direction, is substantially uniform across the Y-axis extent of the busbar 2218. The conductive terminal is attached (e.g., welded) to a portion of the busbar 2218 extending between the ends 2210 and 2212 of the electrode assembly 2202. This eliminates the busbar 2218 from having to be bent or folded after the conductive terminal is attached to an outer portion of the busbar 2218 that extends beyond one of the ends 2210 or 2212, as is typical in existing electrode assemblies and otherwise creates the opportunity to mechanically damage or tear the current collector tabs 2208 near the end 2210 or 2212 at which the busbar 2218 is bent or folded. The conductive terminal may be attached (e.g., welded) to the busbar 2218 without subsequent bending or folding of the busbar 2218 due to the increased reliability of the connection between the busbar 2218 and the overlapping current collector tabs 2208. The conductive terminal of the electrode assembly 2202 may have a thickness, measured in the X-axis direction, similar to the thickness T₄ described below and shown in FIG. 30.

In the example embodiment, all the current collector tabs 2208 on a single side of the electrode assembly 2202 (e.g., the side illustrated in FIGS. 25 and 26) extend from the same type of electrode or counter-electrode structure. In the example embodiment, the current collector tabs 2208 extend from a cathode structure, and more particularly from the cathode current collectors of the electrode assembly 2202. In other embodiments, the current collector tabs 2208 may extend from the anode current collectors of the electrode assembly 2202.

On an opposite side of the electrode assembly 2202 (e.g., on the opposite Y-Z side of the electrode assembly 2202), an equivalent number of the other type of electrode will have current collector tabs extending therefrom. A single busbar may extend along the entirety of the length of the unit cells 2204 in the Y-axis direction on the opposite side of the battery. In the example embodiment, an anode type busbar extends across the unit cells 2204 on the opposite side of the electrode assembly 2202 and is attached to the anode current collectors via corresponding tabs. The anode busbar may be connected to the anode current collectors in a similar manner as the current collector tabs 2208 and the busbar 2218 or using any other connection technique described above. In some examples, the anode busbar is connected to the anode current collectors through a current limiter (e.g., a current limiter 506) as described above for the electrode structures 502 and the electrode busbar 508 with reference to FIGS. 9-15. A conductive terminal is attached to the anode busbar and extends outward therefrom.

The conductive terminals included in the electrode assembly 2202 may be made of any suitable conductive metal. In various embodiments, the conductive terminal attached to the busbar 2218, which is a cathodic type busbar in the example electrode assembly 2202, may be made of aluminum, and the conductive terminal attached to the anode busbar may be made of nickel.

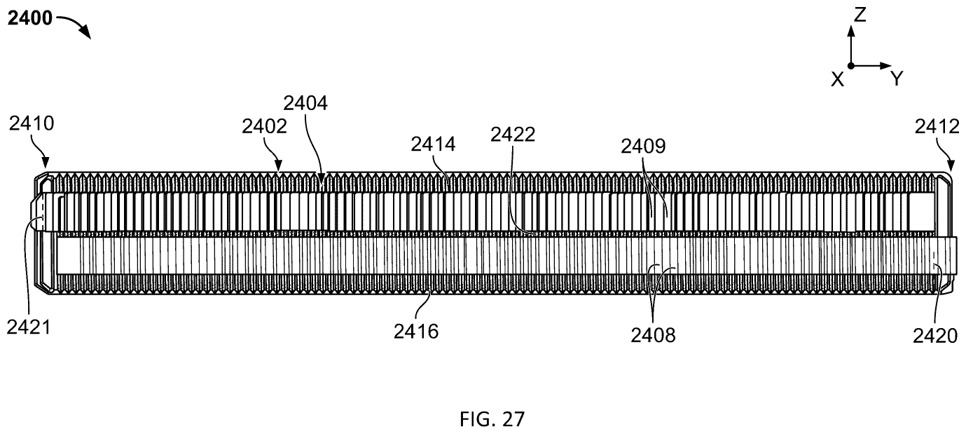

FIGS. 27 and 28 are side views of another example partially assembled secondary battery 2400. FIG. 29 is a schematic side view of the secondary battery 2400 shown in FIG. 28 and FIG. 30 is a cross section taken along the lines 29-29 in FIG. 29. The secondary battery 2400 includes, similar to the secondary battery 2200 described above with reference to FIGS. 25 and 26, an electrode assembly 2402, which may be the same as or similar to the electrode assemblies described above, such as the electrode assembly 150 (FIG. 1) and/or electrode assembly 500 (FIG. 5). The electrode assembly 2402 includes a population of unit cells 2404 (e.g., the unit cell 200A and/or the unit cell 200B, FIG. 2) organized in a stacked arrangement in the Y-axis direction. Each of the unit cells 2404 includes at least an electrode layer that includes an electrode current conductor (e.g., an anode type current collector) and an electrode active material (e.g., anodically active material layer), a separator layer, and a counter-electrode layer including a counter-electrode current collector (e.g., a cathode type current collector) and a counter-electrode active material.

When the secondary battery 2400 is completely assembled, the stacked unit cells 2404 of the electrode assembly 2402 are held within a constraint (which, in some embodiments, may be the same as or similar to the casing 116 shown in FIG. 1 or the constraint 2206 shown in FIGS. 25 and 26), and the electrode assembly 2402 is disposed within a battery enclosure made of an insulating packaging material, such as a multi-layer aluminum polymer material, plastic, or the like.

In this embodiment, two current collector tabs 2408 and 2409 extend from a counter-electrode (e.g., a cathode) structure or an electrode (e.g., anode) structure of each of the unit cells 2404. Each current collector tab 2408 and 2409 is formed as an end portion of a current collector of the counter-electrode structure or electrode structure that extends outward beyond the active material of the structure to an X-axis terminus of the structure and is bent generally in the Y-axis direction back towards the electrode assembly 2402. For each current collector, the current collector tabs 2408 and 2409 are spaced from each other in the Z-axis direction. Each current collector tab 2408 is bent in the same direction as the other current collector tabs 2408 and each current collector tab 2409 is bent in the same direction as the other current collector tabs 2409. In the illustrated example, the current collector tabs 2408 are bent in the opposite direction to the current collector tabs 2409. In particular, the current collector tabs 2408 are bent from the X-axis, away from a first Y-axis end 2410 of the electrode assembly 2402 and towards a second Y-axis end 2412 of the electrode assembly 2402, and the current collector tabs 2409 are bent from the X-axis, away from the second end 2412 of the electrode assembly 2402 and towards the first end 2412 of the electrode assembly 2402.

Each current collector tab 2408 and 2409 has a suitable length (which may be similar to the length L₁ described above with reference to FIGS. 19 and 20) in the Y-axis direction when bent to respectively overlap one or more other current collector tabs 2408 or one or more other current collector tabs 2409. The overlapping current collector tabs 2408 and the overlapping current collector tabs 2409 build a thickness, measured in the X-axis direction and relative to the Y-Z plane of the electrode assembly 2402. In the example embodiment, the overlapping current collector tabs 2408 and the overlapping current collector tabs 2409 build to the cumulative thickness T₃, which is described above with reference to FIGS. 19-23. The overlapping current collector tabs 2408 and the overlapping current collector tabs 2409 have the same cumulative thickness T₃ in this embodiment, but in other embodiments may have different thicknesses measured in the X-axis direction.

The current collector tabs 2408 extend a height H₁ and the current collector tabs 2409 extend a height H₂ in the Z-axis direction. The heights H₁ and H₂ of the current collector tabs 2408 and 2409, respectively, may be the same or different. The heights H₁ and H₂ will also vary depending upon the secondary battery 2400 and its intended use. For example, the heights H₁ and H₂ may be within the range of about 0.05 mm to about 10 mm, such as between about 0.1 mm to about 5 mm, between about 0.1 mm to about 1 mm, between about 0.5 mm to about 1 mm, between about 1 mm to about 5 mm, between about 1 mm to about 3 mm, or between about 1 mm to about 2 mm. A total height of the current collector tabs 2408 and 2409, measured as the sum of the heights H₁ and H₂ in the Z-axis direction, is less than a height H₃ of the electrode assembly 2402 in the Z-axis direction. As such, a first margin 2414 of the unit cells 2404 is defined adjacent to the current collector tabs 2409, opposite the tabs 2408, and a second margin 2416 of the unit cells 2404 is defined adjacent to the current collector tabs 2408, opposite the tabs 2409.

The spacing between the tabs 2408 and 2409 of each current collector in the Z-axis defines a medial gap 2422 extending between the current collector tabs 2408 and the current collector tabs 2409 the Y-axis extent of the electrode assembly 2402 (i.e., the medial gap 2422 separates the current collector tabs 2408 and the current collector tabs 2409 the entire Y-axis extent between the ends 2410 and 2412 of the electrode assembly 2402). The height H₃ of the unit cells 2404 in the Z-axis direction is approximately equal to the sum total of the height H₁ of the current collector tabs 2408, the height H₂ of the current collector tabs 2409, a margin height H₄ and H₅ of each of the first margin 2214 and the second margin 2216, respectively, measured in the Z-axis direction, and a gap height H₆ of the medial gap 2422 measured in the Z-axis direction.

The margin heights H₄ and H₅ may be the same or different. In various embodiments, the margin heights H₄ and H₅ are between about 50 μm to about 1 mm, between about 50 μm to about 500 μm, between about 50 μm to about 300 μm, between about 100 μm to about 500 μm, between about 100 μm to about 400 μm, between about 100 μm to about 300 μm, between about 150 μm to about 300 μm, or between about 150 μm to about 250 μm. The gap height H₆ may be the same as either or both of the margin heights H₄ and H₅, and example gap heights H₆ include those within the same range as or a similar range to the margin heights H₄ and H₅.

The overlapping current collector tabs 2408 and the overlapping current collector tabs 2409 may be respectively attached or secured together using any suitable technique, such as an adhesive, laser welding, and/or soldering, for example. For example, the overlapping current collector tabs 2408 and the overlapping current collector tabs 2409 may be laser welded together as described above for the bent end portions 1402 with reference to FIGS. 22 and 23A-23E. When attached, the overlapping current collector tabs 2408 and the overlapping current collector tabs 2409 may be respectively daisy-chained or connected together in series from the first end 2410 of the electrode assembly 2402 in the Y-axis to the second end 2412 of the electrode assembly 2402 in the Y-axis. The overlapping current collector tabs 2408 and/or the overlapping current collector tabs 2409 may be attached before being attached to a busbar 2418 or at the same time as the busbar 2418 is attached thereto.

Due to the Y-axis extent of the current collector tabs 2408 when bent towards the second end 2412 of the electrode assembly 2402, the current collector tabs 2408 of the current collectors located proximate the second end 2412 extend outward beyond the second end 2412. Similarly, the current collector tabs 2409 of the current collectors located proximate the first end 2410 extend outward beyond the first end 2410. The current collector tabs 2408 and 2409 that extend outward beyond the Y-axis ends 2410, 2412 of the electrode assembly 2402 may be cut along a cut line 2420 and 2421, respectively, such that the collective length of the current collector tabs 2408 and the collective length of the current collector tabs 2409 in the Y-axis direction is approximately equal to the length of the electrode assembly 2402 between the first end 2410 and the second end 2412 in the Y-axis direction. These current collector tabs 2408 and 2409 may be cut, for example, by laser cutting when the overlapping current collector tabs 2408 and the overlapping current collector tabs 2409 are respectively laser welded. Any other suitable cutting technique (e.g., a mechanical cutting technique) may be used to cut the current collector tabs 2408 and 2409 that extend outward beyond the Y-axis ends 2410, 2412 of the electrode assembly 2402.

Alternatively, the current collector tabs 2408 and 2409 that extend outward beyond the Y-axis ends 2412, 2410 of the electrode assembly 2402, respectively, may not be cut. In these examples, the tabs 2408, 2409 proximate the Y-axis ends 2412, 2410 may be folded towards the X-axis direction or may remain extending in the Y-axis direction beyond the ends 2412, 2410. The secondary battery 2400 may include an insulation layer (not shown) disposed over opposing Y-axis sides of the electrode assembly that each lie in an X-Z plane defined by the X and Z axes, and the insulation layer may extend in the X-axis direction to electrically insulate the tabs 2408, 2409 extending beyond the Y-axis ends 2412, 2410, respectively, and/or to limit or prevent the tabs from contacting the casing or constraint within which the electrode assembly 2402 is contained when the secondary battery 2400 is assembled. Additionally and/or alternatively, the tabs 2408, 2409 may be folded toward a respective X-Z plane and attached to a side of the casing or constraint using electrically insulating material (e.g., electrically insulating adhesive material).

A busbar 2418 (which may be the same as or similar to the busbar 510 described above) extends along the Y-axis direction across each of the unit cells 2404. The bent current collector tabs 2408 and the bent current collector tabs 2409 are each disposed inboard of the busbar 2418. In the example embodiment, the busbar 2418 has a height H₇, measured in the Z-axis direction, that is approximately equal to or greater than a sum total of the height Hi of the current collector tabs 2408, the height H₂ of the current collector tabs 2409, and the gap height H₆ of the medial gap 2422 measured in the Z-axis direction, which enables the busbar 2418 to extend across both the bent current collector tabs 2408 and the bent current collector tabs 2409. In some embodiments, the height H₇ of the busbar 2418 may be less than the sum total of the heights H₁, H₂, and H₆.

The busbar 2418 may extend an entire length of the electrode assembly 2402 in the Y-axis direction, between the first end 2410 and the second end 2412 of the electrode assembly 2402. In other embodiments, the busbar 2418 may extend less than the entire length of the electrode assembly 2402 in the Y-axis direction.

To secure the current collector tabs 2408 and 2409 to the busbar 2418, the busbar 2418 may be welded at one or more weld locations to the current collector tabs 2408 and the current collector tabs 2409. For example, the busbar 2418 may be laser welded to the current collector tabs 2408 and 2409 as described above for the bent end portions 1402 with reference to FIGS. 19-22 and 23A-23E. In some embodiments, a bridge (not shown) made of a suitable electrically conductive material (e.g., aluminum) may extend across the current collector tabs 2408 and 2409 and be laser welded thereto, and the busbar 2418 may be welded or otherwise attached to the bridge. The bridge may form a first busbar layer and the busbar 2418 may form a second busbar layer. In some embodiments, the bridge comprises the first busbar layer or a portion of the first busbar layer. Is some embodiments, the bridge connects one or more rows of current collectors. In other embodiments, another suitable attachment technique may be used to secure the busbar 2418 to the current collector tabs 2408 and 2409, such as using an adhesive, for example. The busbar 2418 may have a thickness, measured in the X-axis direction, similar to the thickness T₂ described above with reference to FIGS. 19 and 20, and may in some examples be formed of multiple busbar layers (e.g., as described above for the first busbar layer 510a and the second busbar layer 510b with reference to FIG. 21).

In examples where the current collector tabs 2408 and 2409 that extend outward beyond the Y-axis ends 2412, 2410 of the electrode assembly 2402, respectively, are not cut, these tabs may not be directly attached to the busbar 2418 but are electrically connected to the busbar 2418 via the serial connection between the overlapping tabs 2408, 2409 attached together and the parallel connection provided by attaching the overlapping tabs 2408, 2409 to the busbar 2418. Furthermore, the busbar 2418 may not extend across the tabs 2408, 2409 extending outward beyond the Y-axis ends 2412, 2410 of the electrode assembly 2402, respectively. Reference made herein to the overlapping current collector tabs, such as the current collector tabs 2408 and 2409, being disposed inboard of the busbar, such as the busbar 2418, encompasses examples where there are current collector tabs that extend outward beyond Y-axis end(s) of the electrode assembly of which they are a part, even though the outward-extending tabs may not be directly attached to the busbar and/or not directly covered by the busbar.

The electrode assembly 2402 also includes conductive terminal 2424 attached to the busbar 2418. For example, the conductive terminal 2424 may be directly welded to the busbar 2418 when the busbar 2418 is attached to the current collector tabs 2408 and 2409. Suitably, the busbar 2418 is a substantially planar strip of one or more layers of material (e.g., aluminum in a cathode type or copper in an anode type) such that a thickness (e.g., the thickness T₃) of the busbar 2418, measured in the X-axis direction, is substantially uniform across the Y-axis extent of the busbar 2418. The conductive terminal 2424 is attached (e.g., welded) to a portion of the busbar 2418 extending between the ends 2410 and 2412 of the electrode assembly 2402. This eliminates the busbar 2418 from having to be bent or folded after the conductive terminal 2424 is attached to an outer portion of the busbar 2418 that extends beyond one of the ends 2410 or 2412, as is typical in existing electrode assemblies and otherwise creates the opportunity to mechanically damage or tear the current collector tabs 2408 and/or 2409 near the end 2410 or 2412 at which the busbar 2418 is bent or folded. The conductive terminal 2424 may be attached (e.g., welded) to the busbar 2418 without subsequent bending or folding of the busbar 2418 due to the increased reliability of the connection between the busbar 2418 and the overlapping current collector tabs 2408 and the overlapping current collector tabs 2409. As shown in FIG. 29, the conductive terminal 2424 is attached to the busbar 2418 in the Y-Z plane of the electrode assembly 2402 and extends outward from the busbar 2418. In the example embodiment, the conductive terminal 2424 extends outward from the busbar 2418 in the Z-axis direction. In other embodiments, the conductive terminal 2424 may be bent along a line (schematically shown as line 2426 in FIG. 29) outward from the electrode assembly 2402 (i.e., out of the page in FIG. 29) and towards the X-axis direction.

As shown in FIG. 30, the conductive terminal 2424 has a thickness T₄ measured in the X-axis direction. The thickness T₄ is generally greater than or equal to the thickness T₂ of the busbar 2418. The thickness T₄ of the conductive terminal 2424 may, for example, be between about 50 μm to about 1 mm, between about 500 μm to about 1 mm, between about 50 μm to about 500 μm, between about 100 μm to about 500 μm, between about 200 μm to about 500 μm, between about 300 μm to about 500 μm, between about 400 μm to about 500 μm, between about 20 μm to about 400 μm, between about 20 μm to about 300 μm, between about 20 μm to about 200 μm, between about 20 μm to about 100 μm, between about 100 μm to about 400 μm, between about 100 μm to about 300 μm, between about 100 μm to about 200 μm, between about 100 μm to about 150 μm, or between about 50 μm to about 150 μm. For example, the thickness T₄ of the conductive terminal may be about 50 μm, about 100 μm, about 150 μm, about 200 μm, about 250 μm, about 300 μm, about 350 μm, about 400 μm, about 450 μm, about 500 μm, about 600 μm, about 700 μm, about 800 μm, about 900 μm, or about 1 mm.

In the example embodiment, all the current collector tabs 2408 and 2409 on a single side of the electrode assembly 2402 (e.g., the side illustrated in FIGS. 25 and 26) extend from the same type of electrode or counter-electrode structure. In the example embodiment, the current collector tabs 2408 and 2409 extend from a cathode structure, and more particularly from the cathode current collectors of the electrode assembly 2402. In other embodiments, the current collector tabs 2408 and 2409 may extend from the anode current collectors of the electrode assembly 2402.

On an opposite side of the electrode assembly 2402 (e.g., on the opposite Y-Z side of the electrode assembly 2402), an equivalent number of the other type of electrode will have current collector tabs extending therefrom. A single busbar may extend along the entirety of the length of the unit cells 2404 in the Y-axis direction on the opposite side of the battery. In the example embodiment, an anode type busbar extends across the unit cells 2404 on the opposite side of the electrode assembly 2402 and is attached to the anode current collectors via corresponding tabs. The anode busbar may be connected to the anode current collectors in a similar manner as the current collector tabs 2408 and 2409 and the busbar 2418 or using any other connection technique described above. In some examples, the anode busbar is connected to the anode current collectors through a current limiter (e.g., a current limiter 506) as described above for the electrode structures 502 and the electrode busbar 508 with reference to FIGS. 9-15. A conductive terminal is attached to the anode busbar and extends outward therefrom.

The conductive terminals included in the electrode assembly 2202 may be made of any suitable conductive metal. In various embodiments, the conductive terminal 2424 attached to the busbar 2418, which is a cathodic type busbar in the example electrode assembly 2402, may be made of aluminum, and the conductive terminal attached to the anode busbar may be made of nickel.

The oppositely-bent configuration of the current collector tabs 2408 and the current collector tabs 2409 described with reference to FIGS. 27-20 may provide several advantages in addition to those provided by the overlapping tab configuration. For example, this configuration alleviates the risk that the current collectors proximate either end 2410 or 2412 of the electrode assembly 2402 will not have sufficient connection with the busbar 2418 when the current collector tabs 2408 or 2409 are cut along the respective cut lines 2420 and 2421. In addition, this configuration may provide strain relief during formation and cycling of the secondary battery 2400 as the tensile forces applied to the current collector tabs 2408 balance those applied to the current collector tabs 2409.

Referring generally to FIGS. 25-30, a reinforcement structure (not shown) may be utilized in some embodiments that is applied over the busbar 2218 or 2418 in the Y-Z plane to facilitate reducing or eliminating the potential for abuse conditions (e.g., mechanical impact or fatigue) will lead to a failed weld between the busbar 2218 or 2418 and the current collector tabs 2208 or 2408 and 2409. In some embodiments, the reinforcement structure is a rigid structure comprising an electrically non-conductive material. In other embodiments, the reinforcement structure is a flexible or semi-flexible structure comprising one or more of polyvinylidene fluoride (PVDF), polyethylene (PE), ethylene acrylic acid (EAA), ethylene methacrylic acid (EMAA) or functional derivatives or copolymers or combinations thereof. In one suitable embodiment, the reinforcement structure comprises a polymer film. The polymer film is adhered to the electrode assembly 2202 or 2402 using a hot melt technique. By applying sufficient heat to the polymer material, the material reflows into any gaps and around edges of the current collector tabs and the busbar. In one embodiment, the polymer film is heat treated after it has been applied to the desired portion of the electrode assembly 2202 or 2402. In this embodiment, the polymer film is heat treated to a temperature within a range of from 80° C. to 130° C., such as 80° C., 85° C., 90° C., 95° C., 100° C., 105° C., 110° C., 115° C., 120° C., 125° C. and 130° C. In one embodiment, when heated to this temperature range, the polymer cross-links and significantly hardens to a rigid structure, thus forming the reinforcement structure. In other embodiments, when heated to the above-described temperature range, the polymer adheres to the electrode assembly 2202 or 2402, but retains its flexibility or semi-flexible properties. In one embodiment, the reinforcement structure has a thickness measured in the X-axis direction of from 25 μm to 500 μm, such as 25 μm, 50 μm, 75 μm, 100 μm, 125 μm, 150 μm, 175 μm, 200 μm, 225 μm, 250 μm, 275 μm, 300 μm, 325 μm, 350 μm, 375 μm, 400 μm, 425 μm, 450 μm, 475 μm or 500 μm. In one embodiment, the film forming the reinforcement structure is applied and has from a 15% to 40% reduction in thickness, measured in the X-axis direction after heat treatment.

In some embodiments, the reinforcement structure is omitted from the secondary battery 2200 and/or 2400. A reinforcement structure is typically applied where failed welds between the busbar 2218 or 2418 and the current collector tabs 2208 or 2408 and 2409 are susceptible or likely. The reinforcement structure adds bulk to the electrode assembly 2202 or 2402 without increasing the performance or capacity of the battery, thereby degrading the energy and power density and material utilization efficiency of the battery. Suitably, the interconnection design between the overlapping current collector tabs 2208 or 2408 and 2409 and the corresponding busbar 2218 or 2418 reduces the propensity for the failure of the welds and/or connection therebetween. In this regard, the interconnection design described herein facilitates reducing or eliminating the need for such a reinforcement structure, while maintaining or increasing the performance, capacity, and/or energy end power density of the secondary battery 2200 or 2400.

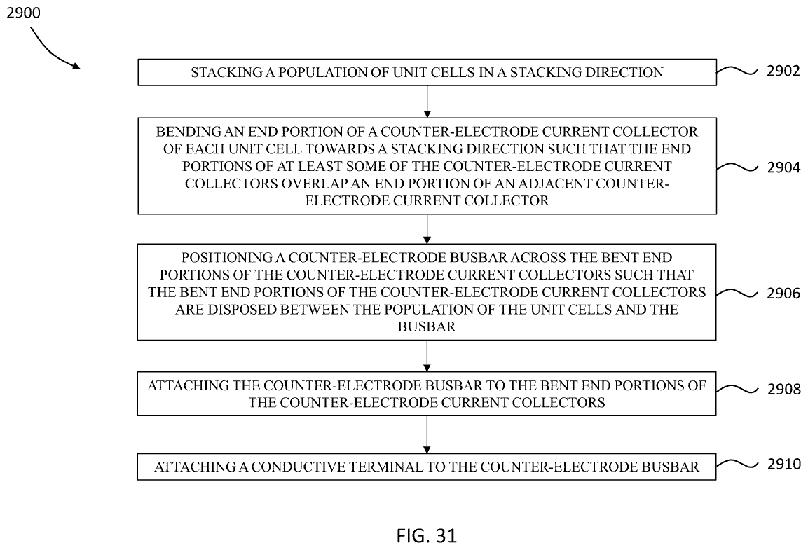

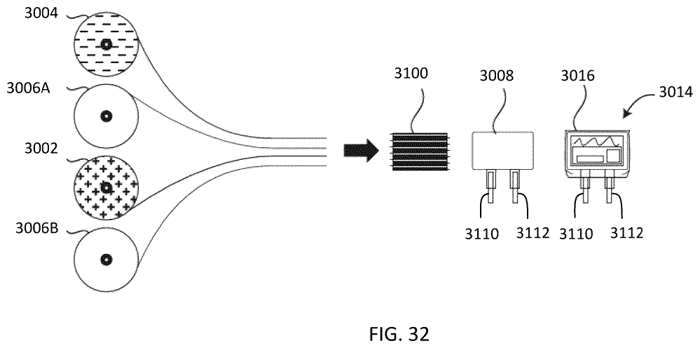

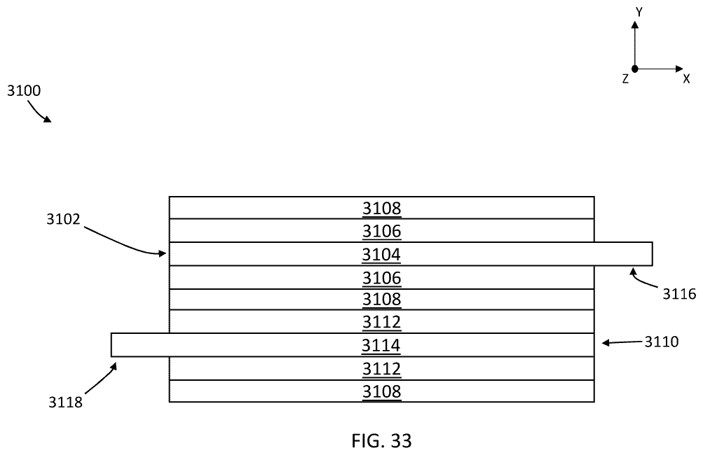

FIG. 31 is an example method 2900 of assembling a secondary battery assembly that will be described with general reference to FIGS. 1-30 and additional reference to FIGS. 32 and 33. FIG. 32 illustrates individual spools of electrode material 3002, 3004, and 3006A and 3006B that are unwound and stacked in an alternating configuration including at least one layer of a positive electrode or cathode 3002 and at least one layer of a negative electrode or anode 3004 separated by separator material 3006. The spools of electrode material 3002, 3004, and 3006A and 3006B may be produced as webs of electrode material as described, for example, in U.S. Pat. No. 11,495,784 B2, issued Nov. 8, 2022, and U.S. Pat. No. 11,411,253 B2, issued Aug. 9, 2022, the disclosures of which are hereby incorporated by reference herein in their entirety.

In one suitable embodiment, as shown in FIGS. 32 and 33, the spools of electrode material 3002, 3004, and 3006A and 3006B are merged into a unit cell 3100. The unit cell 3100 shown in FIG. 33 is similar to the unit cell 200B shown in FIG. 2 and includes, in stacked succession in the longitudinal direction or the Y-axis, an anode structure 3102 that includes an anode current collector layer 3104 and anodically active material layers 3106 on each side of the anode current collector layer 3104, a cathode structure 3110 that includes a cathode current collector layer 3114 and cathodically active material layers 3112 on each side of the cathode current collected layer 3114, and separator structures 3108 comprised of an electrically insulating separator material on each side of the anode structure 3102 and each side of the cathode structure 3110. The unit cell 3100 may alternatively be similar to the unit cell 200A shown in FIG. 2 and includes, in stacked succession in the longitudinal direction or the Y-axis, an anode current collector 3104, an anodically active material layer 3106, a separator structure 3108, a cathodically active material layer 3112, and a cathode current collector 3114.

The method 2900 includes stacking 2902 a population of the unit cells 3100 in the Y-axis or stacking direction. Additional stacked layers for the population of unit cells 3100 may be merged, by alternating layers of spools of anode 3004, separator 3006, and cathode 3002 to stack 2902 the desired number of unit cells 3100. When the population of the unit cells 3100 are stacked 2902, pairs of adjacent unit cells 3100 are formed that include the anode structure 3102 of one of the unit cells 3100 of the pair adjacent the cathode structure 3104 of the other of the unit cells 3100 of the pair and a separator structure 3108 between the anodically active material layer 3106 and the adjacent cathodically active material layer 3112. The separator structure 3108 that is between the anode structure 3102 of one of the unit cells 3100 of the pair and the cathode structure 3104 of the other of the unit cells 3100 of the pair may be considered to be shared between the pair of unit cells 3100 or included in one of the unit cells 3100 of the pair.

After the desired number of unit cells 3100 are stacked 2902, the method 2900 proceeds with bending 2904 an end portion 3118 of the cathode electrode current collectors 3114 that extends past the cathode active material 3112 and the separator structure 3108 in the X-axis direction. The end portions 3118 of the cathode current collectors 3114 are bent towards the stacking direction. The bent end portions 3118 are similar to the bent end portions 1402 and the counter-electrode current collector tabs 2208 described above, and at least some of the bent end portions 3118 overlap the end portion 3118 of an adjacent current collector 3114. In some embodiments, the bent end portions 3118 may include two current collector tabs, similar to the two current collector tabs 2408 and 2409, that are oppositely bent (i.e., one of the current collector tabs is bent towards the stacking direction and the other of the current collector tabs is bent towards the Y-axis direction opposite the stacking direction).

The method 2900 may, in some implementations, include attaching the overlapping end portions 3118 together, for example, by welding, soldering, gluing, or any other suitable technique. For example, the overlapping end portions 3118 may be laser welded together as described above for the bent end portions 1402 with reference to FIGS. 22 and 23A-23E. In some embodiments, the end portions 3116 of the anode current collectors 3104 may be bent similar to the cathode current collectors 3114. However, in some embodiments, the end portions 3116 of the anode current collectors 3104 may not overlap when bent.

The method 2900 continues with positioning 2906 a cathode busbar (e.g., the busbar 510) across the bent end portions 3118. The bent end portions 3118 are thereby positioned between the cathode busbar 510 and the rest of the population of stacked unit cells 3100 as described above. In some implementations of the method 2900, bending 2904 the end portions 3118 of the cathode current collectors 3114 and positioning 2906 the cathode busbar 510 across the bent end portions 3118 may occur substantially simultaneously, that is, the end portions 3118 may be bent 2904 when the cathode busbar 510 is positioned 2906 across the end portions 3118. An anode busbar (e.g., the anode busbar 508) may also be positioned across and/or through slots formed in the end portions 3116 of the anode current collectors 3104.

The cathode busbar 510 is then attached 2908 to the bent end portions 3118 using any suitable attachment technique, such as welding, soldering, gluing, and the like. For example, the stacked population of unit cells 3100 may proceed to a tab welding station at which the cathode busbar 510 is positioned 2906 across and attached 2908 to the bent end portions 3118. The welds between the cathode busbar 510 and the bent end portions 3118 may be made using a laser welder, friction welding, ultrasonic welding or any suitable welding method. For example, the cathode busbar 510 may be laser welded to the bent end portions 3318 as described above for the bent end portions 1402 with reference to FIGS. 19-22 and 23A-23E.

The anode busbar 508 may also be positioned across and attached (e.g., welded, soldered, glued, and the like) to the end portions 3116 of the anode current collectors 3104. In some examples, the anode busbar 508 is connected to the end portions 3116 through a current limiter (e.g., a current limiter 506) as described above for the electrode structures 502 and the electrode busbar 508 with reference to FIGS. 9-15.

After attaching the cathode busbar 510 to the bent end portions 3118 and attaching the anode busbar 508 to the end portions 3116, the electrode assembly 3008 shown in FIG. 32 is produced by attaching 2910 conductive terminals 3010 and 3012 to the cathode busbar 510 and the anode busbar 508, respectively. The conductive terminals 3010 and 3012 may be attached 2910 to the respective busbar by any suitable technique (e.g., welding, soldering, gluing, and the like). In certain implementations of the method 2900, the conductive terminals 3010 and 3012 are attached 2910 to the respective busbar by a suitable welding method.

The electrode assembly 3008 proceeds to a packaging station to form a secondary battery 3016 that includes the electrode assembly 3008 disposed within a battery enclosure 3016. At the packaging station, the electrode assembly 3008 may be coated with an insulating packaging material, such as a multi-layer aluminum polymer material, plastic, or the like, to form the battery enclosure 3016 in which the electrode assembly 3008 is disposed. In one embodiment, the battery enclosure 3016 is evacuated using a vacuum and filled through an opening (not shown) with an electrolyte material. The battery enclosure 3016 including the insulating packaging material may be sealed around the electrode assembly 3008 using a heat seal, laser weld, adhesive or any suitable sealing method. The conductive terminals 3010 and 3012 of the electrode assembly 3008 remain exposed, that is, the conductive terminals 3010 and 3012 extend outward beyond and are not covered by the battery enclosure 3016 to allow a user to connect the terminals 3010 and 3012 to a device to be powered, or to a battery charger. Once the battery enclosure 3016 is placed on the electrode assembly 3008, a completed secondary battery 3014 is formed. In this embodiment, the completed secondary battery 3014 is a 3-D lithium ion type battery. In other embodiments, the completed secondary battery 3014 may be any battery type suitable for production using the devices and methods described herein.

The following embodiments are provided to illustrate aspects of the disclosure, although the embodiments are not intended to be limiting and other aspects and/or embodiments may also be provided.

Embodiment 1. An electrode assembly for use with a secondary battery, the electrode assembly defining mutually perpendicular transverse, longitudinal, and vertical directions corresponding to an X axis, a Y axis, and a Z axis, respectively, of a three-dimensional Cartesian coordinate system, the electrode assembly comprising: a population of unit cells being stacked in the longitudinal direction, each member of the unit cell population including an electrode structure, a separator structure, and a counter-electrode structure, wherein: the electrode structure comprises an electrode current collector and an electrode active material layer, the electrode structure extending in the transverse direction; the counter-electrode structure comprises a counter-electrode current collector and a counter-electrode active material layer, the counter-electrode structure extending in the transverse direction, an end portion of the counter-electrode current collector extending past the counter-electrode active material and the separator structure in the transverse direction, and the end portion of the counter-electrode current collector being bent towards the longitudinal direction to define a bent end portion of the respective counter-electrode current collector; and the bent end portions of at least some of the counter-electrode current collectors overlap the bent end portion of an adjacent counter-electrode current collector in a Y-Z plane of the electrode assembly defined by the Y and Z axes; and a counter-electrode busbar being attached to the bent end portions of the counter-electrode current collectors such that the counter-electrode current collectors are electrically connected to the counter-electrode busbar.

Embodiment 2. The electrode assembly of Embodiment 1, wherein the counter-electrode busbar extends across the bent end portions in the Y-Z plane such that the bent end portions of the counter-electrode current collectors are disposed inboard of the counter-electrode busbar.

Embodiment 3. The electrode assembly of Embodiment 1 or Embodiment 2, wherein the electrode structures comprise negative electrode structures, and the counter-electrode structures comprise positive electrode structures.

Embodiment 4. The electrode assembly of any previous embodiment, wherein the counter-electrode current collectors comprise a material selected from the group consisting of aluminum, nickel, cobalt, titanium, tungsten, and alloys thereof.

Embodiment 5. The electrode assembly of any previous embodiment, wherein the counter-electrode current collectors comprise aluminum.

Embodiment 6. The electrode assembly of any previous embodiment, wherein the counter-electrode busbar is directly welded to the bent end portions of the counter-electrode current collectors.

Embodiment 7. The electrode assembly of any previous embodiment, wherein the overlapping bent end portions of the counter-electrode current collectors are attached by at least one of welding, soldering, and gluing.

Embodiment 8. The electrode assembly of any previous embodiment, wherein a cumulative thickness of the overlapping bent end portions of the counter-electrode current collectors, measured in the transverse direction, is at least or approximately two times greater than an individual thickness of the counter-electrode current collectors, measured in the longitudinal direction.

Embodiment 9. The electrode assembly of any previous embodiment, wherein a cumulative thickness of the overlapping bent end portions of the counter-electrode current collectors, measured in the transverse direction, is at least or approximately three times greater than an individual thickness of the counter-electrode current collectors, measured in the longitudinal direction.

Embodiment 10. The electrode assembly of any previous embodiment, wherein a cumulative thickness of the overlapping bent end portions of the counter-electrode current collectors, measured in the transverse direction, is at least or approximately four times greater than an individual thickness of the counter-electrode current collectors, measured in the longitudinal direction.

Embodiment 11. The electrode assembly of any previous embodiment, wherein a cumulative thickness of the overlapping bent end portions of the counter-electrode current collectors, measured in the transverse direction, is at least or approximately five times greater than an individual thickness of the counter-electrode current collectors, measured in the longitudinal direction.

Embodiment 12. The electrode assembly of any previous embodiment, wherein a cumulative thickness of the overlapping bent end portions of the counter-electrode current collectors, measured in the transverse direction, is at least or approximately six times greater than an individual thickness of the counter-electrode current collectors, measured in the longitudinal direction.

Embodiment 13. The electrode assembly of any previous embodiment, wherein a cumulative thickness of the overlapping bent end portions of the counter-electrode current collectors, measured in the transverse direction, is at least or approximately seven times greater than an individual thickness of the counter-electrode current collectors, measured in the longitudinal direction.

Embodiment 14. The electrode assembly of any previous embodiment, wherein a cumulative thickness of the overlapping bent end portions of the counter-electrode current collectors, measured in the transverse direction, is at least or approximately eight times greater than an individual thickness of the counter-electrode current collectors, measured in the longitudinal direction.

Embodiment 15. The electrode assembly of any previous embodiment, wherein a cumulative thickness of the overlapping bent end portions of the counter-electrode current collectors, measured in the transverse direction, is at least or approximately nine times greater than an individual thickness of the counter-electrode current collectors, measured in the longitudinal direction.

Embodiment 16. The electrode assembly of any previous embodiment, wherein a cumulative thickness of the overlapping bent end portions of the counter-electrode current collectors, measured in the transverse direction, is at least or approximately ten times greater than an individual thickness of the counter-electrode current collectors, measured in the longitudinal direction.

Embodiment 17. The electrode assembly of any previous embodiment, wherein the end portion of the counter-electrode current collector comprises first and second tabs each extending past the counter-electrode active material and the separator structure in the transverse direction, the first and second tabs of each counter-electrode current collector being bent towards the longitudinal direction, the first and second tabs of at least some of the counter-electrode current collectors overlap the first and second tab, respectively, of an adjacent counter-electrode current collector in the Y-Z plane of the electrode assembly, the counter-electrode busbar being attached to and extending across the first tabs, the second tabs, or both the first and second tabs of the counter-electrode current collectors in the Y-Z plane of the electrode assembly such that the first tabs, the second tabs, or both the first and second tabs are disposed inboard of the counter-electrode busbar.

Embodiment 18. The electrode assembly of Embodiment 17, wherein the counter-electrode busbar is attached to and extends across the first tabs and second tabs in the Y-Z plane of the electrode assembly such that the first and second tabs are disposed inboard of the second counter-electrode busbar.

Embodiment 19. The electrode assembly of Embodiment 18, wherein the counter-electrode busbar is directly welded to the first tabs and to the second tabs.

Embodiment 20. The electrode assembly of any one of Embodiments 17 to 19, wherein the first and second tabs of the counter-electrode current collectors are oppositely bent towards the longitudinal direction.

Embodiment 21. The electrode assembly of any previous embodiment, wherein the counter-electrode current collectors have an individual thickness less than 100 μm, less than 50 μm, or less than 20 μm.

Embodiment 22. The electrode assembly of any previous embodiment, wherein the counter-electrode current collectors have an individual thickness between about 1 μm to about 100 μm, between about 1 μm to about 50 μm, between about 1 μm to about 40 μm, between about 1 μm to about 30 μm, between about 1 μm to about 20 μm, between about 1 μm to about 15 μm, between about 1 μm to about 10 μm, between about 10 μm to about 50 μm, between about 20 μm to about 50 μm, between about 30 μm to about 50 μm, between about 40 μm to about 50 μm, between about 10 μm to about 40 μm, between about 10 μm to about 30 μm, between about 10 μm to about 20 μm, or between about 10 μm to about 15 μm.

Embodiment 23. The electrode assembly of any previous embodiment, wherein the counter-electrode current collectors have an individual thickness of about 1 μm, about 5 μm, about 10 μm, about 15 μm, about 20 μm, about 25 μm, about 30 μm, about 35 μm, about 40 μm, about 45 μm, about 50 μm, or about 100 μm.

Embodiment 24. The electrode assembly of any previous embodiment, wherein the counter-electrode current collectors have the same individual thickness.

Embodiment 25. The electrode assembly of any previous embodiment, wherein the counter-electrode current collectors have different individual thicknesses.

Embodiment 26. The electrode assembly of any previous embodiment, wherein a thickness of the counter-electrode busbar is between about 20 μm to about 500 μm, between about 50 μm to about 500 μm, between about 100 μm to about 500 μm, between about 200 μm to about 500 μm, between about 300 μm to about 500 μm, between about 400 μm to about 500 μm, between about 20 μm to about 400 μm, between about 20 μm to about 300 μm, between about 20 μm to about 200 μm, between about 20 μm to about 100 μm, between about 20 μm to about 50 μm, between about 50 μm to about 100 μm, between about 100 μm to about 400 μm, between about 100 μm to about 300 μm, between about 100 μm to about 200 μm, between about 100 μm to about 150 μm, or between about 50 μm to about 150 μm. For example, the thickness T₂ of the counter-electrode busbar 510 may be about 20 μm, about 50 μm, about 100 μm, about 150 μm, about 200 μm, about 250 μm, about 300 μm, about 350 μm, about 400 μm, about 450 μm, or about 500 μm.

Embodiment 27. The electrode assembly of any previous embodiment, wherein a thickness of the counter-electrode busbar is greater than an individual thickness of the counter-electrode current collectors.

Embodiment 28. The electrode assembly of Embodiment 27, wherein the thickness of the counter-electrode busbar is at least two times greater than the individual thickness of the counter-electrode current collectors, or at least three times greater, at least four times greater, at least five times greater, at least ten times greater, at least fifteen times greater, at least twenty times greater, at least thirty times greater, at least forty times greater, or up to fifty times greater than the individual thickness of the counter-electrode current collectors.

Embodiment 29. The electrode assembly of any previous embodiment, wherein a cumulative thickness of the overlapping bent end portions is greater than a thickness of the counter-electrode busbar, or less than a thickness of the counter-electrode busbar.

Embodiment 30. The electrode assembly of any previous embodiment, wherein a cumulative thickness of the overlapping bent end portions is within (above or below) 50 μm of a thickness of the counter-electrode busbar, or within 25 μm, within 20 μm, within 15 μm, within 10 μm, within 5 μm, or within 1 μm of the thickness of the counter-electrode busbar.

Embodiment 31. The electrode assembly of any previous embodiment, wherein a cumulative thickness of the overlapping bent end portions is within +/−25% of a thickness of the counter-electrode busbar, or within +/−20%, within +/−15%, within +/−10%, within +/−5%, or within +/−1% of the thickness of the counter-electrode busbar.

Embodiment 32. The electrode assembly of any previous embodiment, wherein a cumulative thickness of the overlapping bent end portions is approximately equal to a thickness of the counter-electrode busbar.

Embodiment 33. The electrode assembly of any previous embodiment, wherein each bent end portion extends a length, measured in the Y-axis direction, that enables the bent end portion to overlap an adjacent bent end portion.

Embodiment 34. The electrode assembly of Embodiment 33, wherein the bent end portions extend the same length.

Embodiment 35. The electrode assembly of Embodiment 33, wherein the bent end portions extend different lengths.

Embodiment 36. The electrode assembly of any one of Embodiments 33 to 35, wherein each bent portion extends the length of at least 0.1 mm, at least 0.5 mm, at least 1 mm, at least 1.5 mm, or at least 2 mm.

Embodiment 37. The electrode assembly of any one of Embodiments 33 to 36, wherein each bent portion extends the length of between about 0.1 mm to about 5 mm, between about 0.5 mm to about 5 mm, between about 1 mm to about 5 mm, between about 0.5 mm to about 4 mm, between about 0.5 mm to about 3 mm, between about 0.5 mm to about 2 mm, between about 1 mm to about 4 mm, between about 1 mm to about 3 mm, or between about 1 mm to about 2 mm.

Embodiment 38. The electrode assembly of any previous embodiment, wherein the bent end portion of each counter-electrode current collector overlaps at least one adjacent bent end portion.

Embodiment 39. The electrode assembly of any previous embodiment, wherein at least some of the bent end portions overlap more than one bent end portion.

Embodiment 40. The electrode assembly of Embodiment 39, wherein at least some of the bent end portions overlap at least two bent end portions.

Embodiment 41. The electrode assembly of Embodiment 39, wherein at least some of the bent end portion overlap two bent end portions, three bent end portions, four bent end portions, or five bent end portions.

Embodiment 42. The electrode assembly of any previous embodiment, wherein a cumulative thickness of the overlapping bent end portions is between about 20 μm to about 250 μm, between about 20 μm to about 200 μm, between about 20 μm to about 150 μm, between about 20 μm to about 100 μm, between about 20 μm to about 50 μm, between about 50 μm to about 250 μm, between about 50 μm to about 200 μm, between about 50 μm to about 150 μm, between about 50 μm to about 100 μm, between about 100 μm to about 250 μm, between about 100 μm to about 200 μm, between about 100 μm to about 150 μm, between about 150 μm to about 250 μm, between about 150 μm to about 200 μm, or between about 200 μm to about 250 μm.

Embodiment 43. The electrode assembly of any previous embodiment, wherein a cumulative thickness of the overlapping bent end portions is about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, or about 250 μm.

Embodiment 44. The electrode assembly of any previous embodiment, wherein the electrode structures or the counter-electrode structures comprise anodic electrode structures.

Embodiment 45. The electrode assembly of Embodiment 44, wherein the anodic electrode structures comprising graphite, silicon, or lithium metal.

Embodiment 46. The electrode assembly of any previous embodiment, wherein the electrode structures or the counter-electrode structures comprise cathodic electrode structures.

Embodiment 47. The electrode assembly of Embodiment 46, wherein the cathodic electrode structures comprising at least one of lithium metal phosphate, lithium nickel manganese cobalt oxide, and lithium cobalt oxide.

Embodiment 48. A secondary battery comprising an electrode assembly disposed within a battery enclosure, the electrode assembly defining mutually perpendicular transverse, longitudinal, and vertical directions corresponding to an X axis, a Y axis, and a Z axis, respectively, of a three-dimensional Cartesian coordinate system, the electrode assembly comprising: a population of unit cells being stacked in the longitudinal direction, each member of the unit cell population including an electrode structure, a separator structure, and a counter-electrode structure, wherein: the electrode structure comprises an electrode current collector and an electrode active material layer, the electrode structure extending in the transverse direction; the counter-electrode structure comprises a counter-electrode current collector and a counter-electrode active material layer, the counter-electrode structure extending in the transverse direction, an end portion of the counter-electrode current collector extending past the counter-electrode active material and the separator structure in the transverse direction, and the end portion of the counter-electrode current collector being bent towards the longitudinal direction to define a bent end portion of the respective current collector; and the bent end portions of at least some of the counter-electrode current collectors overlap the bent end portion of an adjacent counter-electrode current collector in a Y-Z plane of the electrode assembly defined by the Y and Z axes; a counter-electrode busbar attached to the bent end portions of the counter-electrode current collectors such that the counter-electrode current collectors are electrically connected to the counter-electrode busbar.

Embodiment 49. The secondary battery of Embodiment 48, wherein the counter-electrode busbar extends across the bent end portions in the Y-Z plane such that the bent end portions of the counter-electrode current collectors are disposed inboard of the counter-electrode busbar.

Embodiment 50. The secondary battery of Embodiment 48 or Embodiment 49, wherein the electrode structures comprise negative electrode structures, and the counter-electrode structures comprise positive electrode structures.

Embodiment 51. The secondary battery of any previous embodiment, wherein the counter-electrode current collectors comprise a material selected from the group consisting of aluminum, nickel, cobalt, titanium, tungsten, and alloys thereof.

Embodiment 52. The secondary battery of any previous embodiment, wherein the counter-electrode current collectors comprise aluminum.

Embodiment 53. The secondary battery of any previous embodiment, wherein the counter-electrode busbar is directly welded to the bent end portions of the counter-electrode current collectors.

Embodiment 54. The secondary battery of any previous embodiment, wherein the overlapping bent end portions of the counter-electrode current collectors are attached by at least one of welding, soldering, and gluing.

Embodiment 55. The secondary battery of any previous embodiment, wherein a cumulative thickness of the overlapping bent end portions of the counter-electrode current collectors, measured in the transverse direction, is at least or approximately two times greater than an individual thickness of the counter-electrode current collectors, measured in the longitudinal direction.

Embodiment 56. The secondary battery of any previous embodiment, wherein a cumulative thickness of the overlapping bent end portions of the counter-electrode current collectors, measured in the transverse direction, is at least or approximately three times greater than an individual thickness of the counter-electrode current collectors, measured in the longitudinal direction.

Embodiment 57. The secondary battery of any previous embodiment, wherein a cumulative thickness of the overlapping bent end portions of the counter-electrode current collectors, measured in the transverse direction, is at least or approximately four times greater than an individual thickness of the counter-electrode current collectors, measured in the longitudinal direction.

Embodiment 58. The secondary battery of any previous embodiment, wherein a cumulative thickness of the overlapping bent end portions of the counter-electrode current collectors, measured in the transverse direction, is at least or approximately five times greater than an individual thickness of the counter-electrode current collectors, measured in the longitudinal direction.

Embodiment 59. The secondary battery of any previous embodiment, wherein a cumulative thickness of the overlapping bent end portions of the counter-electrode current collectors, measured in the transverse direction, is at least or approximately six times greater than an individual thickness of the counter-electrode current collectors, measured in the longitudinal direction.

Embodiment 60. The secondary battery of any previous embodiment, wherein a cumulative thickness of the overlapping bent end portions of the counter-electrode current collectors, measured in the transverse direction, is at least or approximately seven times greater than an individual thickness of the counter-electrode current collectors, measured in the longitudinal direction.

Embodiment 61. The secondary battery of any previous embodiment, wherein a cumulative thickness of the overlapping bent end portions of the counter-electrode current collectors, measured in the transverse direction, is at least or approximately eight times greater than an individual thickness of the counter-electrode current collectors, measured in the longitudinal direction.

Embodiment 62. The secondary battery of any previous embodiment, wherein a cumulative thickness of the overlapping bent end portions of the counter-electrode current collectors, measured in the transverse direction, is at least or approximately nine times greater than an individual thickness of the counter-electrode current collectors, measured in the longitudinal direction.

Embodiment 63. The secondary battery of any previous embodiment, wherein a cumulative thickness of the overlapping bent end portions of the counter-electrode current collectors, measured in the transverse direction, is at least or approximately ten times greater than an individual thickness of the counter-electrode current collectors, measured in the longitudinal direction.

Embodiment 64. The secondary battery of any previous embodiment, wherein the end portion of the counter-electrode current collector comprises first and second tabs each extending past the counter-electrode active material and the separator structure in the transverse direction, the first and second tabs of each counter-electrode current collector being bent towards the longitudinal direction, the first and second tabs of at least some of the counter-electrode current collectors overlap the first and second tab, respectively, of an adjacent counter-electrode current collector in the Y-Z plane of the electrode assembly, the counter-electrode busbar being attached to and extending across the first tabs, the second tabs, or both the first and second tabs of the counter-electrode current collectors in the Y-Z plane of the electrode assembly such that the first tabs, the second tabs, or both the first and second tabs are disposed inboard of the counter-electrode busbar.

Embodiment 65. The secondary battery of Embodiment 64, wherein the counter-electrode busbar is attached to and extends across the first tabs and second tabs in the Y-Z plane of the electrode assembly such that the first and second tabs are disposed inboard of the second counter-electrode busbar.

Embodiment 66. The secondary battery of Embodiment 65, wherein the counter-electrode busbar is directly welded to the first tabs and to the second tabs.

Embodiment 67. The secondary battery of any one of Embodiments 64 to 66, wherein the first and second tabs of the counter-electrode current collectors are oppositely bent towards the longitudinal direction.

Embodiment 68. The secondary battery of any previous embodiment, wherein the counter-electrode current collectors have an individual thickness less than 100 μm, less than 50 μm, or less than 20 μm.

Embodiment 69. The secondary battery of any previous embodiment, wherein the counter-electrode current collectors have an individual thickness between about 1 μm to about 100 μm, between about 1 μm to about 50 μm, between about 1 μm to about 40 μm, between about 1 μm to about 30 μm, between about 1 μm to about 20 μm, between about 1 μm to about 15 μm, between about 1 μm to about 10 μm, between about 10 μm to about 50 μm, between about 20 μm to about 50 μm, between about 30 μm to about 50 μm, between about 40 μm to about 50 μm, between about 10 μm to about 40 μm, between about 10 μm to about 30 μm, between about 10 μm to about 20 μm, or between about 10 μm to about 15 μm.

Embodiment 70. The secondary battery of any previous embodiment, wherein the counter-electrode current collectors have an individual thickness of about 1 μm, about 5 μm, about 10 μm, about 15 μm, about 20 μm, about 25 μm, about 30 μm, about 35 μm, about 40 μm, about 45 μm, about 50 μm, or about 100 μm.

Embodiment 71. The secondary battery of any previous embodiment, wherein the counter-electrode current collectors have the same individual thickness.

Embodiment 72. The secondary battery of any previous embodiment, wherein the counter-electrode current collectors have different individual thicknesses.

Embodiment 73. The secondary battery of any previous embodiment, wherein a thickness of the counter-electrode busbar is between about 20 μm to about 500 μm, between about 50 μm to about 500 μm, between about 100 μm to about 500 μm, between about 200 μm to about 500 μm, between about 300 μm to about 500 μm, between about 400 μm to about 500 μm, between about 20 μm to about 400 μm, between about 20 μm to about 300 μm, between about 20 μm to about 200 μm, between about 20 μm to about 100 μm, between about 20 μm to about 50 μm, between about 50 μm to about 100 μm, between about 100 μm to about 400 μm, between about 100 μm to about 300 μm, between about 100 μm to about 200 μm, between about 100 μm to about 150 μm, or between about 50 μm to about 150 μm. For example, the thickness T₂ of the counter-electrode busbar 510 may be about 20 μm, about 50 μm, about 100 μm, about 150 μm, about 200 μm, about 250 μm, about 300 μm, about 350 μm, about 400 μm, about 450 μm, or about 500 μm.

Embodiment 74. The secondary battery of any previous embodiment, wherein a thickness of the counter-electrode busbar is greater than an individual thickness of the counter-electrode current collectors.

Embodiment 75. The secondary battery of Embodiment 74, wherein the thickness of the counter-electrode busbar is at least two times greater than the individual thickness of the counter-electrode current collectors, or at least three times greater, at least four times greater, at least five times greater, at least ten times greater, at least fifteen times greater, at least twenty times greater, at least thirty times greater, at least forty times greater, or up to fifty times greater than the individual thickness of the counter-electrode current collectors.

Embodiment 76. The secondary battery of any previous embodiment, wherein a cumulative thickness of the overlapping bent end portions is greater than a thickness of the counter-electrode busbar, or less than a thickness of the counter-electrode busbar.

Embodiment 77. The secondary battery of any previous embodiment, wherein a cumulative thickness of the overlapping bent end portions is within (above or below) 50 μm of a thickness of the counter-electrode busbar, or within 25 μm, within 20 μm, within 15 μm, within 10 μm, within 5 μm, or within 1 μm of the thickness of the counter-electrode busbar.

Embodiment 78. The secondary battery of any previous embodiment, wherein a cumulative thickness of the overlapping bent end portions is within +/−25% of a thickness of the counter-electrode busbar, or within +/−20%, within +/−15%, within +/−10%, within +/−5%, or within +/−1% of the thickness of the counter-electrode busbar.

Embodiment 79. The secondary battery of any previous embodiment, wherein a cumulative thickness of the overlapping bent end portions is approximately equal to a thickness of the counter-electrode busbar.

Embodiment 80. The secondary battery of any previous embodiment, wherein each bent end portion extends a length, measured in the Y-axis direction, that enables the bent end portion to overlap an adjacent bent end portion.

Embodiment 81. The secondary battery of Embodiment 80, wherein the bent end portions extend the same length.

Embodiment 82. The secondary battery of Embodiment 80, wherein the bent end portions extend different lengths.

Embodiment 83. The secondary battery of any one of Embodiments 80 to 82, wherein each bent portion extends the length of at least 0.1 mm, at least 0.5 mm, at least 1 mm, at least 1.5 mm, or at least 2 mm.

Embodiment 84. The secondary battery of any one of Embodiments 80 to 83, wherein each bent portion extends the length of between about 0.1 mm to about 5 mm, between about 0.5 mm to about 5 mm, between about 1 mm to about 5 mm, between about 0.5 mm to about 4 mm, between about 0.5 mm to about 3 mm, between about 0.5 mm to about 2 mm, between about 1 mm to about 4 mm, between about 1 mm to about 3 mm, or between about 1 mm to about 2 mm.

Embodiment 85. The secondary battery of any previous embodiment, wherein the bent end portion of each counter-electrode current collector overlaps at least one adjacent bent end portion.

Embodiment 86. The secondary battery of any previous embodiment, wherein at least some of the bent end portions overlap more than one bent end portion.

Embodiment 87. The secondary battery of Embodiment 86, wherein at least some of the bent end portions overlap at least two bent end portions.

Embodiment 88. The secondary battery of Embodiment 86, wherein at least some of the bent end portion overlap two bent end portions, three bent end portions, four bent end portions, or five bent end portions.

Embodiment 89. The secondary battery of any previous embodiment, wherein a cumulative thickness of the overlapping bent end portions is between about 20 μm to about 250 μm, between about 20 μm to about 200 μm, between about 20 μm to about 150 μm, between about 20 μm to about 100 μm, between about 20 μm to about 50 μm, between about 50 μm to about 250 μm, between about 50 μm to about 200 μm, between about 50 μm to about 150 μm, between about 50 μm to about 100 μm, between about 100 μm to about 250 μm, between about 100 μm to about 200 μm, between about 100 μm to about 150 μm, between about 150 μm to about 250 μm, between about 150 μm to about 200 μm, or between about 200 μm to about 250 μm.

Embodiment 90. The secondary battery of any previous embodiment, wherein a cumulative thickness of the overlapping bent end portions is about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, or about 250 μm.

Embodiment 91. The secondary battery of any previous embodiment, wherein the electrode structures or the counter-electrode structures comprise anodic electrode structures.

Embodiment 92. The secondary battery of Embodiment 91, wherein the anodic electrode structures comprising graphite, silicon, or lithium metal.

Embodiment 93. The secondary battery of any previous embodiment, wherein the electrode structures or the counter-electrode structures comprise cathodic electrode structures.

Embodiment 94. The secondary battery of Embodiment 93, wherein the cathodic electrode structures comprising at least one of lithium metal phosphate, lithium nickel manganese cobalt oxide, and lithium cobalt oxide.

Embodiment 95. The electrode assembly or the secondary battery of any previous embodiment, further comprising a conductive terminal attached to the counter-electrode busbar, the conductive terminal extending outward beyond the battery enclosure in the secondary battery of any previous embodiment.

Embodiment 96. The electrode assembly or the secondary battery of Embodiment 95, wherein the counter-electrode busbar is substantially planar in the Y-Z plane such that the counter-electrode busbar has a substantially uniform thickness, measured in the transverse direction.

Embodiment 97. The electrode assembly or the secondary battery of Embodiment 95 or 96, wherein the conductive terminal extends outward from the counter-electrode busbar in the transverse or vertical direction.

Embodiment 98. The electrode assembly or the secondary battery of any one of Embodiments 95 to 97, wherein the conductive terminal is directly welded to the counter-electrode busbar.

Embodiment 99. The electrode assembly or the secondary battery of any previous embodiment, wherein the counter-electrode busbar comprises a first busbar layer directly welded to the bent end portions of the counter-electrode current collectors.

Embodiment 100. The electrode assembly or the secondary battery of Embodiment 99, wherein the counter-electrode busbar comprises a second busbar layer.

Embodiment 101. The electrode assembly or the secondary battery of Embodiment 100, wherein the second busbar layer is directly welded to the first busbar layer.

Embodiment 102. The electrode assembly or the secondary battery of any one of Embodiments 99 to 101, wherein a cumulative thickness of the overlapping bent end portions of the counter-electrode current collectors, measured in the transverse direction, is within (above or below) 50 μm of a thickness of the counter-electrode busbar, or within 25 μm, within 20 μm, within 15 μm, within 10 μm, within 5 μm, or within 1 μm of a thickness of the first busbar layer, measured in the transverse direction.

Embodiment 103. The electrode assembly or the secondary battery of any one of Embodiments 99 to 102, wherein a cumulative thickness of the overlapping bent end portions of the counter-electrode current collectors, measured in the transverse direction, is within +/−25% of a thickness of the first busbar layer, measured in the transverse direction, or within +/−20%, within +/−15%, within +/−10%, within +/−5%, or within +/−1% of the thickness of the first busbar layer.

Embodiment 104. The electrode assembly or the secondary battery of any one of Embodiments 99 to 103, wherein a cumulative thickness of the overlapping bent end portions is approximately equal to a thickness of the first busbar layer.

Embodiment 105. A method of assembling an electrode assembly, the method comprising: stacking a population of unit cells in a stacking direction, each member of the unit cell population including an electrode structure, a separator structure, and a counter-electrode structure, wherein the electrode structure comprises an electrode current collector and an electrode active material layer, the counter-electrode structure comprises a counter-electrode current collector and a counter-electrode active material layer, the electrode structure and the counter-electrode structure extend in a transverse direction perpendicular to the stacking direction, and an end portion of the counter-electrode current collector extends past the counter-electrode active material and the separator structure in the transverse direction; bending the end portion of each counter-electrode current collector towards the stacking direction to define a bent end portion, the bent end portions of at least some of the counter-electrode current collectors overlapping the bent end portion of an adjacent counter-electrode current collector; positioning a counter-electrode busbar across the bent end portions of the counter-electrode current collectors such that the bent end portions of the counter-electrode current collectors are disposed between the population of the unit cells and the busbar; and attaching the counter-electrode busbar to the bent end portions of the counter-electrode current collectors.

Embodiment 106. A method of assembling a secondary battery, the method comprising: assembling an electrode assembly, wherein assembling the electrode assembly comprises: stacking a population of unit cells in a stacking direction, each member of the unit cell population including an electrode structure, a separator structure, and a counter-electrode structure, wherein the electrode structure comprises an electrode current collector and an electrode active material layer, the counter-electrode structure comprises a counter-electrode current collector and a counter-electrode active material layer, the electrode structure and the counter-electrode structure extend in a transverse direction perpendicular to the stacking direction, and an end portion of the counter-electrode current collector extends past the counter-electrode active material and the separator structure in the transverse direction; bending the end portion of each counter-electrode current collector towards the stacking direction to define a bent end portion, the bent end portions of at least some of the counter-electrode current collectors overlapping the bent end portion of an adjacent counter-electrode current collector; and positioning a counter-electrode busbar across the bent end portions of the counter-electrode current collectors such that the bent end portions of the counter-electrode current collectors are disposed between the population of the unit cells and the busbar; attaching the counter-electrode busbar to the bent end portions of the counter-electrode current collectors; and enclosing the electrode assembly within a battery enclosure, wherein the conductive terminal extends outward beyond the battery enclosure.

Embodiment 107. The method of Embodiment 105 or 106, further comprising attaching a conductive terminal to the counter-electrode busbar.

Embodiment 108. The method of Embodiment 107, wherein the conductive terminal is attached to a portion of the counter-electrode busbar that is attached to the bent end portions.

Embodiment 109. The method of any one of Embodiments 105 to 108, wherein attaching the counter-electrode busbar to the bent end portions of the counter-electrode current collectors comprises welding the counter-electrode busbar to the bent end portions of the counter-electrode current collectors.

Embodiment 110. The method of any one of Embodiments 105 to 109, further comprising attaching the overlapping bent end portions of the counter-electrode current collectors together.

Embodiment 111. The method of any one of Embodiments 105 to 110, wherein attaching the overlapping bent end portions of the counter-electrode current collectors together is performed prior to attaching the counter-electrode busbar to the bent end portions of the counter-electrode current collectors.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An electrode assembly for use with a secondary battery, the electrode assembly defining mutually perpendicular transverse, longitudinal, and vertical directions corresponding to an X axis, a Y axis, and a Z axis, respectively, of a three-dimensional Cartesian coordinate system, the electrode assembly comprising:
a population of unit cells being stacked in the longitudinal direction, each member of the unit cell population including an electrode structure, a separator structure, and a counter-electrode structure, wherein:
the electrode structure comprises an electrode current collector and an electrode active material layer, the electrode structure extending in the transverse direction;
the counter-electrode structure comprises a counter-electrode current collector and a counter-electrode active material layer, the counter-electrode structure extending in the transverse direction, an end portion of the counter-electrode current collector extending past the counter-electrode active material and the separator structure in the transverse direction, and the end portion of the counter-electrode current collector being bent towards the longitudinal direction to define a bent end portion of the respective counter-electrode current collector; and
the bent end portions of at least some of the counter-electrode current collectors overlap the bent end portion of an adjacent counter-electrode current collector in a Y-Z plane of the electrode assembly defined by the Y and Z axes; and
a counter-electrode busbar being attached to the bent end portions of the counter-electrode current collectors such that the counter-electrode current collectors are electrically connected to the counter-electrode busbar, the counter-electrode busbar extending across the bent end portions in the Y-Z plane such that the bent end portions of the counter-electrode current collectors are disposed inboard of the counter-electrode busbar.

2. The electrode assembly as set forth in claim 1, wherein the electrode structures comprise negative electrode structures, and the counter-electrode structures comprise positive electrode structures.

3. The electrode assembly as set forth in claim 2, wherein the counter-electrode current collectors comprise a material selected from the group consisting of aluminum, nickel, cobalt, titanium, tungsten, iron, stainless steel, and alloys thereof.

4. The electrode assembly as set forth in claim 2, wherein the counter-electrode current collectors comprise aluminum.

5. The electrode assembly as set forth in claim 1, wherein the counter-electrode busbar is directly welded to the bent end portions of the counter-electrode current collectors.

6. The electrode assembly as set forth in claim 1, wherein the overlapping bent end portions of the counter-electrode current collectors are attached by at least one of welding, soldering, and gluing.

7. The electrode assembly as set forth in claim 1, wherein a cumulative thickness of the overlapping bent end portions of the counter-electrode current collectors, measured in the transverse direction, is at least two times greater than an individual thickness of the counter-electrode current collectors, measured in the longitudinal direction.

8. The electrode assembly as set forth in claim 7, wherein the cumulative thickness of the overlapping bent end portions of the counter-electrode current collectors is approximately four times greater than the individual thickness of the counter-electrode current collectors.

9. The electrode assembly as set forth in claim 1, wherein the end portion of the counter-electrode current collector comprises first and second tabs each extending past the counter-electrode active material and the separator structure in the transverse direction, the first and second tabs of each counter-electrode current collector being bent towards the longitudinal direction, the first and second tabs of at least some of the counter-electrode current collectors overlap the first and second tab, respectively, of an adjacent counter-electrode current collector in the Y-Z plane of the electrode assembly, the counter-electrode busbar being attached to and extending across the first tabs, the second tabs, or both the first and second tabs of the counter-electrode current collectors in the Y-Z plane of the electrode assembly such that the first tabs, the second tabs, or both the first and second tabs are disposed inboard of the counter-electrode busbar.

10. The electrode assembly as set forth in claim 9, wherein the counter-electrode busbar is attached to and extends across the first tabs and second tabs in the Y-Z plane of the electrode assembly such that the first and second tabs are disposed inboard of the second counter-electrode busbar.

11. The electrode assembly as set forth in claim 10, wherein the counter-electrode busbar is directly welded to the first tabs and to the second tabs.

12. The electrode assembly as set forth in claim 9, wherein the first and second tabs of the counter-electrode current collectors are oppositely bent towards the longitudinal direction.

13. The electrode assembly as set forth in claim 1, wherein the counter-electrode current collectors have an individual thickness less than 100 μm, less than 50 μm, or less than 20 μm.

14. The electrode assembly as set forth in claim 1, wherein the counter-electrode current collectors have an individual thickness of between about 1 μm to about 100 μm.

15. The electrode assembly as set forth in claim 1, wherein the bent end portions of the counter-electrode current collectors extend a length in the longitudinal direction of at least 0.5 mm, or at least 1 mm.

16. The electrode assembly as set forth in claim 1, wherein the electrode structures or the counter-electrode structures comprise anodic electrode structures, the anodic electrode structures comprising graphite, silicon, or lithium metal.

17. The electrode assembly as set forth in claim 1, wherein the electrode structures or the counter-electrode structures comprise cathodic electrode structures, the cathodic electrode structures comprising at least one of lithium metal phosphate, lithium nickel manganese cobalt oxide, lithium metal oxide, and lithium cobalt oxide.

18. A secondary battery comprising an electrode assembly disposed within a battery enclosure, the electrode assembly defining mutually perpendicular transverse, longitudinal, and vertical directions corresponding to an X axis, a Y axis, and a Z axis, respectively, of a three-dimensional Cartesian coordinate system, the electrode assembly comprising:
a population of unit cells being stacked in the longitudinal direction, each member of the unit cell population including an electrode structure, a separator structure, and a counter-electrode structure, wherein:
the electrode structure comprises an electrode current collector and an electrode active material layer, the electrode structure extending in the transverse direction;
the counter-electrode structure comprises a counter-electrode current collector and a counter-electrode active material layer, the counter-electrode structure extending in the transverse direction, an end portion of the counter-electrode current collector extending past the counter-electrode active material and the separator structure in the transverse direction, and the end portion of the counter-electrode current collector being bent towards the longitudinal direction to define a bent end portion of the respective current collector; and
the bent end portions of at least some of the counter-electrode current collectors overlap the bent end portion of an adjacent counter-electrode current collector in a Y-Z plane of the electrode assembly defined by the Y and Z axes;
a counter-electrode busbar attached to the bent end portions of the counter-electrode current collectors such that the counter-electrode current collectors are electrically connected to the counter-electrode busbar, the counter-electrode busbar extending across the bent end portions in the Y-Z plane such that the bent end portions of the counter-electrode current collectors are disposed inboard of the counter-electrode busbar; and
a conductive terminal attached to the counter-electrode busbar, the conductive terminal extending outward beyond the battery enclosure.

19. The secondary battery as set forth in claim 18, wherein the counter-electrode busbar is substantially planar in the Y-Z plane such that the counter-electrode busbar has a substantially uniform thickness, measured in the transverse direction.

20. The secondary battery as set forth in claim 19, wherein the conductive terminal extends outward from the counter-electrode busbar in the transverse or vertical direction.

21.-30. (canceled)
